(19) United States
(12) Patent Application Publication
(10) Pub. No.: US 2025/0170475 A1
(43) Pub. Date: May 29, 2025

(54) Systems & Methods To Enhance The Event Experience With Augmented Reality

(71) Applicant: Sara Jilani, Anahtim, CA (US)

(72) Inventor: Sara Jilani, Anahtim, CA (US)

(21) Appl. No.: 18/155,706

(22) Filed: Jan. 17, 2023

(51) Int. Cl. A63F 13/213; G06K 19/06

(52) U.S. Cl. CPC A63F 13/213; G06K 19/06037

(57) ABSTRACT

An event entertainment system, according to the present disclosure, includes one or more forms of augmented reality content, an accessory that may be attached to a piece of furniture and/or another location, and a matrix code that helps a user engage, access, interact, and/or play with the aforementioned augmented reality content. The event entertainment system may be used by entities, such as, but not limited to, venues, individuals, and businesses, that operate and/or host events that may involve people and users, such as, but not limited to, fans and participants of an event.

### RELATED APPLICATIONS

This application claims the benefit of priority to the U.S. Provisional Patent Application Ser. No. 63/299,965 filed on Jan. 15, 2022 and U.S. Provisional Patent Application Ser. No. 63/374,324 filed on Sep. 1, 2022, the contents of each of the foregoing being incorporated herein by reference in its entirety.

### COPYRIGHT

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### STATEMENT REGARDING FEDERALLY SPONSORED RESEARCH/DEVELOPMENT

Not Applicable.

### BACKGROUND

### Field of the Invention

The various aspects discussed herein relate to entertainment services.

### Description of Related Art

Entertainment services are used to enhance the experience of an event. However, there are problems with existing entertainment services.

Accordingly, there is a need in the art for improved entertainment services.

### SUMMARY

In one or more aspects described herein, an entertainment system is disclosed. The entertainment system may have immersive media, a digital icon, and a means for displaying the digital icon. The immersive media may be related to an event. With respect to the immersive media, the digital icon may provide an electronic device the ability to access the immersive media. In one or more aspects described herein, an electronic game is disclosed. The electronic game may have a design, a graphic, and a means for allowing a user to interact with the electronic game. The design of the electronic game may relate to an event. The graphic may relate to one or more parts of a user's body. In one or more aspects described herein, a method for broadcasting entertainment content is disclosed. The method for broadcasting entertainment content may include providing access to immersive media, providing a digital icon, and displaying the digital icon. With respect to providing access to immersive media, the immersive media may relate to an event. With respect to providing a digital icon, the digital icon may be provided as a means to provide access to the immersive media. With respect to displaying a digital icon, the digital icon may be displayed within a venue, or nearby a venue, or on a digital screen, or on a combination thereof. In one or more aspects described herein, a furniture accessory is disclosed. The furniture accessory may have a design and a means for the design to provide access to digital content. The design may relate to an event. In one or more aspects described herein, a method of advertising for an event is disclosed. The method of advertising for an event may include providing immersive media and allowing a user to interact with the event. With respect to providing immersive media, the immersive media may relate to the event. With respect to allowing a user to interact with an event, a user may interact with the event through immersive media.

### BRIEF DESCRIPTION

### Drawings: Figures

FIG. 1 illustrates a perspective view of the event entertainment system and the general interactions between the components of the event entertainment system.

FIG. 2 illustrates a perspective view of the event entertainment system in which the accessory component of the event entertainment system is connected to the armrest of a chair.

FIG. 3 illustrates a perspective view of the event entertainment system in which the accessory component of the event entertainment system is connected to the cupholder of a chair.

FIG. 4 illustrates a perspective view of the event entertainment system being used at mass scale in a venue.

FIG. 5 illustrates a flowchart of a method of affixing an accessory component to a piece of furniture in a venue.

FIG. 6 illustrates a flowchart of a method of broadcasting the augmented reality content component of the event entertainment system during a live event.

FIG. 7 illustrates a flowchart of a method for broadcasting the augmented reality content component of the event entertainment system in correspondence with the type of event a venue may be hosting and/or the event association a venue may be affiliated with.

FIG. 8 illustrates a perspective view of an exemplative augmented reality game in which a user's face and/or another part of the user's body serves as the remote control of an augmented reality game in the augmented reality content component of the event entertainment system.

FIG. 9 illustrates various methods for a user to interact with the augmented reality content component of the event entertainment system via various head, face, and eye movements.

FIG. 10 illustrates a perspective view of an exemplative augmented reality game in which the user's face is morphed into the environment of the augmented reality content component of the event entertainment system.

FIG. 11 illustrates a perspective view of an exemplative augmented reality content in which the user's face is morphed into the avatar and/or remote control of the augmented reality content component of the event entertainment system.

FIG. 12 illustrates an exemplative single-player American football augmented reality game which serves as the foundation for the augmented reality content component of the event entertainment system.

FIG. 13 illustrates a method for playing an exemplative single-player American football augmented reality game of the augmented reality content component of the event entertainment system.

FIG. 14 illustrates an exemplative multiplayer American football augmented reality game which serves as the foundation for the augmented reality content component of the event entertainment system.

FIG. 15 illustrates a method for playing an exemplative multiplayer American football augmented reality game of the augmented reality content component of the event entertainment system.

FIG. 16 illustrates an exemplative single-player baseball augmented reality game which serves as the foundation for the augmented reality content component of the event entertainment system.

FIG. 17 illustrates a method for playing an exemplative single-player baseball augmented reality game of the augmented reality content component of the event entertainment system.

FIG. 18 illustrates an exemplative single-player soccer augmented reality game which serves as the foundation for the augmented reality content component of the event entertainment system.

FIG. 19 illustrates a method for playing an exemplative single-player soccer augmented reality game of the augmented reality content component of the event entertainment system.

FIG. 20 illustrates an exemplative single-player ice hockey augmented reality game which serves as the foundation for the augmented reality content component of the event entertainment system.

FIG. 21 illustrates a method for playing an exemplative single-player ice hockey augmented reality game of the augmented reality content component of the event entertainment system.

FIG. 22 illustrates an exemplative single-player martial arts augmented reality game which serves as the foundation for the augmented reality content component of the event entertainment system.

FIG. 23 illustrates a method for playing an exemplative single-player mixed martial arts augmented reality game of the augmented reality content component of the event entertainment system.

FIG. 24 illustrates an exemplative multiplayer boxing augmented reality game which serves as the foundation for the augmented reality content component of the event entertainment system.

FIG. 25 illustrates a method for playing an exemplative multiplayer boxing augmented reality game of the augmented reality content component of the event entertainment system.

FIG. 26 illustrates an exemplative single-player tennis augmented reality game which serves as the foundation for the augmented reality content component of the event entertainment system.

FIG. 27 illustrates a method for playing an exemplative single-player tennis augmented reality game of the augmented reality content component of the event entertainment system.

FIG. 28 illustrates an exemplative augmented reality animations and/or illustrations which serves as the foundation for the augmented reality content component of the event entertainment system.

FIG. 29 illustrates an exemplative augmented reality game which serves as the foundation for the augmented reality content component of the event entertainment system.

FIG. 30 illustrates a perspective view of the event entertainment system in which the accessory component of the event entertainment system involves one or more pieces of rubber.

FIG. 31 illustrates a perspective view of the event entertainment system in which the accessory component of the event entertainment system involves one or more C-clamps.

FIG. 32 illustrates a perspective view of the event entertainment system in which the accessory component of the event entertainment system involves a QR code being attached to a chair (and/or a piece of furniture) without a piece of rubber and/or C-clamp.

FIG. 33 illustrates a perspective view of a QR code as a part of the QR code component of the event entertainment system; and, the QR code may include an icon.

FIG. 34 illustrates a flowchart which shows the process of allowing a user to access the augmented reality content component of the event entertainment system through implementing the QR code component and/or accessory component of the event entertainment system.

FIG. 35 illustrates a flowchart of the variations of a server to report that a user may have interacted with the augmented reality component and/or QR code component of the event entertainment system.

### DETAILED DESCRIPTION

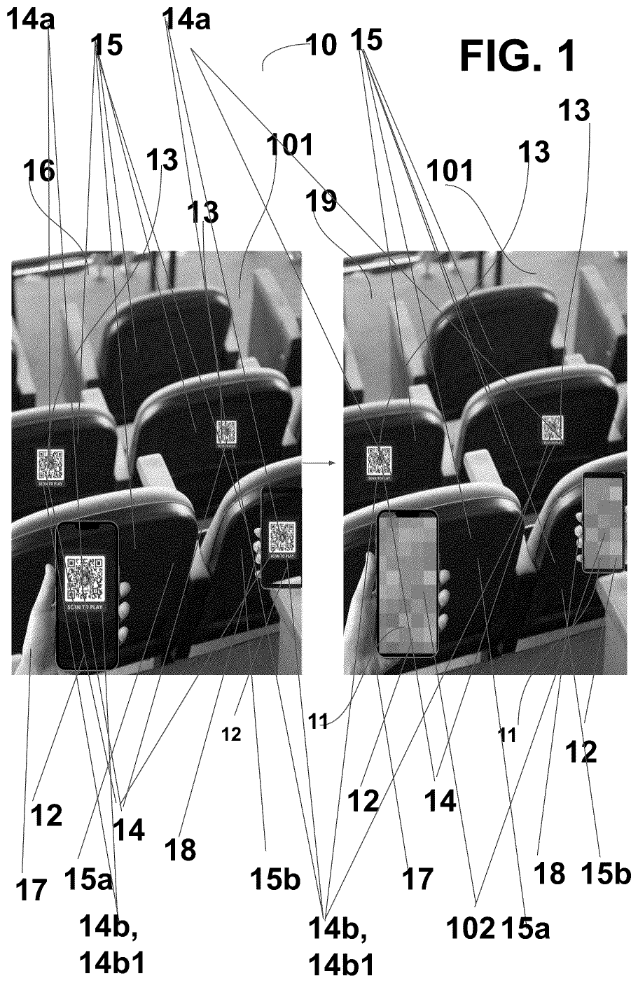

FIG. 1 illustrates a perspective view of the event entertainment system and the general interactions between the components of the event entertainment system.

Entertainment System: Event entertainment system 10 involves one of the following and/or a combination of the following components: augmented reality content 11, electronic device 12, accessory 13, and QR code 14. FIG. 1 shows accessory 13 attached to furniture 15. FIG. 1 shows that furniture 15 is illustrated as a telescopic seat with a backrest; but, there are many types of furniture that accessory 13 may be attached to. Although a QR code (such as QR code 14 of the event entertainment system 10) may provide a user access to augmented reality content 11, the QR code 14 illustrated in FIG. 1 serves as an illustration to further elaborate the components and/or details of this present disclosure. In image 16, hand 17 and hand 18 are holding their electronic devices 12 (which, in FIG. 1, are illustrated as smartphones) to scan QR code 14. Hand 17 represents a user who is sitting behind telescopic seat 15a; and, hand 18 represents a user who is sitting behind telescopic seat 15b. It is recommended that a user sits behind a chair (and/or a piece of furniture (whatever piece of furniture accessory component 13 may be attached to)) to scan a QR code to access augmented reality content 11; but, a user may physically be in any location (within the boundaries of a venue if the QR code is in the venue) he/she chooses to scan a QR code 14 if his/her electronic device 12 allows him/her to do so. A user may have the ability to scan QR code 14 wherever QR code 14 may be located; but, a user may have limited access to scan QR code 14 within a venue 101 if QR code 14 is located in venue 101. In image 19, pixel screen 102 shows that augmented reality content 11 has appeared on a user's electronic device 12 after the user scanned QR code 14 in image 16. Pixel screen 102 does not refer to a specific type, genre, theme, illustration, and/or animation of augmented reality content 11. Pixel screen 102 is illustrated to better understand the augmented reality content 11 component of event entertainment system 10. Image 16 and image 19 help identify the process of a user being able to interact with augmented reality content 11, in which the user's journey may involve encountering the action(s) presented in image 16 before encountering the action(s) presented in image 19. A person and/or venue operator may choose however many QR codes 14 and/or accessories 13 to attach to furniture 15. For instance, in image 16 and 19 of FIG. 1, one accessory 13 (which QR code 14 is attached to) is attached to four out of five pieces of furniture 15 in a venue. Other instances may include, but are not limited to, attaching accessory 13 to every piece of furniture 15 in a venue, attaching accessory 13 to every other piece of furniture 15 in a venue, and attaching accessory 13 to every third piece of furniture 15 in a venue. A form and/or component of event entertainment system 10, such as, but not limited to, augmented reality content 11, accessory 13, and QR code 14, may be modifiable at times, such as, but not limited to, before, during, and/or after an event.

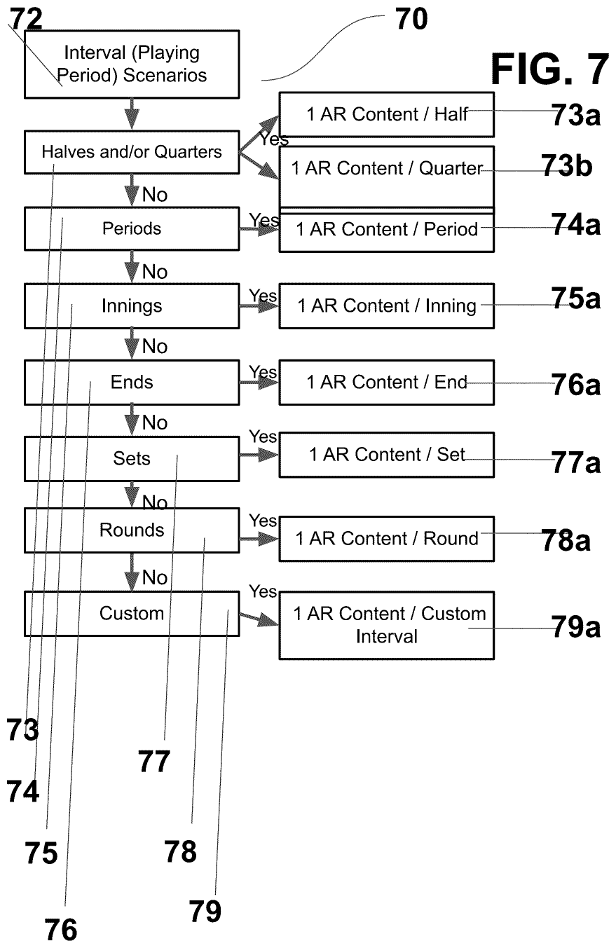

Venues: Event entertainment system 10 may be most useful when made for the benefit of a venue and/or buildings (herein referred to as “venue” and/or “venue 101” throughout this present disclosure). Venues 101 include, but are not limited to, amphitheaters, aquariums, arenas, airports, art houses, auditoriums, bowling alleys, bullrings, bus stations, movie theaters, civic centers, clubs, clubhouses, community centers, concert halls, drive-ins, fanzones, fitness centers, fun-plexes, gyms, halls, health clubs, malls, megaplexes, music halls, oceanariums, opera houses, palaces, piers, playgrounds, playhouses, redezvouses, stadiums, airports, universities, theme parks, hospital wait rooms, train stations, and theaters. The figures in this present disclosure may or may not take place in a venue 101. Augmented Reality Content: Augmented reality content 11 may be accessible via electronic device 12. Augmented reality content 11 may be classified as digital content that involves augmented reality and may be created for the purpose of a user to access and/or interact with digital content through an electronic device. Augmented reality content 11 may include an augmented reality game 11a and/or augmented reality instructions and/or animations 11b that may be personalized and/or customized with a venue's theme, marketing strategy, audience, and/or other aspects that may be personalized and customized for a venue 101. For example, augmented reality content 11 may be personalized and/or customized to cater to users who identify and/or associate themselves with a certain sports team and/or community, such as, but not limited to, the Los Angeles Dodgers baseball team and the Golden State Warriors basketball team. Augmented reality content 11 may be customized and/or personalized for an entity, such as, but not limited to a person, organization, business, venue, company, individual, and/or client. Augmented reality content 11 may be personalized and/or customized for an entity, such as, but not limited to, a person, organization, business, venue, company, individual, and/or client. The figures in this present disclosure may assume and/or show that augmented reality content 11 may be personalized and/or customized for venue 101 and/or the other aforementioned entities. Augmented reality content 11 may have instructions that may be personalized and/or customized to the event that a venue is hosting. For example, if a venue 101 is hosting a sports event, such as, but not limited to, a basketball game, then the instructions of augmented reality content 11 may be related to basketball and/or the basketball team(s) that may be associated with venue 101. Augmented reality content 11 may have animations that may be personalized and/or customized to the event that a venue 101 is hosting. For example, if a venue 101 is hosting a sports game, such as, but not limited to, a basketball game, then the animations of augmented reality content 11 may be related to basketball and/or the basketball team(s) that may be associated with venue 101. Augmented reality content 11 may include, but is not limited to, augmented reality games 11a and augmented reality instructions and/or animations 11b. Augmented reality games 11a may include augmented reality illustrations, instructions and/or animations 11b; but, augmented reality instructions and/or animations 11b may or may not be considered as an augmented reality game 11a. With augmented reality games 11a, a user (such as an attendee in a venue's event) may interact with the augmented reality game 11a with an electronic device 12 to achieve an outcome (such as, but not limited to, scoring 100 points in a game). With augmented reality instructions and/or animations 11b, a user may interact with the augmented reality instructions and/or animations 11b, which may involve, but is not limited to, the user allowing the screen presented in electronic device 12 to be customized to include animations indirectly and/or directly related to venue 101 and/or event. Augmented reality games 11a and augmented reality instructions and/or animations 11b may have beneficial use cases for augmented reality content 11 and for entities, such as, but not limited to users, individuals, companies, venues, organizations, championships, businesses, and teams. This present disclosure describes various examples and versions of augmented reality content 11 instead of involving a single piece of augmented reality content 11; but, a single piece of augmented reality content 11 may be provided as a part of the use and/or implementation of event entertainment system 10. When an entity, such as, but not limited to, a venue provides augmented reality content 11 as a part of its implementation and/or use of event entertainment system 10, one form and/or a variety of augmented reality content 11 may be provided before, during, and/or after an event. For example, a venue may choose to provide two types of augmented reality games 11a and one type of augmented reality illustrations and animations 11b during an event. Another example is that a venue may choose to provide one augmented reality game 11a during an event. These examples are further elaborated in FIG. 7. The following augmented reality content 11 described in this present disclosure may serve as examples of the types of augmented reality content 11 one may use during his/her/its/their use and/or implementation of event entertainment system 10 before, during, and/or after an event; but, the types of augmented reality content 11 one may use during his/her/its/their use and/or implementation of event entertainment system 10 are not limited to what is described in this present disclosure. A form and/or component of augmented reality content 11, such as, but not limited to, augmented reality games 11a and augmented reality illustrations and/or animations 11b, may be modifiable at a time, such as, but not limited to, before, during, and/or after an event.

Electronic Device: A user may interact with event entertainment system 10 by using his/her electronic device 12 to scan QR code 14 and/or to access augmented reality content 11. It is not required for a user to have and/or use electronic device 12 to interact with event entertainment system 10. A user may also interact with event entertainment system 10 without his/her electronic device 12 if he/she is interacting and/or mingling with another user who may have used his/her electronic device 10 to scan QR code 14 and access augmented reality content 11. An electronic device 12 may be any of the following, such as, but not limited to: mobile phones, smartphones, laptops, tablets, computers, and smart watches.

Accessory: Accessory 13 may be attached to a piece of furniture 15 in a venue 101. A piece of furniture 15 may defined as, but is not limited to, a chair, bleacher, gym bleacher, stadium seats, auditorium seats, cinema and theater armchairs, telescopic tribunes, sofas, couches, beam seats, fixed seats, seats made for education venues, seats made for sports venues, seats made for performing arts venues, seats made for locations with waiting areas, seats made for cinema halls, and seats made for worship venues. Accessory 13 may be any of the following items that has the ability to be attached to a piece of furniture 15; and, such items may include, but are not limited to, industrial C-clamps (industrial G-clamps), rubber, elastic, and plastic. QR code 14 may be attached to and/or serves as a part of accessory 13. It is possible that access to augmented reality content 11 may be provided to a user without the help of accessory 13 and/or QR code 14. A form and/or component of accessory 13, such as, but not limited to, the designs and/or materials of QR code 14, may be modifiable at a time, such as, but not limited to, before, during, and/or after an event.

QR Code: A user may scan QR code 14 to access and/or interact with augmented reality content 11. A user may scan QR code 14 with his/her electronic device 12 in order to be directed to either (or a combination of) a webpage, uniform resource locator (URL), web link, or mobile application that will provide and/or contain augmented reality content 11. A user may scan QR code 14, and may then be redirected to a mobile application with the help of a URL associated with QR code 14; and, once the user's electronic device 12 shows the webpage and/or application (preferably, mobile application), the webpage an/d/or application may contain and/or show augmented reality content 11 which the user may interact with. QR code 14 may include, but is not limited to, QR codes and AR codes. The following types of QR code 14 may be used, such as, but not limited to, a dynamic QR code or a static QR code, or a combination thereof. A dynamic QR code may be used because a venue 101 may change the appearance of the dynamic QR code's elements, may use a dynamic QR code to retrieve data regarding a user's activity and interaction with the dynamic QR code, and may modify the dynamic QR code in many other various ways. A static QR code may not have as many aforementioned capabilities as a dynamic QR code. For example, a status QR code may not have the modifiable and data-storing capabilities of a dynamic QR code. It is important to note that the orientation of QR code 14 may need to be adjusted to ensure that QR code 14 may be scanned correctly by an electronic device 12. It may be harder, yet possible, for an electronic device 12 to scan QR code 14 when QR code 14 is at a tilted/slanted position. When attaching accessory 13 to furniture 15, furniture 15 may be tilted/slanted, thus causing QR code 14 (attached to accessory 13) to be tilted/slanted as well. Solutions to this may include, but are not limited to, leaving the orientation of QR code 14 as is, and/or (fully and/or partially) offsetting the tilt/slant of QR code 14 and/or accessory 13 by tilting/slanting QR code 14 and/or accessory 13 in an opposite direction. QR code 14 may include an icon 14a. Icon 14a may include, but is not limited to, a logo, piece of art, animation, symbol, and/or mascot that may be directly and/or indirectly affiliated with a venue 101 and/or the type of event a venue 101 may be hosting, and/or a company logo. For example, in FIG. 1, icon 14a represents the logo of JEMPIRE INC. Another example is if icon 14a represents a mascot of a sports team that is directly and/or indirectly associated with the venue 101 and/or the event venue 101 is hosting. The bottom of frame 14b of QR code 14 includes a call-to-action 14b1, which gives the user an understanding of the type and/or genre of augmented reality content 11 to expect to interact with when/if they scan QR code 14 with their electronic device 12. For instance, call-to-action 14b1 may be illustrated as the words, “Scan To Play”. Frame 14b and call-to-action 14b1 may be included with and/or in QR code 14. Call-to-action 14b1 may help increase the chance a user will scan QR code 14 with his/her electronic device 12. If numerous, different types of augmented reality content 11 are broadcasted during an event, a user may scan QR code 14 and be able to access numerous, different types of augmented reality content 11 on his/her electronic device 12. For example, if two types of augmented reality content 11 (for example, a single player American football augmented reality game and a multiplayer American football augmented reality game) are broadcasted during an event, a user may scan QR code 14 at different times of the event and be able to access a different type of augmented reality content 11 during a specific time, time period, duration, and/or interval of an event. A user may or may not need to scan a QR code 14, such as, but not limited to, a QR code 14 in order to interact and/or play with augmented reality content 11; and, a QR code 14 may or may not need to be a part of event entertainment system 10. Including a QR code 14 in event entertainment system 10 provides many benefits, such as, but not limited to benefits in marketing and in creating exclusivity. A component of QR code 14, such as, but not limited, links and/or URL's associated with QR code 14, may be modifiable at a time, such as, but not limited to, before, during, and/or after an event. QR code 14 may provide access to one or more types of augmented reality content 11 before, during, and/or after an event. For example, QR code 14 may provide access to two augmented reality games 11a and four augmented reality illustrations and/or animations 11b during an event. Another example is that QR code 14 may provide access to one augmented reality game 11a before an event, two augmented reality games 11a during an event, and one augmented reality illustrations and/or animations 11b after an event.

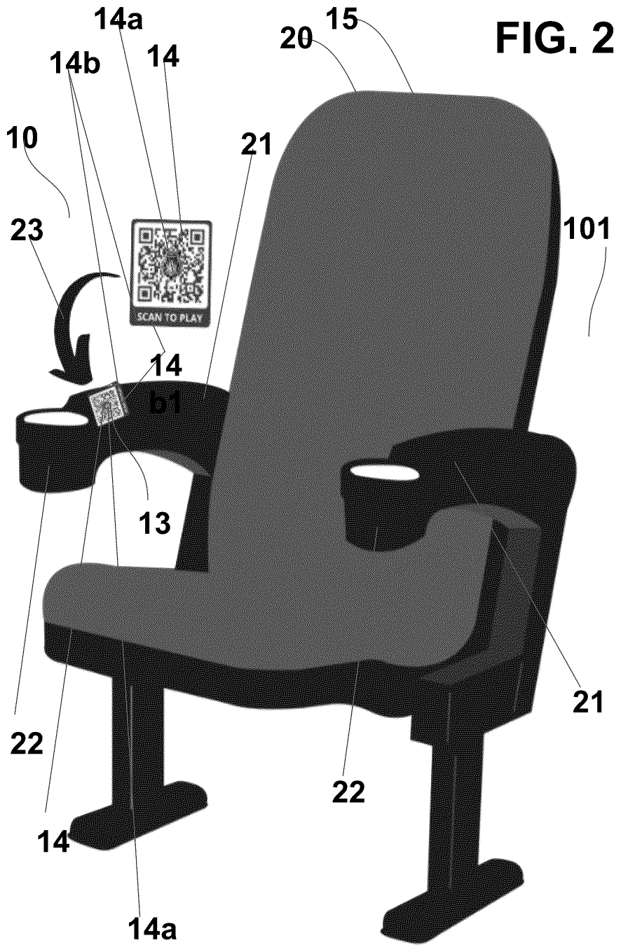

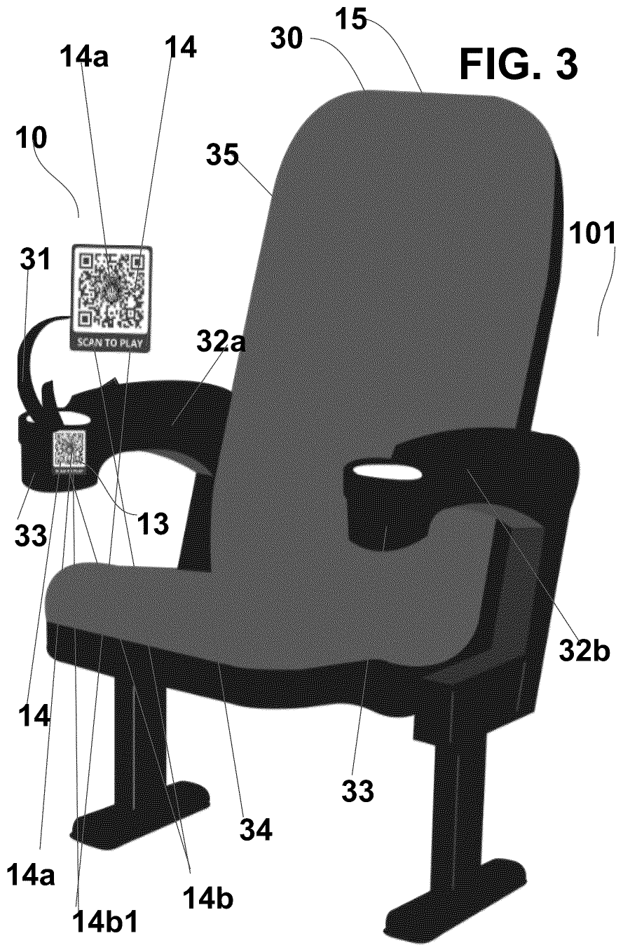

FIG. 2 illustrates a perspective view of event entertainment system 10 in which the accessory component 13 of the event entertainment system 10 is connected to the armrest of a chair. As illustrated in FIG. 2, chair 20 with armrest 21 is an example of the type of furniture 15 that can be classified as furniture 15. Chair 20 is an example of a chair with an armrest 21 that may be located in a venue 101. Cupholder 22 is shown as a part of chair 20 in FIG. 2; but, that doesn't imply that every chair that accessory 13 may be attached to has to be a chair 20 or a chair 20 with a cupholder 22. A larger image of QR code 14 is shown. Imaginary curved arrow 23 is pointing towards accessory 13 and QR code 14 (included with accessory 13) to show that both are installed onto the armrest 21 of chair 20. QR code 14 is shown as an illustration of the type of QR code that may be used in venue 101. Qr code 14 has icon 14a that may include, but is not limited to, a logo and/or piece of art and/or mascot that may be directly and/or indirectly affiliated with a venue 101 and/or the type of event that venue 101 may be hosting, and/or a company logo. In FIG. 2, icon 14a represents the logo of JEMPIRE INC. Icon 14a may also represent a mascot of a team and/organization, such as, but not limited to, a sports team that is directly or indirectly associated with venue 101 and/or the type of event that venue 101 is hosting. The bottom of frame 14b of QR code 14 includes call-to-action 14b1, which may help the user understand the type of augmented reality content 11 to expect to interact with if/when they scan QR code 14 with their electronic device 12. Call-to-action 14b1 reads, “Scan to Play”, which implies that if a user scans QR code 14 with his/her electronic device 12, he/she may be able to interact and/or play with augmented reality content 11 with his/her electronic device 12. The orientation of QR code may be faced towards the user. This means that QR code 14 may be facing upwards towards the sky and/or facing towards the front of backrest 24 of chair 20. The aforementioned orientation of QR code 14 in FIG. 2 means that if a user was sitting on chair 20, then QR code 14 may be facing the user. This aforementioned orientation is beneficial to the user because call-to-action 14b1, which reads, “Scan to Play” may be more easily legible to the user (in comparison to if call-to-action 14b1 and QR code 14 were faced in a direction away from the user); and, it may be a easier for the user's electronic device 12 to scan QR code 14. It may also be easier for electronic device 12 to scan QR code 14 if QR code 14 has a white background. Some figures in this present disclosure may illustrate that the background of QR code 14 is a color, or a combination of colors, other than white.

FIG. 3 illustrates a perspective view of the event entertainment system 10 in which the accessory component 13 of the event entertainment system 10 is connected to the cupholder of a chair. As shown in FIG. 3, it may be possible for QR code 14 and accessory 13 to be attached to cupholder 33 of chair 30. The orientation of QR code 14 may be faced towards that user. This is shown by QR code 14 facing the interior of chair 30 where seat 34 is located. The interior of chair 30 involves seat 34 and backrest 35 and is enclosed and/or surrounded by armrest 32a and armrest 32b. The interior of chair 30 is also where the user may sit. This orientation of QR code 14 in FIG. 3 means that if a user was sitting on chair 30, then QR code 14 may be facing the user. This aforementioned orientation is beneficial to the user because call-to-action 14b1, which reads, “Scan-to-Play” may be more easily legible to the user (in comparison to if call-to-action 14b1 and QR code 14 were faced a direction away from the user); and, it may be a easier for the user's electronic device 12 to scan QR code 14. When QR code 14 is attached to cupholder 33, it is likely that the material containing the image, elements, and/or design of QR code 14 may be curved as a result (due to the curvature of the surface of cupholder 33). In simpler terms, QR code 14 may be described as curved in this present disclosure. FIG. 3 implies that QR code 14 may be curved. In FIG. 3, QR code 14 may be flat with no curvature to the material containing QR code 14 or QR code 14 may be curved—which may depend on the curvature, or lack or curvature, of the surface of armrest 32a and/or another part of a piece of furniture 15 that accessory component 13 may be connected to. It is important to note that it may be easier for electronic device 12 to scan QR code 14 when QR code 14 has little to no bends or creases, has not been attached to a curved surface, has not been curved, and/or has not been affixed to a transparent plastic. If accessory 13 is attached to a curved surface, it may be better (for scannability purposes) for QR code 14 to not be curved; but, QR code 14 may be curved (as a result of accessory 13 being attached to a curved surface) and may be still readable by electronic device 12. Also, the more the material containing QR code 14 fades, the less likely electronic device 12 will be able to scan QR code 14. Imaginary curved arrow 31 is pointing towards accessory 13 and QR code 14 to show that both are installed onto the cupholder 33 of chair 30.

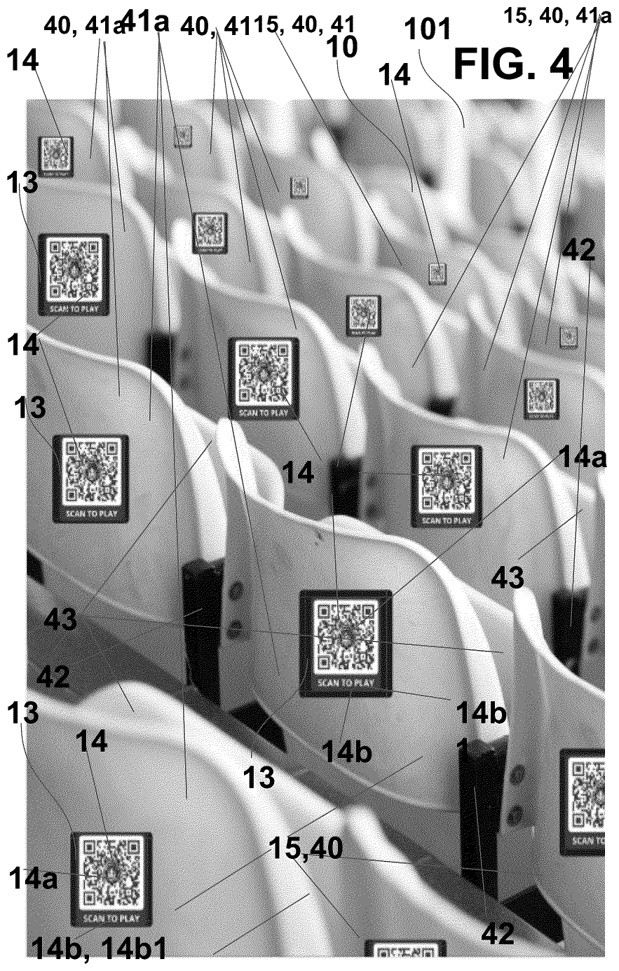

FIG. 4 illustrates a perspective view of the event entertainment system 10 being used at mass scale in a venue. Chair 40 serves as an example of a type of furniture 15. Chair 40 may have a backrest 41 and armrest 42. Chair 40 has a seat 43 that is pushed downwards at a seating position when a user sits on chair 40; and, seat 43 folds upwards towards backrest 41 when a user no longer sits on chair 40. Chair 40 may or may not have armrest 42. If chair 40 has armrest 42, it is likely that armrest 42 is shared between chair 40 and the chair 40 next to it. Accessory 13 is attached to the backside 41a of backrest 41. QR code 14 may be attached to accessory 13 and/or be a part of accessory 13. FIG. 4 shows QR code 14 attached to accessory 13; and, other figures in this present disclosure may show QR code 14 as a part of accessory 13. With QR code 14 located on the backrest 41a of backrest 41, a user sitting on a chair behind chair 40 may easily scan QR code 14 to interact with augmented reality content 11. In FIG. 4, QR code 14 and accessory 13 is implied to be attached to every chair 40 in venue 101; but, one may choose other methods for attaching QR code 14 and accessory 13 to chair 40, such as, but not limited to, every other chair 40, every third chair 40, etc. FIG. 4 implies that QR code 14 and accessory 13 has been attached to every chair 40 of venue 101. FIG. 4 implies that QR code 14 and accessory 13 has been attached to every chair 40 of venue 101. Event entertainment system 10 may be used at mass scale because, with multiple QR codes 14 available to be scanned (with electronic device 12) throughout venue 101, more users have the opportunity to interact with augmented reality content 11. More than one user may scan the same QR code 14, which means that for many users to have access to QR code 14, QR code 14 may not need to be attached to every chair 40 in venue 101; but, QR code 14 may need to be attached to a considerable amount of chairs 40. This is because if venue 101 has a large capacity of users (such as 60,000 users in a venue 101), it may be unlikely that all 60,000 users may be able to use their electronic device 12 to scan QR code 14 to access augmented reality content 11. Rather, it may be more feasible for QR code 14 to be attached to a much larger amount of chairs 40; and, doing so may make QR code 14 more accessible for users to scan QR code 14 with electronic device 12. For instance, affixing QR code 14 to every other chair 40 (i.e. a total of 30,000 chairs) instead of one chair 40 or all chairs 40 (i.e. a total of 60,000 chairs) may be more feasible for users to scan QR code 14 with their electronic device 12. One may argue that, for instance in venues 101 such as, but not limited to indoor/outdoor stadiums/arenas, a QR code 14 may be presented digitally within a venue 101's jumbotron for users to have access to scan QR code 14 with their electronic device 12. However, when a QR code 14 is placed on a jumbotron, it may be likely that not all users may have the ability to scan QR code 14 because, especially in venue 101's that may be shaped as rounded and/or with curvature(s) (i.e. dome-shaped venues, sphere-shaped venues, oval-shaped venues, etc.), it may be difficult for an electronic device 12 to scan QR code 14 because some and/or all of QR code 14's may not face the camera of some and/or all electronic device 12's. In other words, the orientation of QR code 14, in most cases, may need to face the camera of electronic device 12 (and/or vice versa) so that QR code 14 may be scanned properly by electronic device 12. The more QR code 14's orientation faces away from the camera of electronic device 12, the less likely QR code 14 may be scanned by electronic device 12. One may choose to place QR code 14 in various digital and/or physical locations, such as, but not limited to, a television, tablet, jumbotron or furniture 15. When describing QR code 14's and/or accessory 13's attachment, connection, and/or installation to furniture 15 throughout this present disclosure, if accessory 13 is attached to furniture 15, QR code 14 may be implied to be attached to furniture 15 as well; but, when QR code 14 is attached to furniture 15, it may be implied that accessory 13 is attached to furniture 15 as well. In FIG. 4, QR code 14 may have the same design (with or without frame 14b and/or call-to-action 14b1) and may be embedded with the same link as the other QR code 14's in FIG. 4. It is possible that when more than one QR code 14 is attached to furniture 15 in venue 101, the design of the QR codes may differ while the link(s) that is(are) embedded into the QR code 14's may be the same; and, it is possible that the design of the QR codes may be the same while the link(s) that is(are) embedded into the QR code 14's may differ. There are many reasons why a person and/or venue operator may want to keep the design of QR code 14 the same throughout venue 101, which include, but are not limited to, wanting to maintain continuity with icon 14a throughout venue 101 and wanting to associate the design of a QR code 14 with a particular event and/or individual. There are many reasons why a venue operator may want to keep the design of QR code 14 different throughout venue 101, which include, but are not limited to, presenting an icon 14a of a sports team's mascot that may be affiliated with the opposing team of the aforementioned team (that venue 101 may be affiliated with). For instance, if a venue 101 is hosting an event which users and/or fans of an opposing team (to venue 101's affiliated team) are attending, then displaying icon 14a as a mascot of the opposing team may make the aforementioned users/fans feel welcomed and/or be more entertained when attending venue 101. There are many reasons why a venue operator may choose to keep the link affiliated with QR code 14 the same throughout venue 101, which include, but are not limited to, marketing the team that venue 101 may be affiliated with to venue 101's attendees. There are many reasons why a venue operator may choose to make the link affiliated with QR code 14 different throughout venue 101, which include, but are not limited to, engaging attendees who are affiliated with the opposing team of the team that venue 101 may be affiliated with. When a link that is affiliated with QR code 14 changes, it may or may not be implied that the augmented reality content 11 changes too. A person and/or venue operator may involve, but is not limited to, a person who manages the operations of venue 101, a person who manages the operations of an organization affiliated with venue 101 (i.e. a sports team, sports federation, etc.), a person who manages the event being hosted in venue 101, etc.

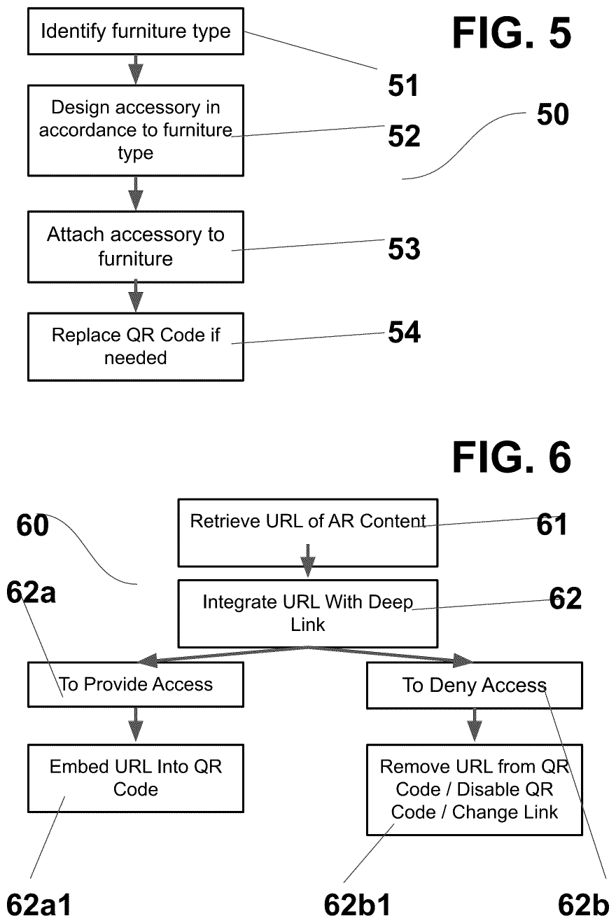

FIG. 5 illustrates a flowchart of a method 50 of affixing an accessory 13 to a piece of furniture 15 in a venue. Step 51 of method 50 is to identify the type of furniture 15 that is in venue 101. Accessory 13 may be attached to a seat(s) (such as, but not limited to, a chair, bleacher, gym bleacher, stadium seat, auditorium seat, cinema and/or theater armchair, telescopic tribune, beam seats, fixed seat, etc.); but, accessory 13 (and thus, QR code 14) may be attached to other types of furniture 15 (such as, but not limited to, the ground, wall(s), ceiling(s), etc.). Step 52 implies that a person may need to ensure that accessory 13 and QR code 14 are properly attached to furniture 15 and that QR code 14 is oriented adequately when attached to accessory 13. Suggestions regarding the orientation of QR code 14 are elaborated in of FIG. 1 and are visualized in many figures, including, but not limited to FIGS. 2, 3, and 4. Orientations to consider when connecting QR code 14 to furniture 15 include, but are not limited to, ensuring that QR code 14 directly faces the user so his/her electronic device 12 may scan QR code 14, tilting/slating QR code 14 and/or accessory 13 to offset the tilt, slant, and/or curvature of furniture 15 to make it easier for a user to scan QR code 14 with his/her electronic device 12. Step 53 says to attach accessory 13 to furniture 15, which may involve, but is not limited to, using nails and/or other pieces of metal to attach accessory 13 onto furniture 15, using adhesive(s) and/or elastic(s) to attach accessory 13 to furniture 15, etc. Step 54 says to replace QR code 14 if necessary. It is likely that while QR code 14 may be attached to furniture 15 in a venue 101 (if located outdoors), the sunlight and/or other weather conditions may cause damages to QR code 14, such as, but not limited to, wear, tear, and/or the fading of QR code 14. The more the aforementioned damages occur to QR code 14, the less likely QR code 14 may be able to be scanned by electronic device 12. The aforementioned damages may also occur to QR code 14 if venue 101 is indoors. Other damages may include damages caused by people, such as, but not limited to, putting graffiti and/or causing wear and/or tear on QR code 14. Other damages may include marks and/or graffiti that cover a big portion of the design of QR code 14. For instance, if drawings, marks, images, and/or graffiti cover too much of the design of QR code 14, an electronic device 12 may not be able to scan QR code 14. Method 50 may be repeated for however many furniture 15's a person and/or venue operator chooses to install QR code 14 onto. It may be assumed that when repeating method 50 to install QR code 14 onto more than one furniture 15, the same design of QR code 14 may be used; and, it may be assumed that furniture 15 may be the same type of furniture 15 throughout venue 101. QR code 14 may have the same design and/or be affiliated with the same link (aka to redirect electronic device 12 to the same and/or different augmented reality content 11), but one may choose to change the design of QR code 14 and/or the link affiliated with QR code 14 for each furniture 15 of venue 101. If the type of furniture 15 differs throughout venue 101, one may repeat steps 51, 52, and/or the following steps of method 50 as needed to affix the right type of accessory 13 piece and/or QR code 14 to furniture 15.

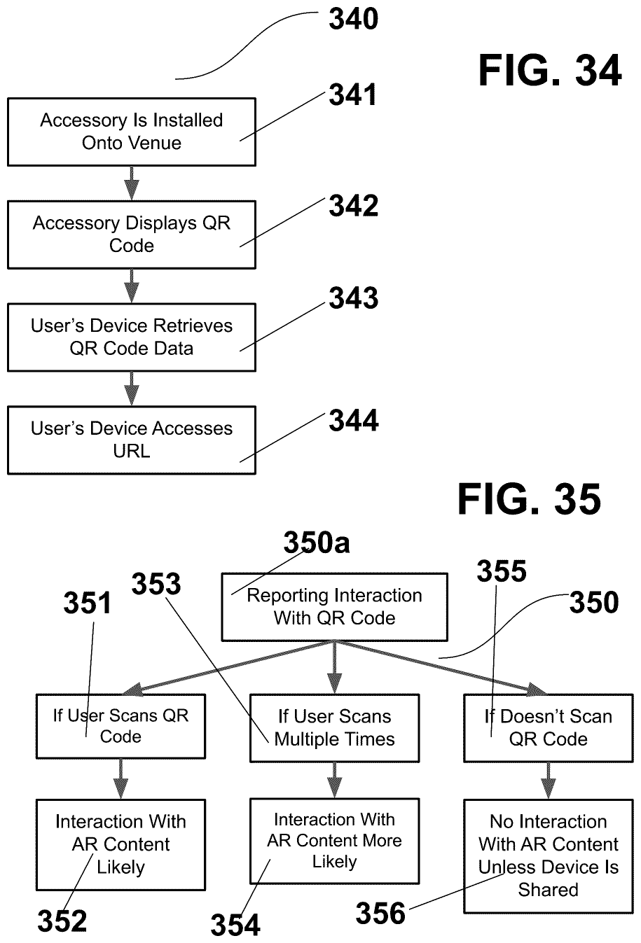

FIG. 6 illustrates a flowchart of a method 60 of broadcasting the augmented reality component 11 of the event entertainment system 10 during a venue 101's live event. Step 61 says to retrieve the URL of augmented reality content 11. Augmented reality content 11 may include, but is not limited to, an augmented reality game 11a and/or augmented reality instructions and/or animations 11b that may be personalized and/or customized with a venue's theme, marketing strategy, audience, and/or other aspects that may be personalized and/or customized for a venue 101, organization, party, individual, etc. Step 61 assumes that an augmented reality game 11a and/or augmented reality instructions and/or animations 11b has been made and/or developed and/or in the testing stage; and, step 61 assumes that augmented reality game 11a and/or augmented reality instructions and/or animations 11b may be accessible via a URL. Augmented reality content 11, such as an augmented reality game 11a and/or augmented reality instructions and/or animations 11b, may be accessible via mediums other than a URL, such as, but not limited to, a mobile application with and/or without a URL; however, for the purpose of better understanding and following the steps of method 60, augmented reality content 11 may be accessible via a URL, webpage and/or mobile application. Augmented reality 11 may be accessible via a URL, webpage, and/or mobile application. Step 62 says to take the URL that gives access to augmented reality content 11, and integrate that URL with a deep link. Deep links may be used on an electronic device 12 when electronic device 12 may or may not be connected to the Internet. Deep links may be very useful when associated with a mobile application and may make a user's interactivity with event entertainment system 10 and/or augmented reality content 11 more seamless and effective. In regards to deep links that are associated with mobile applications, a deep link allows a user to launch an application on an electronic device 12 and open a specific page within the application once a user clicks and/or enters a URL on a web page or on another app. The advantage of deep links is that it makes it easier and/or faster for a user to move between a web page or application. Event entertainment system 10 may service its function without deep links. Deep links may be resourceful in/for event entertainment system 10 when a user attempts to access augmented reality content 11. In the scenario in which augmented reality content 11 is accessible via an application, after retrieving a URL to access augmented reality content 11 in his/her electronic device, a user may click the URL and launch augmented reality content 11 within the application that houses (and/or is associated with) augmented reality content 11. If a deep link is not integrated with the URL of augmented reality content 11, then when a user clicks on the URL with an electronic device 12, a user may be directed to a webpage that may be associated with augmented reality content 11; but, the user may not be able to interact and/or play with augmented reality content 11 if the application is not launched on electronic device 12. The aforementioned scenario may apply to augmented reality content 11 that may be accessible via an application. The aforementioned scenario may apply to augmented reality content 11 that may be accessible with or without an application, which implies that a user may be able to interact with augmented reality content 11 with or without launching an application and with or without integrating a deep link with the URL associated with augmented reality content 11. If a deep link is not integrated with the URL of augmented reality content 11, then when a user clicks on the URL with his/her electronic device 12, a user may be directed to a webpage that is associated with augmented reality content 11, but the user may not be able to interact and/or play with augmented reality content 11 if the application is not launched on electronic device 12. If a deep link is integrated with the URL of augmented reality content 11, then when a user clicks on the URL with his/her electronic device 12, a user may be directed to a webpage that may be associated with the augmented reality content 11, then electronic device 12 may automatically (or not automatically—depending on the type of deep link integrated with augmented reality content 11 (i.e. default deep link, deferred deep link, contextual deep link)) launch the application that is associated with and/or houses augmented reality content 11. Then, once the application launches, the user may be able to interact and/or play with augmented reality content 11 in the electronic device 12. Deep links may also be beneficial in motivating a user to interact with augmented reality content 11 because with deep links, there are less steps a user has to take to be able to access augmented reality content 11 when the URL of augmented reality content 11 is integrated with a deep link as opposed to when the URL of augmented reality content 11 is not integrated with a deep link. The steps that a user may take to be able to access augmented reality content 11 are explained in more detail in FIG. 34. Regardless of integrating a URL of augmented reality content 11 with a deep link, the feasibility of a user being able to access augmented reality content 11 differs with whether the user has the application (that may be associated with and/or houses augmented reality content 11) installed in electronic device 12; and, the feasibility differs with whether a default deep link, deferred deep link, or contextual deep link is integrated with the URL of augmented reality content 11. If a default deep link is integrated with the URL of augmented reality content 11, then when a user clicks on the URL, the default deep link may allow the user to launch the application that is associated with and/or houses augmented reality content 11 if the application is installed on his/her electronic device 12. If the application is not installed on his/her electronic device 12, then the user may be directed to a webpage that may be associated with augmented reality content 11; but, the user may not be able to interact with augmented reality content 11 if the application is not launched on electronic device 12. FIG. 6 assumes that electronic device 12 should have the application that is associated with and/or houses augmented reality content 11 installed in order to launch the aforementioned application on electronic device 12. If a deferred deep link is integrated with the URL of augmented reality content 11, then when a user clicks on the URL, the deferred deep link may allow the user to launch the application that is associated with and/or houses augmented reality content 11 if the application is installed on his/her electronic device 12. If the application is not installed on his/her electronic device 12, then when the user clicks on the URL, the deferred deep link may direct the user to a website and/or application (i.e. Google Play Store, Apple App Store, etc.) that may allow the user to install the application that is associated with and/or houses augmented reality content 12. Once the user downloads the application that is associated with and/or houses augmented reality content 11 from the aforementioned website and/or application (i.e. Google Play Store, Apple App Store, etc.), the user may be directed to the augmented reality content 11 within the installed application that is associated with and/or houses augmented reality content 11. Step 62a is the name of a condition that a person following method 60 may want to meet. The condition a person may want to meet in step 62a is to provide a user access to augmented reality content 11. In order to provide a user access to augmented reality content 11, a user may add a URL into and/or with QR code 14 (as mentioned in Step 62a1). The aforementioned URL may redirect a user to a webpage and/or application that may feature, associate with, and/or house augmented reality content 11. Step 62b is the name of a condition that a person following method 60 may want to meet. The condition a person may want to meet in step 62b is to not provide a user access to augmented reality content 11. There are multiple ways (as mentioned in Step 62b1) a person may deny a user's access to augmented reality content 11. One way to deny a user's access to augmented reality content 11 may be to remove the URL from QR code 14. When a person follows step 62b1, the aforementioned URL may no longer redirect a user to a webpage and/or application that may feature, associate with, and/or house augmented reality content 11. Another way to deny a user's access to augmented reality content 11 may be to make QR code 14 unscannable by electronic device 12. A few ways to make QR code 14 unscannable include, but are limited to, changing the orientation and/or curvature of QR code 14 to the extent that QR code 14 may be unscannable, enlarging icon 14a to the extent that QR code 14 may be unscannable, putting drawings, marks, images, and/or graffiti that covers QR code 14 to the extent that QR code 14 may be unscannable, and having wear, tear and/or damage on QR code 14 to the extent that QR code 14 may be unscannable.

FIG. 7 illustrates a flowchart of a method 70 for broadcasting the augmented reality content 11 component of the event entertainment system 10 in correspondence with the type of event a venue 101 may be hosting and/or the event association a venue 101 may be affiliated with. Method 70 may be a method for deploying event entertainment system 10 at a personalized schedule in conjunction with venue 101's live event. Interval 71 (aka playing period) may vary depending on the type of live event being hosted by venue 101. Interval 71 (aka playing period) may be classified as a division of time in an event, game, and/or sport, in which a play and/or activity is done. Step 72 says to identify the type of interval 71 that is associated with the live event. For instance, interval 71 may be characterized as any of the following situations 73, 74, 75, 76, 77, 78, and/or 79. Situation 73 involves the intervals, halves and/or quarters. A live event that may be associated with situation 73 may include, but is not limited to, a basketball game and/or an American football game. Basketball games and football games are divided into halves, and may be further divided into quarters. An American football game may also include an additional quarter, which is called overtime; and, overtime occurs if the score is a tie between the two teams playing against each other at the end of the fourth quarter. If a live event is associated with situation 73, then augmented reality content 11 may be broadcasted every half (aka situation 73a) and/or augmented reality content 11 may be broadcasted every quarter (aka situation 73b). The event associations associated with basketball (aka basketball leagues) include, but are not limited to, National Basketball Association (NBA), NCAA Men's Division I Basketball Championship (NCAA Division I), and Women's National Basketball Association (WNBA). The event associations associated with American football (aka American and Canadian football leagues) include, but are not limited to, National Football League (NFL), Canadian Football League (CFL), European League of Football (ELF), and Japan American Football League (X-League). Situation 74 involves the interval, periods. A live event that may be associated with situation 74 may include, but is not limited to, a floorball game and/or an ice hockey game. In most, but not all, cases, floorball games and ice hockey games are divided into three periods. An additional (forth) period, called overtime, may occur if the score is a tie between the two teams playing against each other at the end of the third period. If a live event is associated with situation 74, then augmented reality content 11 may be broadcasted every period (aka situation 74a). The event associations associated with floorball (aka floorball leagues) include, but are not limited to, North American Floorball League (NAFL), Champions Cup, EuroFloorball Cup, and Men's World Floorball Championship. The event associations associated with ice hockey (aka ice hockey leagues) include, but are not limited to, National Hockey League (NHL), American Hockey League (AHL), and Canadian Hockey League (CHL). Situation 75 involves the interval, innings. A live event that may be associated with situation 75 may include, but is not limited to, a cricket game and/or a baseball game. Cricket games and baseball games are divided into innings, and may be further divided depending on the type of game. If a live event is associated with situation 75, then augmented reality content 11 may be broadcasted every inning (aka situation 75a). The event associations associated with cricket (aka cricket leagues) include, but are not limited to, Indian Premier League (IPL), England and Wales Cricket Board (ECB), and Bangladesh Premier League (BPL). The event associations associated with baseball (aka baseball leagues) include, but are not limited to, Major League Baseball (MLB), Minor League Baseball (MiLB), and Nippon Professional Baseball (NPB). Situation 76 involves the interval, ends. A live event that may be associated with situation 76 may include, but is not limited to, curling contests. If a live event is associated with situation 76, then augmented reality content 11 may be broadcasted every end (aka situation 76a). The event associations associated with curling (aka curling leagues) include, but are not limited to, Curling at the Olympics and curling clubs. Situation 77 involves the interval, sets. A live event that may be associated with situation 77 may include, but is not limited to, a volleyball game and/or a tennis game. The match for volleyball games and tennis games end when a team or individual wins the necessary amount of sets. This differs from the other games/sports because there may not be a definitive number of sets in a game/sport. If a live event is associated with situation 77, then augmented reality content 11 may be broadcasted every set (aka situation 77a). The event associations associated with volleyball (aka volleyball leagues) include, but are not limited to, FIVB Volleyball World League (FIVB), USA Volleyball, and Pro Volleyball League (PVL). The event associations associated with tennis (aka tennis leagues) include, but are not limited to, World Team Tennis (WTP), Atlanta Open Tennis, and US Open. Situation 78 involves the interval, rounds. A live event that may be associated with situation 78 may include, but is not limited to, a mixed martial arts (MMA) fighting game, a boxing match, and a wrestling match. MMA games typically have a maximum of three to five rounds in a game. Boxing matches typically have a maximum of twelve rounds in a game. In both sports/games, the number of rounds may not be definitive and may depend on how the winning individual wins the game/match. If a live event is associated with situation 78, then augmented reality content 11 may be broadcasted every round (aka situation 78a). The event associations associated with MMA (aka MMA leagues) include, but are not limited to, Ultimate Fighting Championship (UFC), One Championship, and International Fight League (IFL). The event associations associated with boxing (aka boxing leagues) include, but are not limited to, World Boxing Association (WBA), World Boxing Council (WBC), and International Boxing Federation (IBF). The event associations associated with wrestling matches (wrestling leagues) include, but are not limited to, WrestleMania, WWE Championship, and Royal Rumble. Situation 79 involves custom broadcasting intervals. Custom is classified as broadcasting augmented reality content 11 at any time and/or at any frequency during the event venue 101 may be hosting. A person (i.e. venue operator) may choose to have custom broadcasting regardless of the type of live event that venue 101 may host. There may be variations of how augmented reality content 11 may be broadcasted at a given time and/or a given frequency. One example of a custom broadcasting interval may be that a person and/or venue operator may choose to broadcast augmented reality content 11 once during the entire event, such as, but not limited to, a basketball game. Another example of a custom broadcasting interval may be to broadcast augmented reality content twice during an event, which may include broadcasting one type of augmented reality content 11 during the beginning of the event (i.e. tennis match) and another type of augmented reality content 11 near the end of the event (i.e. the aforementioned tennis match). Another example of custom broadcasting may be to not broadcast during intervals, but rather to broadcast augmented reality content 11 every time a team and/or individual scores a point, misses a point, and/or loses a point, etc. For example, if there are twelve rounds in a boxing match, it may not be practical to broadcast augmented reality content 11 for each round, but rather it may be practical to broadcast augmented reality content 11 every time an individual (that venue 101 favors) wins a round and/or makes a noteworthy action against the opponent. It is recommended that one may keep the augmented reality content 11 broadcasted long enough for a user to interact with augmented reality content 11. Another example of custom broadcasting may include, but are not limited to, broadcasting augmented reality content 11 every other interval and every two intervals. Events, such as, but not limited to, musicals and concerts may benefit when augmented reality content 11 is broadcasted is a custom manner, as described in steps 79 and 79a.

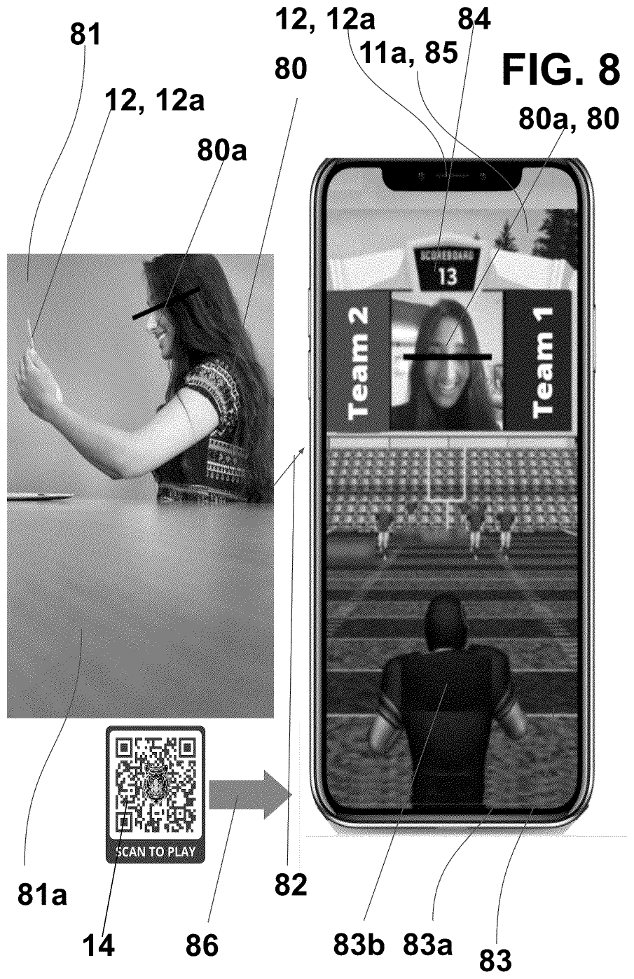

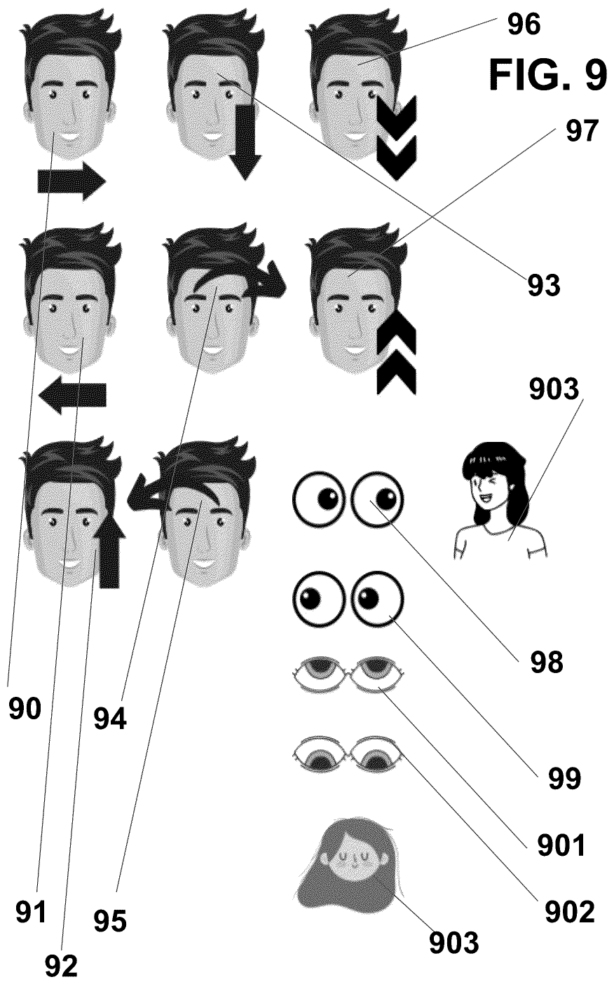

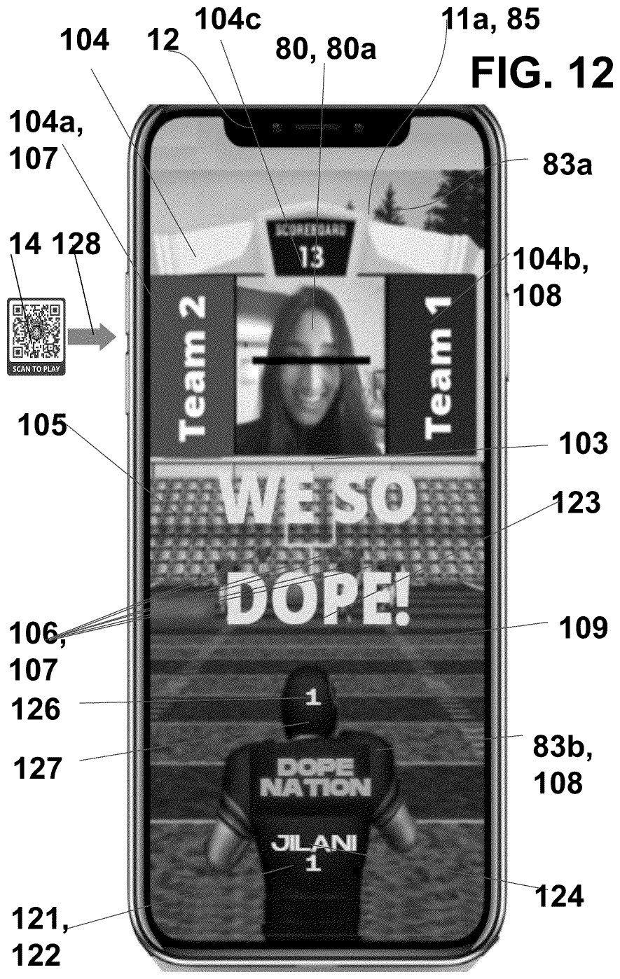

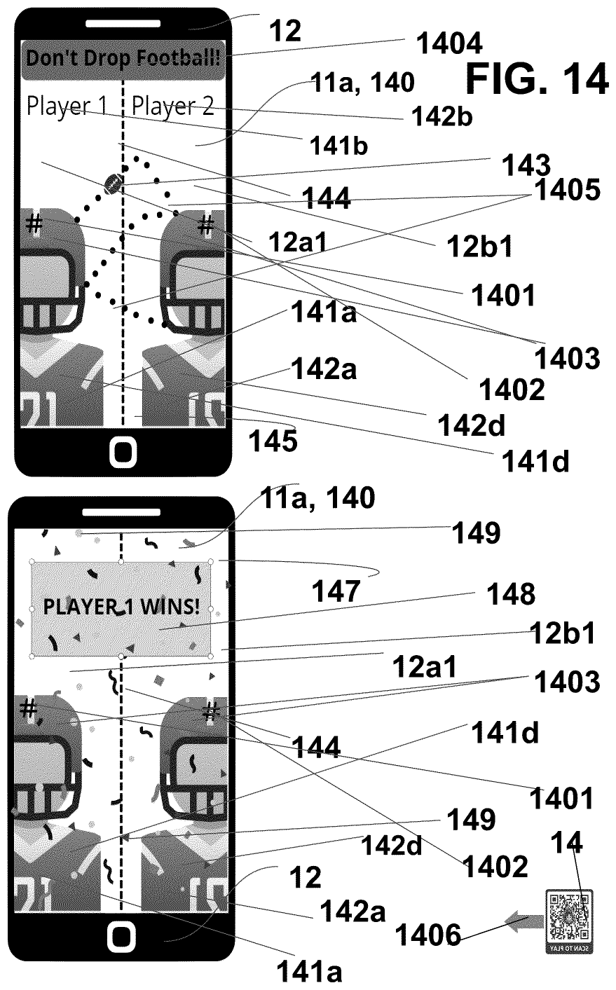

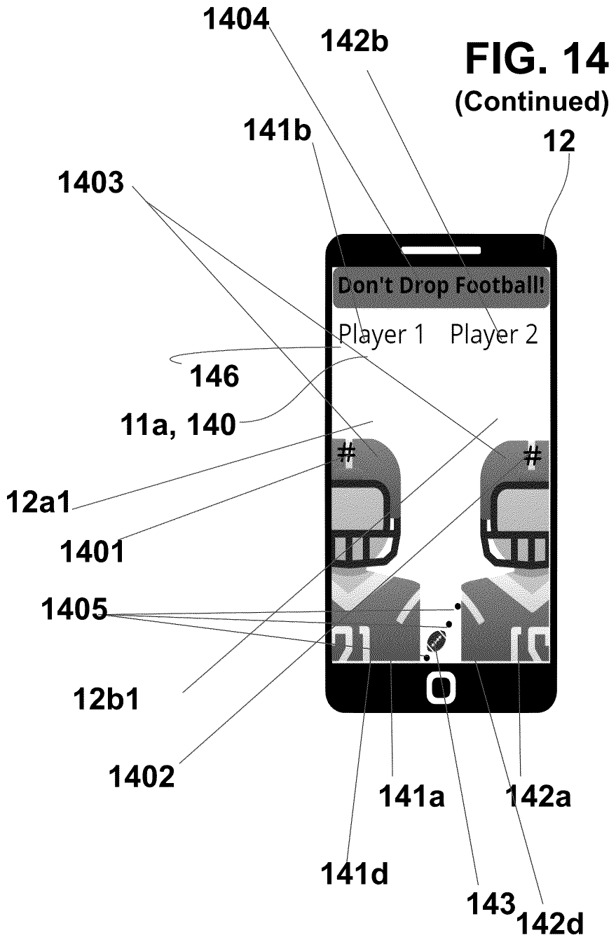

FIG. 8 illustrates a perspective view of an exemplative augmented reality game 11a in which the user 80's face 80a and/or another part of user 80's body serves as the remote control of an augmented reality game 11a in the augmented reality content 11 component of event entertainment system 10. Image 81 shows user 80 holding electronic device 12. The electronic device 12 that user 80 is holding is smartphone 12a. Electronic device 12 may be any electronic device, with the capability to scan QR code 14, such as, but not limited to, smartphone 12a. Image 81 assumes that user 80 has already scanned QR code 14 to retrieve access to augmented reality game 11a (such as, but not limited to, augmented reality game 85 in FIG. 8); however, it is likely that user 80 may hold electronic device 12 at or near the same position and/or orientation to allow electronic device 12 scan QR code 14. Any augmented reality content 11, such as, but not limited to, an augmented reality game 11a and/or augmented reality instructions and/or animations 11b may be used to include, provide, and/or broadcast augmented reality content 11 as a part of event entertainment system 10; but, FIG. 8 shows user 80 interacting with augmented reality game 11a for the purpose of better understanding FIG. 8 and this present disclosure. User 80 may interact with augmented reality content 11 which includes, but is not limited to, augmented reality game 11a and/or augmented reality instructions and/or animations 11b. User 80 may hold smartphone 12a at a position and/or orientation to allow the camera of smartphone 12a to capture user 80's face in order for user 80 to interact with augmented reality game 11a. It may not be required for an electronic device 12 to capture a user's face in order for the user to interact and/or play with augmented reality content 11; but, for the augmented reality game 11a illustrated in FIG. 8, smartphone 12a may need to capture user 80's face in order to interact with augmented reality game 11a (in FIG. 8, specifically augmented reality game 85). User 80's face may be needed for user 80 to play with augmented reality game 11a because user 80's face may serve as the remote control to play augmented reality game 11a. Arrow 82 shows the linkage between image 81 and image 83. Image 81 shows user 80 in the real world 81a. Image 83 shows user 80's face 80a in the augmented reality world 83a. In image 81, FIG. 8 shows that user 80 is located in a location other than venue 101; but, it is implied that user 101 is located in venue 101. A user may be located in venue 101 or a location other than venue 101; a user may be located in venue 101 because it may make event entertainment system 10 more advantageous for venues 101 to implement. Ideally, user 80 may be sitting on a seat that may or may not be classified as part of furniture 15; and, user 80 may be holding electronic device 12 before, during, and/or after interacting with augmented reality content 11. The real world 81a involves the existing state of things. The augmented reality world 83a involves some and/or all things that are simulated, digitized, and/or imaginary. The augmented reality world 83a may also involve and/or incorporate real world 81a into augmented reality world 83a, such as, but not limited to, user 80's face 80a. In image 83, the background, animations, and/or environment of the augmented reality world 83a and/or augmented reality game 11a may mimic the background and/or environment of venue 101. In FIG. 8, the background, animations, and/or environment of the augmented reality world 83a and/or augmented reality game 11a may resemble the background and/or environment of venue 101. The extent to which the background, animations, and/or environment of the augmented reality world 83a and/or augmented reality game 11a closely resembles the background and/or environment of venue 101 is further elaborated in figures including, but not limited to, FIG. 12 and FIG. 14. Image 81 and image 83 show user 80 and user's face 80a at different angles/views. Image 81 shows a side profile of user 80 to better understand that user 80 is using smartphone 12a to interact with augmented reality game 11a. Image 83 shows a front profile of user's face 80a to show that user's face 80a may be needed for user 80 to interact with and/or play with augmented reality game 11a in FIG. 8 because user's face 80a serves as the remote control to play augmented reality game 11a. Image 83 also shows character 83b. Character 83b represents user 80's avatar in augmented reality game 11a. Character 83b is a figure representing user 80 in augmented reality game 11a. With user's face 80a serving as a remote control, user 80 may use various head, eye, and/or face movements to dictate how character 83b moves in the augmented reality game 11a in order for user 80 to play augmented reality game 11a. Various head/eye/face movements that a user may make to interact and/or play with augmented reality content 11 are illustrated in FIG. 9. In augmented reality game 11a of FIG. 8, the user's face 80a may need to move side to side to play augmented reality game 11a. If user's face 80a moves side to side, then character 83b may also move side to side in order for user 80 to play augmented reality game 11a. It is possible, but not required, that when interacting with augmented reality game 11a, the orientations of the head/eye/face movements of user 80 may lead to the same and/or similar orientations and/or movements of character 83b on electronic device 12 and/or augmented reality content 11. For instance, when user 80 moves user 80's face 80a leftwards in real world 81a, character 83b may move leftwards in the augmented reality world 83a and/or augmented reality content 11. When user's face 80a serves as a remote control for augmented reality game 11a, it is not required for character 83b to be a part of augmented reality game 11a; but, character 83b is illustrated in FIG. 8 to better understand how user's face 80 serves as a remote control; and, character 83b is illustrated in FIG. 8 because the augmented reality game 11a illustrated in FIG. 8 may need a character 83b as a part of the augmented reality game 11a. In augmented reality game 11a, a score 84 may be provided to see the number of points user 80 scored when interacting and/or playing with augmented reality content 11. For example, the augmented reality game 11a of FIG. 8 shows that user 80 currently scored 13 points (which represents score 84) while in the process of interacting and/or playing with augmented reality game 11a. The number of points that user 80 scores (aka score 84) may be dependent on how and/or when user 80 uses user's face 80a as a remote control and/or how (and/or if) augmented reality game 11a detects user 80's various head/eye/face/touch movements. In the augmented reality game 11a of FIG. 8, the number of points that user 80 scores (aka score 84) may change depending on how and/or when user's face 80a moves. QR code 14 and arrow 86 are shown to imply that a user may use an electronic device 12 to scan QR code 14, and scanning QR code 14 may allow the user(s) to retrieve access to augmented reality content 11, such as, but not limited to, digital game 13. A user may retrieve access to digital game 13 via methods other than scanning QR code 14, such as, but not limited to, being provided with a URL.

FIG. 9 illustrates various methods for a user to interact with the augmented reality content 11 component of event entertainment system 10 through various head, face, and eye movements. The head, face, and eye movements allow a user to interact with augmented reality content 11. In the types of augmented reality content 11 that involve a user using his/her face and/or another part of his/her body as a remote control to interact with augmented reality content 11, various head, face, and/or eye movements may be how a user uses his/her face and/or another part of his/her body as a remote control of augmented reality content 11. Also, various head, face, and/or eye movements may be how a user uses his/her face and/or another part of his/her body to move his/her avatar/character in an augmented reality content 11. While the tracking of these head, face, and eye movements already exist in services that involve and/or provide augmented reality, these head, face, and eye movements may be used for the purpose of delivering and/or deploying event entertainment system 10 for the benefit of a party and/or organization, such as, but not limited to, venue 101, and/or for the benefit of individuals, such as, but not limited to, attendees of venue 101. The following head, face, and eye movements are illustrated in FIG. 9: User 90 is turning his/her face leftwards. User 91 is turning his/her face rightwards. User 92 is moving his/her face upwards. User 93 is moving his/her face downwards. User 94 is tilting his/her head and/or face leftwards. User 95 is tilting his/her head and/or face rightwards. User 96 is moving his/her head and/or face forwards. User 97 is moving his/her head and/or face backwards. User 98 is turning his/her eyes leftwards. User 99 is turning his/her eyes rightwards. User 901 is moving his/her eyes upwards. User 902 is moving his/her eyes downwards. User 903 is blinking and/or closing his/her eyes. User 904 is winking one of his/her eyes. Note that regardless of the type of user illustrated in any of the figures in this present disclosure, a user may represent a typical user who may be planned to interact with or who may be interacting with event entertainment system 10. The movements, beyond what is illustrated in FIG. 9, include, but are not limited to, a user raising his/her inner brow, raising his/her outer brow, lowering his/her brow, raising his/her upper eyelid, raising his/her cheek, tightening his/her eyelid, drooping his/her eyelid, squinting his/her eyes, closing his/her eyes, slitting his/her eyes, wrinkling his/her nose, raising his/her upper lid of lips, deepening his/her nasal, pulling the corners of his/her lips, puffing his/her cheeks, making his/her dimples, lowering the corners of his/her lips, raising his/her chin, puckering his/her lips, stretching his/her lips, funneling his/her lips, tightening his/her lips, pressing his/her lips, parting his/her lips, dropping his/her jaw, stretching his/her mouth, and sucking his/her lip(s). The expressions, beyond what is illustrated in FIG. 9, include, but are not limited to, the user expressing happiness and/or joy, sadness, surprise, fear, anger, disgust, and contempt. It is possible that the user may express a combination of movements and expressions to interact with augmented reality content 11.

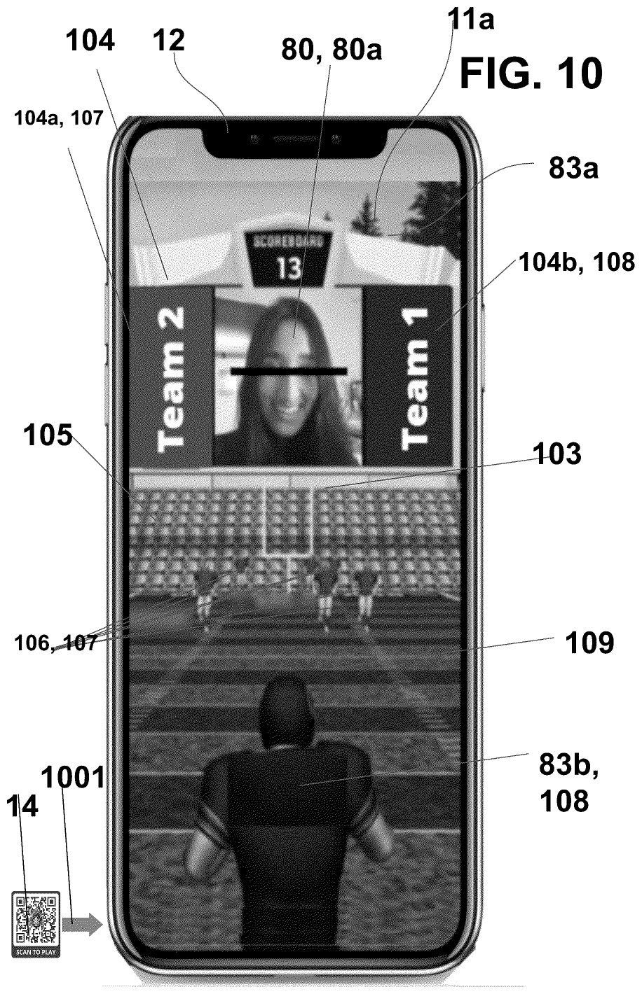

FIG. 10 illustrates a perspective view of an exemplative augmented reality game 11a in which the user's face 80a is morphed into the environment of the augmented reality content 11 component of event entertainment system 10. In FIG. 10, the background, animations, and/or environment of the augmented reality world 83a and/or augmented reality game 11a may closely resemble the background and/or environment of venue 101. Scenery 103 may closely resemble the scenery and/or landscape of venue 101 from the view of character 83b, such as, but not limited to, the focal view of character 83b. This means that, for example, if an American football player participated in a football game in the real world 81a in venue 101, then his/her focal view of the scenery and/or landscape of venue 101 may be similar to the focal view of character 83b of the scenery of venue 101 in the augmented reality world 83a and/or augmented reality game 11a. Jumbotron 104 may closely resemble the jumbotron that venue 101 may have. Side 104b of jumbotron 104 shows the name of the team that may be associated with venue 101 (aka home team 108). Side 104a of jumbotron 104 shows the name of the team that may be the opponent of the team that may be associated with venue 101 (aka opposing team 107). These teams (illustrated in augmented reality world 83a and augmented reality content 11) may be teams that are (and/or will have and/or have) playing against each other in venue 101's live event. User 80's face 80a may be shown on jumbotron 104. User 80's face 80a being shown on jumbotron 104 illustrates how user 80 and/or his/her face may be morphed into the environment of augmented reality content 11. In augmented reality game 11a, user's face 80a appears to be a part of the background, animations, and/or environment of augmented reality game 11a. User's face 80a may be an integral part of the background, animations, and/or environment of augmented reality game 11a because user's face 80a may serve as a remote control, which allows for user 80 to interact and/or play with augmented reality game 11a. Seats 105 may closely resemble the seats that venue 101 may have. FIG. 10 assumes that venue 101 is an outdoor stadium; but, venue 101 may be indoors and/or outdoors and may differ in venue and/or building type. Opponents 106 may be the players that identify with the team that may be the opponent of the team that may be associated with venue 101 (aka opposing team 107). The uniform and/or jerseys of opponents 106 may resemble the uniform and/or jerseys of opposing team 107 during or not during venue 101's live event. Character 83b may represent user 80 in the augmented reality world 83a and/or a player that identifies with home team 108. Character 83b may also represent a renowned player that identifies with a team (such as, but not limited to, home team 108) that may be associated with venue 101. For instance, character 83b may represent Aaron Rodgers, who is a football quarterback player for the American football team, Green Bay Packers; and, this sports team is the home team of the venue, Lambeau Field. Aaron Rodgers is a fan-favorite football player of Green Bay Packers fans; and, if Aaron Rodgers was identified as character 83b in augmented reality content 11, then users may more likely be engaged with event entertainment system 10 and/or interact with augmented reality content 11 because they may be able to be (in a simulated fashion) Aaron Rodgers as an avatar/character in augmented reality content 11 and/or be able to play with and/or against Aaron Rodger's avatar/character in augmented reality content 11 with their/an electronic device(s) 12. The aforementioned individuals and/or teams that character 83b may represent may be identified with the uniform and/or jersey of character 83b which may resemble the uniform and/or jersey of home team 108. The main character and/or the character that may serve as the remote control of augmented reality content 11 may be a noteworthy player in a team that may be affiliated with venue 101. The noteworthy player (i.e. Aaron Rodgers) in a team that may be affiliated with venue 101 may also be a supporting character in augmented reality content 11. Characters that represent opponents 106 may also represent noteworthy players that identify with opposing team 107. For instance, regardless of whether or not venue 101 is hosting a live event against the Tampa Bay Buccaneers (an example of what opposing team 107 could be), opponents 106 may represent that Tampa Bay Buccaneers football players and/or may represent a noteworthy Tampa Bay Buccaneers football player, such as Tom Brady, a football player who is a quarterback for the Tampa Bay Buccaneers. In image 83 of FIG. 8, the background, animations, and/or environment of the augmented reality world 83a and/or augmented reality game 11a may mimic the background and/or environment of venue 101. The extent to which augmented reality content 11 resembles aspects of venue 101 may go beyond and/or go less than scenery 103, jumbotron 104, seats 105, opponents 106, opposing team 107, home team 108, and/or field 109. Augmented reality content 11 may have a resemblance to venue 101. Some augmented reality content 11 may not need to have a resemblance to venue 101 to be a part of the event entertainment system 10 that may be and/or to be implemented in venue 101. Some augmented reality content 11 may have resemblances to venue 101 in order to make event entertainment system 10 and augmented reality content 11 more customized and/or personalized for a specific venue 101; but, augmented reality content 11 may differ in many ways, such as, but not limited to, in appearances, features, animations, backgrounds, environments, etc. QR code 14 and arrow 1001 are shown to imply that a user may use an electronic device 12 to scan QR code 14, and scanning QR code 14 may allow the user(s) to retrieve access to augmented reality game 11a. A user may retrieve access to augmented reality game 11a via methods other than scanning QR code 14, such as, but not limited to, being provided with a URL.

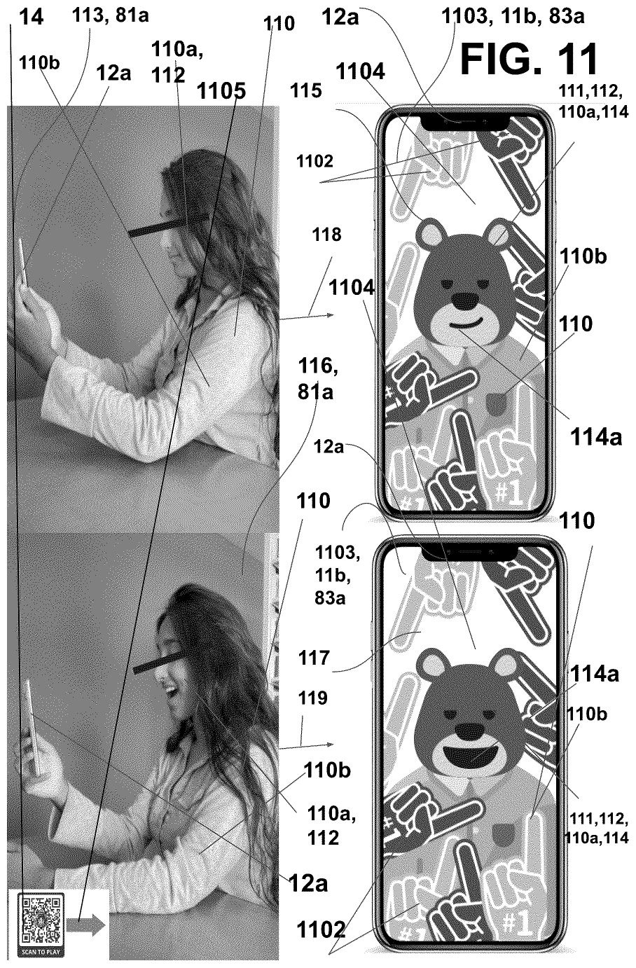

FIG. 11 illustrates a perspective view of exemplative augmented reality content 11 in which user 110's face 110a is morphed into the character 111 and/or remote control 112 of the augmented reality content 11 component of event entertainment system 10. FIG. 11 shows augmented reality animations and/or instructions 1103 as an example of what augmented reality content 11 could be in event entertainment system 10; however, the idea in which user 110 and/or user's face 110a may be morphed into the character 111 and/or remote control 112 of the augmented reality content 11 may apply to any type of augmented reality content 11, such as, but not limited to, augmented reality game 11a, augmented reality animations and/or instructions 11b, and augmented reality animations and/or instructions 1103. User 110, user's face 110a, and/or any other part of user 110's body may be morphed into the character 111 and/or remote control 112 of the augmented reality content 11. In image 113 and image 116, user 110 may hold smartphone 12a at a position and/or orientation to allow the camera of smartphone 12a to capture user 110's face in order for user 110 to interact with augmented reality instructions and/or animations 1103. It is not required for an electronic device 12 to capture a user's face in order for the user to interact with augmented reality content 11; but, for the augmented reality animations and/or instructions 11b illustrated in FIG. 11, smartphone 12a may need to capture user 110's face 110a in order for user 110 to interact and/or play with augmented reality animations and/or instructions 1103. User 110's face 110a may be needed for user 110 to interact and/or play with augmented reality animations and/or instructions 1103 because user 110's face 110a may serve as the remote control of augmented reality instructions and/or animations 1103. User's face 110a may serve as a remote control to interact with augmented reality instructions and/or animations 1103 because when user 110 uses the facial movements (such as, but not limited to, the movements described in FIG. 9) to close user's face 110a's mouth (as seen in image 113), then bear 114 in image 115 may keep its mouth 114a closed for as long as user's face 110a's mouth may be closed. When user 110 uses the facial movements (such as, but not limited to, the movements described in FIG. 9) to open user's face 110a's mouth (as seen in image 116), then bear 114 in image 117 may keep its mouth 114a open for as long as user's face 110a's mouth may be open. Image 115 and image 117 show character 111 which may be bear 114. Character 111 and/or bear 114 represent user 110's avatar in augmented reality instructions and/or animations 1103. It may be apparent that character 111 and bear 114 represent user 110's avatar because character 111 (aka bear 114) moves in a similar and/or the same way and/or direction as user 110 and/or user's face 110a moves. For example, if user's face 110a moves upwards, then character 111 (aka bear 114) may move upwards as well; if user's face 110a moves rightwards, then character 111 (aka bear 114) may move rightwards as well; if user's face 110a's mouth is open, then character 111 (aka bear 114) may open its mouth as well; etc. The idea that character 111 (aka bear 114) may mimic the head, face, and/or eye movements of user 110 may relate to the following, which includes, but is not limited to, the descriptions and illustrations of head/face/eye movements in FIG. 9, and the descriptions and illustrations of a user serving as a remote control for augmented reality content 11 in FIG. 8. It may also be apparent that character 1101 (aka bear 114) represents user 110's avatar because bear 114 may be wearing the same piece of clothing and/or hairstyle as user 110. For instance, in image 113 and image 116, user 110 is wearing a blue polo shirt 110b; and, in image 115 and image 117, bear 114 may be wearing a blue polo shirt 110b as well. With augmented reality content 11, it is possible that the characters in augmented reality content 11 may mimic a user, such as how bear 114 may be simulated to wear the same shirt (such as, but not limited to, blue polo shirt 110b) as user 110. For instance, if another user interacted with augmented reality animations and/or instructions shown in FIG. 11 and if the user may be wearing a red dress, then character 1101 (aka bear 114) may also be wearing a simulated and/or digital version of the aforementioned user's red dress. It may also be apparent that character 111 (aka bear 114) represents user 110's avatar because bear 114's might have a simulated and/or digital version of user 110's eyes. The eyes of bear 114 may be similar to the eyes of user 110; and, other types of augmented reality content 11 may have characters that mimic a user's eyes and/or other parts of a user's body. Characters involved with augmented reality content 11 may represent the following which includes, but is not limited to, a logo, piece of art, animation, symbol, animal, item, thing, and/or mascot that may be directly and/or indirectly affiliated with a venue 101 and/or with the type of event a venue 101 may be hosting, and a company logo. For example, in the augmented reality instructions and/or animations 11b shown in FIG. 11, character 111 (aka bear 114) may represent a mascot affiliated with a team that may be associated with venue 101. While most mascots are typically animated in two-dimensional form, augmented reality content 11 may have the ability to include characters and/or animations in two-dimensional and/or three-dimensional format. For instance, bear 114 represents a mascot of a team which may be a bear; and, the bear may be animated in three-dimensional form in augmented reality content 11. For example, when user's face 110a makes various facial movements, including, but not limited to, moving user's face 110a leftwards and/or rightwards, user 110 may also be able to see the attributes and/or characteristics of bear 114 which may make bear 114 appear three-dimensional, such as, but not limited to, the hairs on bear 114's face and the curvature of bear's 114's face. Other animations may be used in augmented reality content 11 to mimic the theme indirectly and/or directly associated with venue 101. For example, in FIG. 11, foam fingers 1102 may be illustrated in colors (that may or may not be affiliated with a team that may or may not be affiliated with venue 101 and/or the event that venue 101 may be hosting) in order for augmented reality content 11 to, if desired by a person and/or venue operator, mimic the theme indirectly and/or directly associated with venue 101. Foam fingers 1102 in FIG. 11 may be illustrated in colors, such as, but not limited to, green and yellow to make apparent the theme (and/or mimicry of the theme) of a live event that venue 101 may be hosting. Arrow 118 shows the linkage between image 113 and image 115; and arrow 119 shows the linkage between image 116 and image 117. Image 113 and image 116 show user 110 in the real world 81a. Image 113 and image 115 show user 110's face 110a in the augmented reality world 83a. In image 113 and image 116, FIG. 11 shows that user 110 is located in a location other than venue 101; but, it is implied that user 110 may be located in venue 101. A user may be located in venue 101 or a location other than venue 101; a user may be located in venue 101 because it may make event entertainment system 10 more advantageous for a person, venue operator, and/or venue 101 to implement. Ideally, user 110 may be sitting on a seat that may be classified as part of furniture 15; and, user 110 may be holding electronic device 12 before, during, and/or after interacting with augmented reality content 11. An environment of augmented reality content 11 may mimic the background of real world 81a that a user may be located in while the user may be interacting with augmented reality content 11. For example, environment 1104 of the augmented reality instructions and/or animations 1103 may mimic the location that a user may be in while interacting with augmented reality instructions and/or animations 11a. FIG. 11 shows that user 110 is in a location other than venue 101 while interacting with augmented reality instructions and/or animations 1103. The electronic device 12 illustrated in FIG. 11 may be smartphone 12a; but, the electronic device that may be used to scan QR code 14 and/or interact with augmented reality content 11 may be any other device that may be classified as electronic device 12. FIG. 11 assumes that user 110 may have already scanned QR code 14 to access augmented reality instructions and/or animations 1103; however, a user may not have scanned QR code 14 to access augmented reality content 11 because there may be other ways for a user to get access to augmented reality content 11 without scanning QR code 14, which may include, but is not limited to, receiving the URL that may be associated with augmented reality content 11. There may be no required and/or standardized position, method, and/or orientation of how a user holds electronic device 12 to interact with augmented reality content 11, to scan QR code 14, and/or to do an action for a user to interact with event entertainment system 10. For instance, in image 113, user 110 may be holding smartphone 12a with two hands to interact with augmented reality instructions and/or animations 1103; and, in image 116, user 110 may be holding smart phone 12a with one hand to interact with augmented reality instructions and/or animations 1103. There may be no requirement and/or standard for a user to look at electronic device 12 in order to interact with augmented reality content 11. For instance, user 110 may be simulated as bear 114 in augmented reality instructions and/or animations 1103 and may be able to use various head, face, eye, and/or arm movements to control the movements of bear 114, such as, but not limited to, the movements of the head, face, eyes, and arms of bear 114 regardless of whether user 110 may or may not be looking at smartphone 12a. There may be variety in the types of augmented reality content 11 that may be included in event entertainment system 10. The augmented reality content 11 of event entertainment system 10 may include one or more forms of augmented reality content 11, such as, but not limited to, augmented reality instructions and/or animations 1103. QR code 14 and arrow 1105 are shown to imply that a user may use an electronic device 12 to scan QR code 14, and scanning QR code 14 may allow the user(s) to retrieve access to augmented reality content 11, such as, but not limited to, augmented reality instructions and/or animations 1103. A user may retrieve access to augmented reality illustrations and/or animations 1103 via methods other than scanning QR code 14, such as, but not limited to, being provided with a URL.

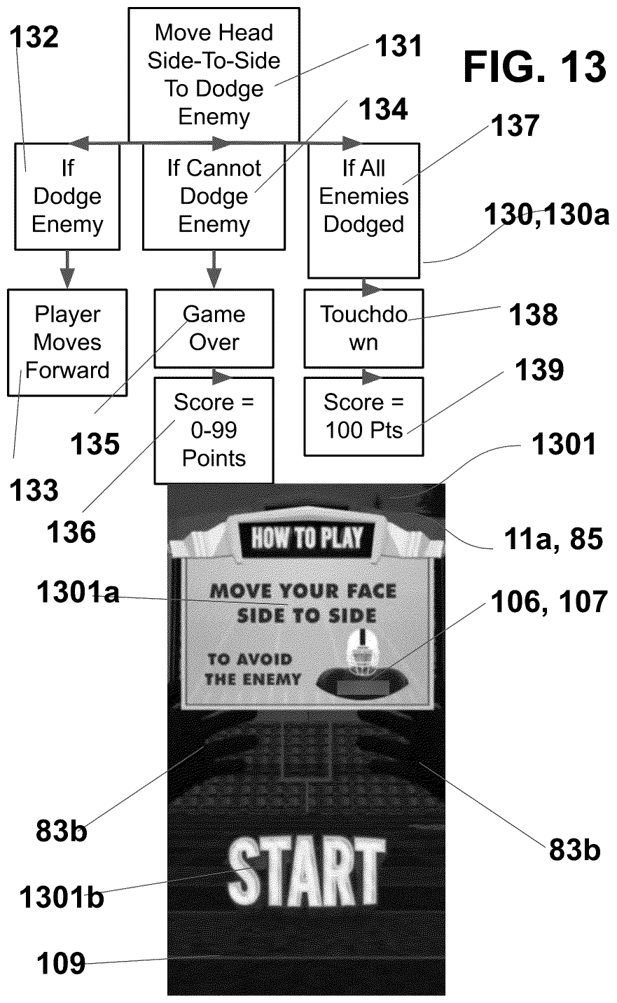

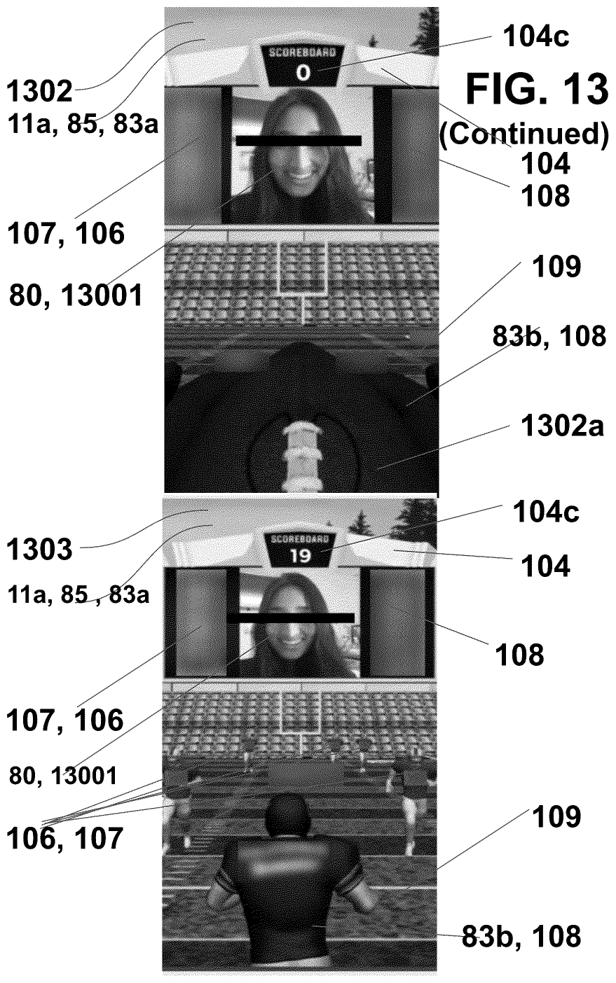

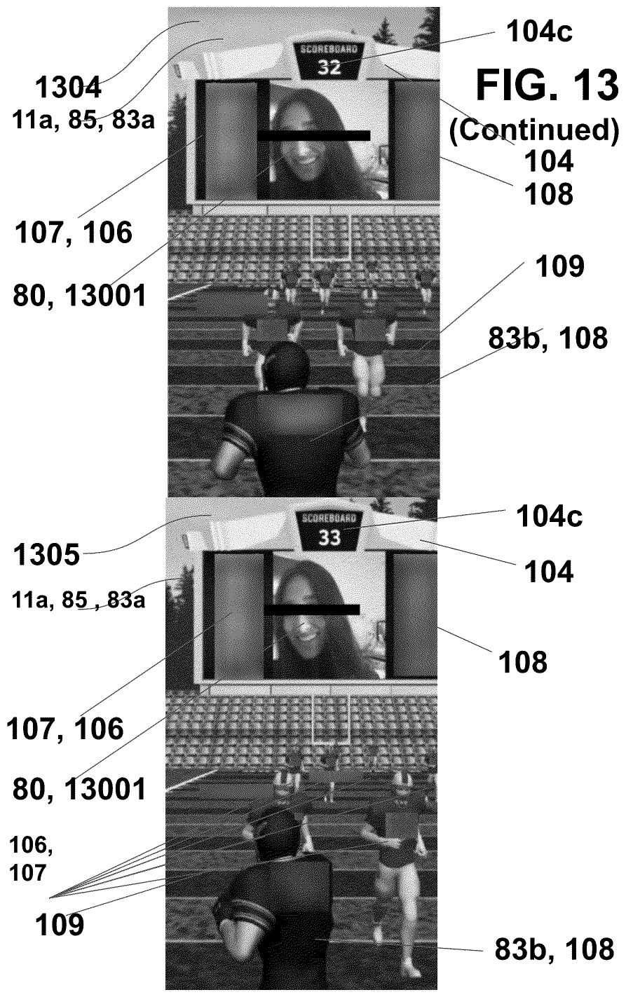

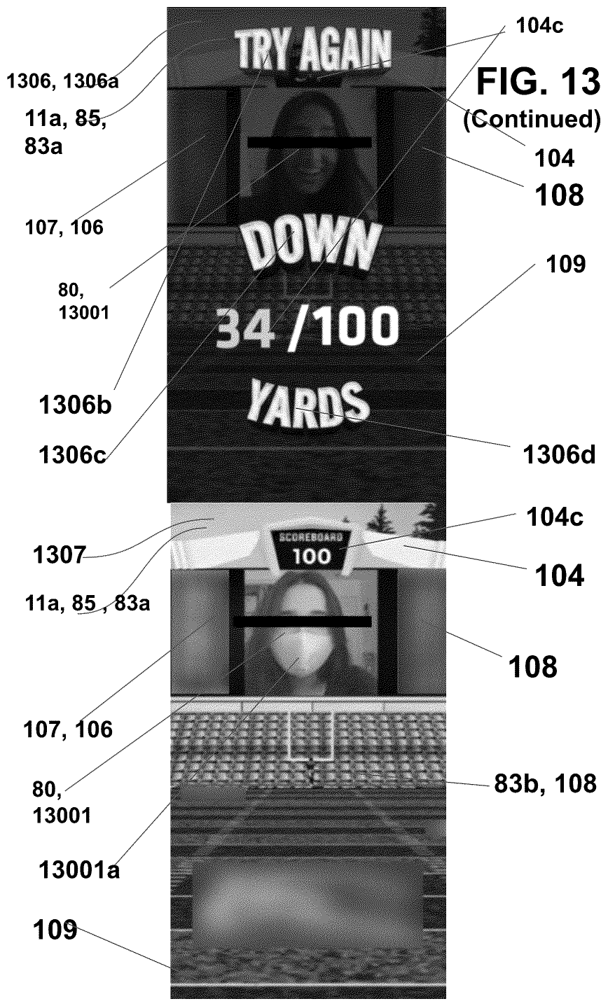

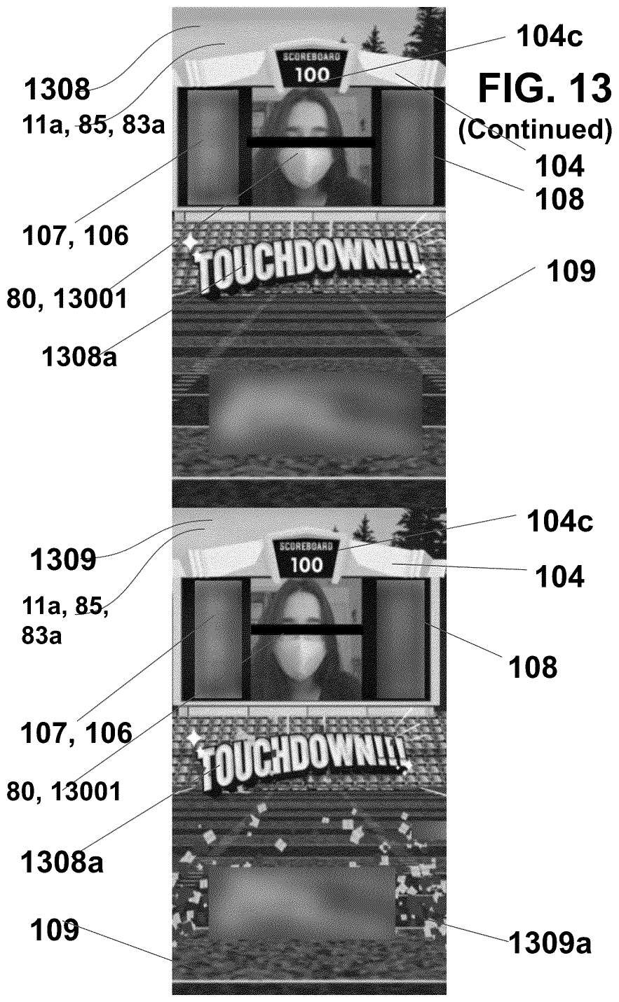

FIG. 12 illustrates an exemplative single-player American football augmented reality game 11a which serves as the foundation for the augmented reality content component 11 of event entertainment system 10. FIG. 12 illustrates an example of augmented reality game 11a through the illustration of augmented reality game 85. The same illustration (with additional illustrations in FIG. 12 to better understand augmented reality game 85) for FIG. 12 is also provided for FIG. 8 and FIG. 10 for the purpose of better understanding event entertainment system 10, augmented reality content 11, and other aspects and/or components associated with event entertainment system 10 and with the methods for using event entertainment system 10. What may be described in FIGS. 8 and 10 in regards to augmented reality game 85 may also apply to what may be described in FIG. 12 in regards to augmented reality game 85. There may be variety in the types of augmented reality content 11 that may be included in event entertainment system 10. The augmented reality content 11 of event entertainment system 10 may or may not be limited to one type of augmented reality content 11, such as, but not limited to, augmented reality game 85. The illustrations and descriptions in FIG. 12 are not meant to limit the scope of augmented reality game 85. Augmented reality game 85 may be an example of what an American football game of event entertainment system 10 and/or a variation of an American football game (such as, but not limited to, gaming methods, game appearance and applications) might be. Augmented reality game 85 may closely resemble a detail concerning an American football game, an American football game associated with event entertainment system 10, and/or a variation of an American football game (such as, but not limited to, gaming methods, the appearance of the game, and applications of the game). FIG. 12 shows that augmented reality content 11 may include and/or demonstrate American football. The purpose of playing and/or interacting with augmented reality game 85 of FIG. 12 may be for character 83b (controlled by user 80) to dodge characters 106 of opposing team 107 in order to score a touchdown. Augmented reality game 85 may show that character 83b scored a touchdown if character 83b successfully dodges and/or runs past characters 106 and/or if character 83b scores 100 points, which may be shown as “100” instead of “13” on jumbotron 104. Because the color scheme of character 83b's uniform 121, jersey 122, and helmet 127 may match the color scheme of “Team 1” (aka home team 108) on side 104b of jumbotron 104, it may be implied that character 83b may be affiliated with “Team 1”. The position of character 83b's arms (in a somewhat folded position) implies that character 83b may be holding a football which he/she may hold throughout his/her run to at/or near the end of field 109 to score a touchdown. FIG. 13 explains the aforementioned components and other components of augmented reality game 85 and methods for playing and/or interacting with augmented reality game 85 in more detail. A player, person, and/or individual may be portrayed in augmented reality content 11, such as, but not limited to, in augmented reality game 85. An animation, icon, simulation, augmented art, etc. that may be illustrated and/or portrayed in augmented reality game 85 may be an example of what may be illustrated and/or portrayed in augmented reality content 11. A concept, idea, person, place, and/or thing, etc., that may be digitized, simulated, and/or augmented may be included in and/or involved with augmented reality content 11 and/or other components of event entertainment system 10. Augmented reality content 11 (such as, but not limited to augmented reality game 85) may include a design (such as, but not limited to, an illustration, graphic, animation, image, and/or art) that relates to an entity (such as, but not limited to, an individual, corporation, venue, and/or sports team), herein, collectively referred to entity design throughout the rest of this present disclosure.

An example of entity design that may be illustrated and/or simulated in augmented reality content 11, such as, but not limited to augmented reality game 85, may be an entity design that may be associated (directly and/or indirectly) with venue 101, company, team, organization, individual, mascot, logo, audio, icon, art, theme, community, uniform, jersey, etc. For instance, an example of an entity design that may be illustrated and/or simulated in augmented reality content 11 may be a digital image of scenery 103 that may relate to venue 101. Another example of an entity design that may be illustrated and/or simulated in augmented reality content 11 may be a digital image of jumbotron 104 that may relate to venue 101. Another example of an entity design that may be illustrated and/or simulated in augmented reality content 11 may be seats 105 that may feature the logo of a sports team affiliated with venue 101; and, logo may relate to an organization affiliated with the sports team. Another example of an entity design that may be illustrated and/or simulated in augmented reality content 11 may include, but is not limited to, opponents 106, character 83b, user 80, uniform 121, jersey 122, home team 108, opposing team 107 and/or a human-like animation that may involve the name, image, and/or likeness relating to an individual and/or organization. Another example of an entity design that may be illustrated and/or simulated in augmented reality content 11 may be a digital image of venue 101 and/or field 109 that may relate to venue 101. An entity design may be illustrated and/or simulated in augmented reality world 83a. Also, an entity design available in real world 81a may be illustrated and/or simulated in augmented reality world 83a. The following includes more detailed examples of applications (in other words, implementation) of augmented reality content 11 (such as, but not limited to augmented reality game 85) that may include a design that relates to an entity as an illustration, graphic, animation, image, art, etc. FIG. 12 may imply any or all of the following examples. One example of an application of augmented reality content 11 that may include entity design may be how side 104b of jumbotron 104 in augmented reality game 85 may show that name of a team that may be associated with venue 101, such as, but not limited to, home team 108. In FIG. 12, side 104b may be identified with the words, “Team 1”; but, this may be replaced with the name of home team 108. If the words, “Team 1” are replaced with the name of home team 108, it is likely that the replacement may involve a logo of home team 108 and/or a party and/or organization that may be affiliated with and/or controls home team 108. An example of the aforementioned replacement may be if “Team 1” was replaced with “Green Bay Packers”, an example of a type of home team 108 that may be affiliated with venue 101 as the home team of venue 101 if venue 101 was Lambeau Field in Green Bay, Wisconsin, United States. Another example of an application of augmented reality content 11 that may include entity design may be how side 104a of jumbotron 104 in augmented reality game 85 may show the opponent of the team that may be associated with venue 101 (aka opposing team 107). In FIG. 12, side 104a may be identified with the words, “Team 2”; but, this may be replaced with the name of opposing team 107. If the words, “Team 2” are replaced with the name of opposing team 107, the replacement may involve a logo of opposing team 107 and/or a party and/or organization that may be affiliated with and/or controls opposing team 107. An example of the aforementioned replacement may be if “Team 2” was replaced with “Tampa Bay Buccaneers”, an example of an opposing team 107 that may be the opponent of the aforementioned example of home team 108, “Green Bay Packers,” if “Tampa Bay Buccaneers” played a sports match against “Green Bay Packers” at an example of venue 101, Lambeau Field in Green Bay, Wisconsin, United States. Another example of an application of augmented reality content 11 that may include entity design may be if a logo, that may be included in augmented reality game 85, may be illustrated in a font. For instance, a phrase illustrated with a cursive and/or other font on jersey 122 may closely resemble the font associated with home team 108; and, the font (and/or the illustration of the phrase with a particular font) of home team 108 and/or a party and/or organization that may be affiliated with and/or controls home team 108. Another example of an application of augmented reality content 11 that may include entity design may be if a slogan and/or chant is illustrated on (such as, but not limited to the center) of electronic device 12 when a user interacts with augmented reality game 85. The slogan and/or chant may relate to a sports team and/or party and/or organization that may be affiliated with and/or controls the sports team. In the center of electronic device 12 showing augmented reality game 85, an example slogan/chant 123 “We So Dope” is shown. “We So Dope” may represent a slogan that may be associated with an organization and/or individual, such as, but not limited to, a sports team, such as, but not limited to, home team 108. Slogan 123 may be the slogan that users in venue 101 may chant in the real world 81a when a favorable activity occurs that may be associated with home team 108, such as, but not limited to, a player in home team scoring a touchdown in football, a form of rallying, and/or supporting sports teams and/or player(s) during the live event. Another example of an application of augmented reality content 11 that may include entity design may be if a logo is illustrated in pieces of clothes and/or accessories, such as, but not limited to, uniform 121, jersey 122, and helmet 127. The logo, uniform, jersey, and/or helmet, may relate to a sports team and/or party and/or organization that may be affiliated with and/or controls the sports team. For instance, in augmented reality game 85 in FIG. 12, the words and/or logo, “Dope Nation” is shown on jersey 122 of a player who may be affiliated with Team 1. “Team 1” and/or an affiliated party or organization of “Team 1” may relate to the words and/or logo, “Dope Nation”. Another example of an application of augmented reality content 11 that may include entity design may be if a name, number, and/or animation that may be associated with a specific individual relates to the individual and/or a party and/or organization that may control the sports team that the individual may be affiliated with. For example, jersey 122 shows the name, “Jilani” 124. “Jilani” 124 may be the name of an individual 125 (which may be character 83b) who may be affiliated with “Team 1”. Another example is that jersey 122 and helmet 123 shows the number, “1” 126. “1” 126 may be the number affiliated with individual 125 (which may be character 83b) who may be affiliated with “Team 1’. Another example of an application of augmented reality content 11 that may include entity design may be if seats 105 shown in augmented reality game 85 have a logo attached to it. The logo on seats 105 may relate to venue 101, a sports team, and/or a party and/or organization that may be affiliated with and/or controls the sports team. The logo on seats 105 may not be illustrated, but may be implied, in FIG. 12. Another example of an application of augmented reality content 11 that may include entity design may be if jumbotron 104 shown in augmented reality game 85 has a logo attached to it. The logo on jumbotron 104 may relate to venue 101, a sports team, and/or a party and/or organization that may be affiliated with and/or controls the sports team. The logo on jumbotron 104 may not be illustrated, but may be implied, in FIG. 12. Another example of an application of augmented reality content 11 that may include entity design may be if field 109 shown in augmented reality game 85 has a logo attached to it. The logo(s) on field 109 may relate to venue 101, a sports team, and/or party and/or organization that may be affiliated with and/or controls the sports team, and/or a sponsoring company and/or advertiser of venue 101 and/or of venue 101's event. Oftentimes, companies, such as, but not limited to, sponsoring companies and/or advertisers, may pay venue 101 to have a logo and/or advertisement shown on areas within venue 101, such as, but not limited to, on field 109 and on other areas in venue 101 while they may or may not secure the naming rights to venue 101. QR code 14 and arrow 128 are shown to imply that a user may use an electronic device 12 to scan QR code 14, and scanning QR code 14 may allow the user(s) to retrieve access to augmented reality content 11, such as, but not limited to, augmented reality game 85. A user may retrieve access to augmented reality game 85 via methods other than scanning QR code 14, such as, but not limited to, being provided with a URL.

FIG. 13 illustrates a method 130 for playing an exemplative single-player American football augmented reality game 85 of the augmented reality content 11 component of event entertainment system 10. Augmented reality game 85 may be a single-player game because one user (such as, but not limited to, user 80 and user 13001) may be needed to complete augmented reality game 85. However, augmented reality content 11 may be able to be interacted with by one person (i.e. single-player) and/or more than one person (i.e. multiplayer). Flowchart 130a describes the steps associated with method 130. Step 131 says that a user (i.e. user 80 and user 13001) who uses electronic device 12 to interact with augmented reality game 85 may move his/her head side-to-side to dodge the enemy 106. The instructions for a user to move his/her head side-to-side may relate to the movements a user may make as described in FIG. 9. For example, a user may follow the instructions in step 131 by moving his/her face leftwards (as seen with user 90) and/or rightwards (as seen with user 91). By moving his/her face leftwards and/or rightwards, the user's character 83b may dodge the enemy(-ies), which means that character 83b may be able to move farther down field 109 without physically clashing with and/or into any of the enemies 106 in augmented reality game 85. The enemies 106 may be classified as opposing team 107 in augmented reality game 85. A user may also follow the instructions in step 131 by tilting his/her head leftwards (as seen with user 94 in FIG. 9) and by tilting his/her head rightwards (as seen with user 95 in FIG. 9). By tilting his/her face leftwards and/or rightwards, the user's character 83b may also dodge the enemy(-ies) 107. Augmented reality game 85 may use facial recognition to be able to detect the movement(s) of a user's face moving and/or not moving side-to-side by detecting the movement(s) of various parts of a user's body, such as, but not limited to, a user's nose. Some augmented reality content 11, such as, but not limited to, augmented reality game 85, may be able to detect a user's face and/or parts of a user's face regardless of if the user is or is not wearing a face mask. For example, user 13001 is wearing a face mask 13001a and is still able to play with and/or interact with augmented reality content 11. At times when the facial recognition component of an augmented reality content 11, such as, but not limited to, augmented reality game 85, may not be able to detect a user's face and/or another part of the user's body, a notice, such as, but not limited to, the words, “Find Your Face”, may be shown on the screen of electronic device 12; and, the notice may shown on the screen for as long as the facial recognition component does not detect the user's face and/or another part of the user's body. Image 1301 is the first page of illustrations a user may encounter when he/she first sees augmented reality game 85. Image 1301 may serve as an illustration of step 131 because it gives the user instructions 1301a (listed on step 131) on how to play with and/or interact with augmented reality game 85. Image 1301 may also provide an image of an enemy 106 (aka opposing team 107) so the user may be aware of who the enemy 106 might be for the augmented reality game 85. Enemy 106 may represent opposing team 107; but, augmented reality game 85 assumes that the enemy(-ies) 106 is(are) associated with opposing team 107. The word “Start” 1301b may appear when the user may be ready to interact with the augmented reality content 11 and/or fulfill the call-to-action to start playing augmented reality game 85. It is important to know that although the descriptions of the figures in this present disclosure may be tailored to a specific type of augmented reality content 11, such as, but not limited to, augmented reality game 85, some and/or all of the aspects used to describe a particular example, element, category, and/or type of augmented reality content 11 may also describe and/or represent other examples, elements, categories, and/or types of augmented reality content 11. Image 1302 shows the introduction of augmented reality game 85, in which character 83b catches a football 1302a in order to carry it and to run through field 109 while dodging enemies 106 (opposing team 107) in order to score a touchdown 1308a. The enemy(-ies) 106 (opposing team 107) shown in augmented reality world 83a and/or augmented reality game 85 may represent the opposing team 107 in real world 81a. This means that while venue 101 may be hosting a live event in which the team associated with venue 101 may be playing against its opponent, the aforementioned team may represent home team 108 in augmented reality game 85; and, the aforementioned opponent may represent opposing team 107 in augmented reality game 85; and, this linkage between home team 108 and opposing team 107 (in real world 81a and augmented reality world 83a) and other aspects/details of augmented reality game 85 may also be implied with, described, attributed to, etc., other examples, elements, categories, and/or types of augmented reality content 11. Step 132 says that if the user dodges an enemy 106 (opposing team 107), then step 133 may follow in which the player 83b moves farther down field 109. In other words, if the user runs through and/or past enemy 106 and does not clash with enemy 106, then character 83b may be able to run farther down field 109. Image 1303 shows character 83b running farther down field 109 and is about to dodge enemies 106 (that may be a part of opposing team 107). We know that character 83b successfully dodged enemies 106, and that character 83b moved farther down past field 109, because scoreboard 104c of jumbotron 104 shows an increase in the number of points user 80 scored in augmented reality game 85 (from 19 points in image 1303 to 32 points in image 1304). Images, such as, but not limited to, image 1303 and image 1304 show in real time that user 80 dodged enemies 107 (as described in step 132), which has allowed character 83b move farther down field 109 and progress further in augmented reality game 85 (as described in step 133). Step 134 says that if a user cannot dodge enemy 107 (in other words, character 83b clashes with enemy 107), then step 135 may follow in which the user has lost augmented reality game 85 (aka “game over”). Image 1305 shows that character 83b may be about to clash with enemy 106. We know that character 83b unsuccessfully dodged enemy 106, and that character 83b failed to move farther down past field 109, because the number of points shown in scoreboard 104c in image 1305 is very close to the number of points in the game over page 1306a of image 1306. In image 1305, scoreboard 104c shows that user 80 scored 33 points; and, in image 1306, game over page 1306a shows that user 80 scored 34 points, and that user 80's final score is 34 points. Images, such as, but not limited to, image 1305 and image 1306, show in real time that user 80 failed to dodge enemies 107 (as described in step 134), which led to user 80 to lose augmented reality game 85 (as described in step 135) and receive a score in between 0 and 99 points (as described in step 136). Game over page 1306a shows that user 80 scored a total of 34 yards out of 100 yards. Yards 1306d may be the metric used in American football to see how far a football player ran with an American football (i.e. American football 1302a) in an American football field. Game over page 1306a may also say the word, “down” 1306c, because “down” is a term used in American football as well. Game over page 1306a may allow a user to play augmented reality game 85 again (in other words: retry his/her interaction and/or play with augmented reality content 11), as shown by the words, “try again” 1306b. Depending on what a person and/or venue operator allows in regards to event entertainment system 10 and/or broadcasting augmented reality content 11, the user may or may not have the opportunity to replay the augmented reality game 85 one or more times. When the user loses augmented reality game 85, it is implied that the total number of points a user may get in augmented reality 85 may be between 0 and 99 points (as mentioned in step 136). For instance, game over page 1306a shows that user 80 scored a total of 34 points. This implies that when and/or after user 80 received a score of 34 points in augmented reality game 85, character 83b hit (aka clashed into) an enemy 107. Step 137 says that if character 83b does not clash into or hit any of the enemies 107, then step 138 may follow in which the user/character 83b will score a touchdown. In this American-football-based augmented reality game 85, scoring a touchdown implies that the user has won augmented reality game 85. Image 1307 shows that character 83b has reached at or near the end of field 109. According to the way augmented reality game 85 may be played and/or interacted with, when character 83b has reached at or near the end of field 109, it may be implied that character 83b dodged all enemies 107 and scored a touchdown. Image 1308 and 1309 shows the word, “touchdown” 1308a, to imply that user 80 won the game. Also, confetti 1309a may be shown (as shown in image 1309) to imply that the user won the game and/or scored a touchdown. When the user wins augmented reality game 85, it may be implied that the total number of points a user may get in augmented reality game 85 may be 100 points (as mentioned in step 1309). For instance, image 1307, image 1308, and image 1309 show that user 13001 scored 100 points on scoreboard 104c. Images, such as, but not limited to, image 1307, image 1308, and image 1309 show in real time that user 13001 dodged enemies 106 (as described in step 137), which led to user 13001 to score a touchdown (as described in step 138) and receive a score of 100 points (as described in step 139). FIG. 13 assumes that a user (i.e. user 80 and user 13001) and character 83b may be used interchangeably because, as described in FIG. 8, a user's face and/or another part of the user's body may serve as the remote control of augmented reality game 85.

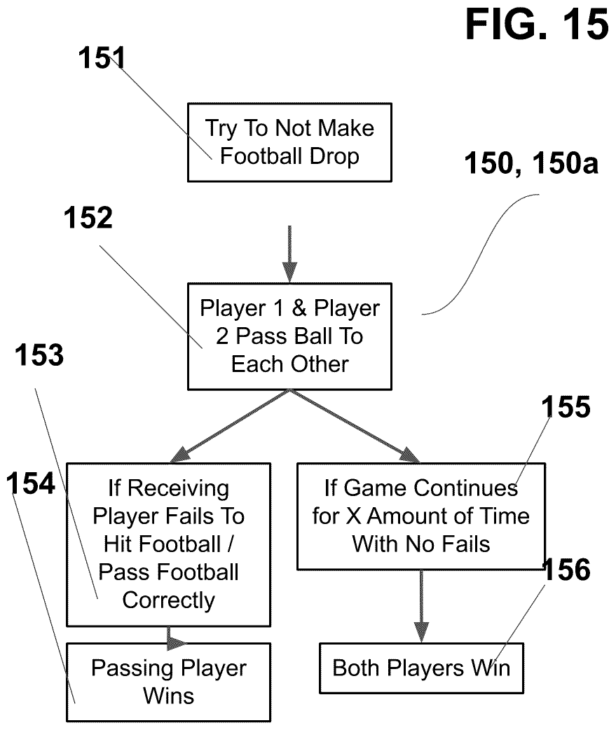

FIG. 14 illustrates an exemplative multiplayer American football augmented reality game 11a which also serves as the foundation for the augmented reality content component 11 of event entertainment system 10. FIG. 14 illustrates an example of augmented reality game 11a through the illustration of augmented reality game 140. The illustrations and descriptions of FIG. 14 are not meant to limit the scope of augmented reality game 140. Augmented reality game 140 may be an example of what an American football game of event entertainment system 10 and/or a variation of an American football game (such as, but not limited to, gaming methods, game appearance and applications) might be. Augmented reality game 140 may closely resemble a detail concerning an American football game, an American football game associated with event entertainment system 10, and/or a variation of an American football game (such as, but not limited to, gaming methods, the appearance of a game, and applications of a game). FIG. 14 does not limit the scope of what may be illustrated in FIG. 14. FIG. 14 shows that augmented reality content 11 may include and/or demonstrate American football. Two users may control the players in augmented reality game 140. For the purpose of better understanding FIG. 14, the two users may be described as user 141 and user 142. User 141 may control “Player 1” 141b, which may also be classified as character 141a for the purpose of better understanding FIG. 14. User 142 may control “Player 2” 142b, which may also be classified as character 142a for the purpose of better understanding FIG. 14. Imaginary line 144 appears to divide the screen of electronic device 12 to imply that user 141 may occupy a portion (such as, but not limited to the left side 12a1) of the screen of electronic device 12 to control the movement(s) of character 141a as a remote control; and, user 142 may occupy a portion (such as, but not limited to the right side 12b1) of the screen of electronic device 12 to control the movement(s) of character 142a. As described in FIG. 8, user 141's and user 142's face and/or another part of user 141's and/or user 142's body may serve as the remote control of augmented reality game 140 because they control the movement(s) of character 141a and character 142a respectively to interact with and/or play with augmented reality game 140. Words, “Player 1” 141b and “Player 2” 142b are imaginary words that are illustrated in FIG. 14 to help better understand that two users may play and/or interact with augmented reality game 140 and that each user may use head/eye/face movements (as described in FIG. 9) to control the movements of characters 141a and 142a respectively during their interaction with augmented reality game 140. The purpose for playing and/or interacting with augmented reality game 140 of FIG. 14 may be for user 141 and 142 to pass football 143 to each other without dropping football 143; and, the player/user (such as, but not limited to, either user 141 or user 142) who may receive his/her turn to pass football 143 but fails to pass football 143 to the other player/user (in other words, drops football 143) may be considered as the loser in augmented reality game 140; and, the winner may be the other player/user who did not receive the football 143 that may have fallen. The instructions 1404 may be summarized as, “Don't Drop Football”, in image 145 and image 146. Imaginary dots 1405 in image 145 and image 146 show the direction of where football 143 may be going when it is passed between user 141 and user 142. For example, in image 145, the football 143 may primarily be passed by user 141, then football 143 may go in the direction towards user 142, then, after football 143 bounces on character 142a, football 143 may go in the direction towards user 141, then, after football 143 bounces on character 141a, football 143 may go in the direction towards user 142 and may bounce again on user 142. Another example of the direction of where football 143 may be going when it is passed between user 141 and user 142 is in image 146, in which football 143 may have bounced on user 142, and, user 142/character 142a hit football 143 so it may be passed onto user 141, but football 143 may be falling and/or moving in a direction that may not allow football 143 to be passed to the opposite player (in this scenario, user 141). Football 143 may go in any direction and/or set of directions, passes, and/or hits by a user depending on the head/face/eye movements of user 141 and/or user 142 as described in FIG. 9. The head/face/eye movements of user 141 and user 142 may be tracked by the facial recognition capabilities involved with the programming language involved with augmented reality game 140. Augmented reality game 140 may have its facial recognition capabilities determine whether user 141 and/or user 142 are moving their heads leftwards and/or rightwards and/or if they are tilting their heads leftwards and/or rightwards to dictate the movement of character 141a and 142a respectively. Other head/face/eye movements may be used to dictate the movement of character 141a and 142a. Because user 142 made football 143 fall and/or drop, user 142 has lost augmented reality game 140; and, user 141 has won augmented reality game 140. Image 147 shows banner 148 which says that “Player 1” 141b (aka user 141) has won augmented reality game 140. Also, confetti 149 may also be shown (as exemplified in image 147) to imply that user 141 won the game. Similar to augmented reality game 85, the face of user 141 and user 142 may be shown in augmented reality game 140. For example, if the face of user 141 and user 142 was shown in augmented reality game 140, then their faces may be shown on and/or morphed with the faces of character 141a and character 142a respectively. Another example is if the face of user 141 and of user 142 was not shown in augmented reality game 140, then the face of American football players associated with the home team of venue 101 and/or the opposing team of the affiliated home team (during a live event that venue 101 may be hosting) may be shown on and/or morphed with the faces of character 141a and character 142a respectively. For the purpose of better understanding FIG. 14, user 141, character 141a, and “Player 1” 141b may be used interchangeably; and, user 142, character 142a, and “Player 1” 142b may be used interchangeably. “Player 1” 141b and “Player 2” 142b may be an American football player associated with and/or not associated with venue 101. “Player 1” 141b and “Player 2” 142b may represent a combination of American football players, in which “Player 1” 141b may be a player that identifies with the home team of venue 101, with the opposing team of the aforementioned home team, and/or is any, random American football player; and, “Player 2” 142b may be a player that identifies with the home team of venue 101, with the opposing team of the aforementioned home team, and/or is any, random American football player. For example, “Player 1” 141b and “Player 2” 142b may represent a player from the home team associated with venue 101, which may imply that both characters 141a and 141b may be playing against each other in augmented reality game 140 while identifying with the same sports team. Another example is that “Player 1” 141b and “Player 2” 142b may represent a player from the opposing team of the aforementioned home team, which may imply that both characters 141a and 141b may be playing against each other in augmented reality game 140 while identifying with the same sports team. Another example is that “Player 1” 141b may represent a player from the home team while “Player 2” 142b may represent a player from the opposing team and vice versa, which may imply that both characters 141a and 141b may be playing against each other in augmented reality game 140 while identifying with different sports teams. These combinations of players, in which the character(s) of an augmented reality content 11 may identify with the home team of venue 101, with the opposing team of the aforementioned home team, and/or is a random American football player, may apply to other forms, types, and/or categories of augmented reality content 11. It is possible for venue 101 to have different versions of augmented reality content 11, such as, but not limited to, augmented reality game 140, broadcasted at or near the same time of each other at different areas and/or locations of venue 101. For instance, augmented reality game 140—which may involve both characters 141a and 141b associated with the home team of venue 101—may be broadcasted in the seating areas and/or sections of venue 101 of users who connect to, are affiliated with, and/or resonate with the home team. Another example is that the augmented reality game 140—which may involve both character 141a and character 141b associated with the opposing team—may be broadcasted in the seating areas and/or sections of venue 101 of users who connect to, are affiliated with, and/or resonate with the opposing team. Another example is that the augmented reality game 140—which may have one character associated with the home team and another character associated with the opposing team—may be broadcasted in the seating areas and/or sections of venue 101 of users who connect to, are affiliated with, and/or resonate with the home team and/or the opposing team and/or with none of the teams and/or individuals/players. One of the benefits of broadcasting one and/or many versions of the same augmented reality content 11 (such as, but not limited to, versions of augmented reality content 140) and/or of different versions of augmented reality content (such as, but not limited to, augmented reality content 140 and augmented reality content 85) throughout various areas and/or locations of venue 101 may be that various users, regardless of the team and/or individual they may associate, connect, and/or resonate with, may be able to interact with augmented reality content 11 and/or may enjoy the process of the interaction and/or may feel as if they matter as part of a target audience to interact and/or play with augmented reality content 11. When an augmented reality content 11 is broadcasted “in” a certain area and/or location of venue 101, such as, but not limited to, the seating area of venue 101, this may imply that augmented reality content 11 is accessible to users located in the aforementioned area and/or location of venue 101. It is possible that augmented reality content 11 may be broadcasted “in” a certain area and/or location of venue 101, and augmented reality content 11 may be accessible to users located in a different area and/or location of venue 101. When augmented reality content 11 is broadcasted “in” a certain area and/or location of venue 101, such as, but not limited to, the seating area of venue 101, this may imply that QR code 14 was installed “in” the aforementioned area and/or location of venue 101. It is possible that augmented reality content 11 may be broadcasted “in” a certain area and/or location of venue 101, and QR code 14 may have been installed in a different area and/or location of venue 101. FIG. 15 explains the aforementioned components and other components of augmented reality game 140 and methods for playing and/or interacting with augmented reality game 140 in more detail. A player, person, and/or individual may be portrayed in augmented reality content 11, including, but not limited to, augmented reality game 140. An animation, icon, simulation, and/or augmented art, that may be illustrated and/or portrayed in augmented reality game 140 may be an example of what may be illustrated and/or portrayed in augmented reality content 11. A concept, idea, person, place, and/or thing, etc., that may be digitalized and/or augmented may be included in and/or involved with augmented reality content 11 and/or other components of event entertainment system 10. An entity design may be illustrated and/or simulated in augmented reality content 11, such as, but not limited to, in augmented reality game 140. For example, number sign 1401 and number sign 1402 may be replaced with the number of an American football player associated with the home team affiliated with venue 101 and/or of an American football player associated with the opposing team of the aforementioned home team. Replacing number sign 1401 and number sign 1402 with the number affiliated with an American football player may involve the entity design relating to the aforementioned player; and, that entity design may relate to the player, a party and/or organization affiliated with the player, and/or venue 101. Other elements, drawings, animations, etc. of augmented reality game 140, such as, but not limited to, jersey 141d and jersey 142d may also include IP. For example, jersey 141d and jersey 142d may also include the number of a renowned American football player. QR code 14 and arrow 1406 are shown to imply that a user may use an electronic device 12 to scan QR code 14, and scanning QR code 14 may allow the user(s) to retrieve access to augmented reality content 11, such as, but not limited to, augmented reality game 140. A user may retrieve access to augmented reality game 140 via methods other than scanning QR code 14, such as, but not limited to, being provided with a URL.

FIG. 15 illustrates a method 150 for playing an exemplative multiplayer American football augmented reality game 140 of the augmented reality content component 11 of event entertainment system 10. Augmented reality game 140 may be a multiplayer game because more than one user (such as, but not limited to, user 141 and 142), preferably two users, may be needed to complete augmented reality game 140. However, augmented reality content 11 may be able to be interacted with by and/or played with by one person (i.e. single-player) and/or more than one person (i.e. multiplayer). Flowchart 150a describes the steps associated with method 150. Step 151 says that the instructions to play augmented reality game 140 is for users 141 and 142 to try to not make football 143 drop. When playing and/or interacting with augmented reality game 140, one and/or both users 141 and user 142 may hold electronic device 12. User 141 may hold an electronic device while user 142 plays and/or interacts with augmented reality game 140 along with user 141 and vice versa. It is possible that both users 141 and 142 hold their own electronic device 12 and/or two different electronic devices 12 to play and/or interact with augmented reality game 140. FIGS. 14 and 15 assume that while a group of two users (such as, but not limited to, user 141 and user 142) play and/or interact with augmented reality game 140, both users may be relying on the same electronic device 12 to play the game. In other words, while augmented reality game 140 may be accessible via an electronic device 12, user 141 and user 142 may not be using their own separate electronic device 12 to play and/or interact with augmented reality game 140; rather, user 141 and user 142 may be sharing a single electronic device 12 to play and/or interact with augmented reality game 140. A single electronic device 12 may be used to play augmented reality game 140 amongst two users; and, it is possible that other types, categories, and/or examples of augmented reality content 11 may be interacted with by one or more than one electronic device 12. In FIG. 15, user 141 and user 142 may be sharing a single electronic device 12 while trying to not make football 143 fall down. FIG. 15 assumes that user 141 and user 142 may be wearing football helmets 1403 (in augmented reality game 140) because they may be playing with football 143 that may be augmented and/or simulated in augmented reality game 140 as well. Step 152 says that player 141a (aka “Player 1” controlled by user 141) and player 142a (aka “Player 2” controlled by user 142) may pass football 143 to each other. FIG. 15 assumes that while user 141 may use a body part (in most cases, the head and/or helmet) of player 141a to hit football 143, it is possible, depending how augmented reality game 140's facial recognition component tracks the movement of user 141, that football 143 may be passed onto user 142, and vice versa. The opposite case, although implied, may be that FIG. 15 assumes that while user 142 may use a body part (in most cases, the head and/or helmet) of player 142a to hit football 143, it is possible, depending on how augmented reality game 140's facial recognition component tracks the movement of user 142, that football 143 may be passed onto user 142. FIG. 15 also assumes that, while user 141 tries to pass football 143 to user 142 and vice versa, depending on how augmented reality game 140's facial recognition component tracks the movement of user 141 and/or user 142 respectively, football 143 may be passed to the intended user and may fall down. Step 153 says that if the receiving user fails to hit football 143 and/or fails to correctly pass football 143 to the passing player, then step 154 would follow, in which the receiving player would lose augmented reality game 140 and the passing player would win augmented reality game 140. Passing player may mean that at the time football 143 was moving in the direction and/or traveling towards the receiving player, passing player was the user who hit the football towards the receiving player. For the purpose of better understanding step 153 and 154, an example of the aforementioned statement may be that if user 142 is the receiving player and if user 141 is the passing player. Given the aforementioned scenario, step 143 says that, at the time when football 143 was recently hit by user 141 (passing player) and is intended to move in the direction towards user 142 (receiving player), if user 142 (receiving player) fails to hit football 143 with the body of player 141a and/or fails to pass football 143 correctly to user 141 (passing player), then user 142 may lose augmented reality game 140 and user 141 may win augmented reality game 140. Image 146 and image 147 of FIG. 14 show an example of step 153 and step 154 in real time, in which user 142 (receiving player) failed to correctly pass football 143 to user 141, which led to user 142 to lose (and user 141 to win) augmented reality game 140. Step 153 and 154 implies another situation in which neither user 141 or user 142 may have yet passed and/or received football 143; but, when it may be a user's turn to pass football 143 and the user fails to pass the football to the other user, the user (whose turn was to pass football 143) may lose augmented reality game 140 while the other user may win augmented reality game 140. Step 155 says that if augmented reality game 140 continues for a certain amount of time (such as, but not limited to, a certain amount of minutes) without any of the users failing to pass football 143 to each other, then step 156 would follow in which both players (passing player and receiving player/Player 1 and Player 2/user 141 and user 142) may win augmented reality game 140. Due to the structure, composition, and complexity of augmented reality game 140, it is possible that the duration for which one or more users may be allowed to interact with and/or play with augmented reality game 140 at a time may be for however long the user(s) choose(s) and/or a fixed amount of time. The aforementioned time duration may be dependent on the maximum file size allowed by the programming software (such as, but not limited to, JavaScript) to create the augmented reality content 11 (such as, but not limited to, augmented reality game 140). For instance, if the maximum file size allowed to broadcast augmented reality game 140 to the satisfaction of the creator(s) and/or controller(s) of the augmented reality game 140 may be 5 megabytes, then user 141 and/or user 142 may be able to play and/or interact with augmented reality game 140 for about 20 seconds at a time. For the purpose of better understanding step 155 and 156, an example scenario may be that user 141 and/or user 142 may be able to play and/interact with augmented reality game 140 for about 20 seconds at a time; and, if 20 seconds has passed while user 141 and user 142 are playing with and/or interacting with augmented reality game 140 (and successfully passing and/or hitting football 143 to each other) and football 143 is moving the direction towards one of the users but has not been hit back by any of the users yet, then both players (user 141 and user 142) may win augmented reality game 140.

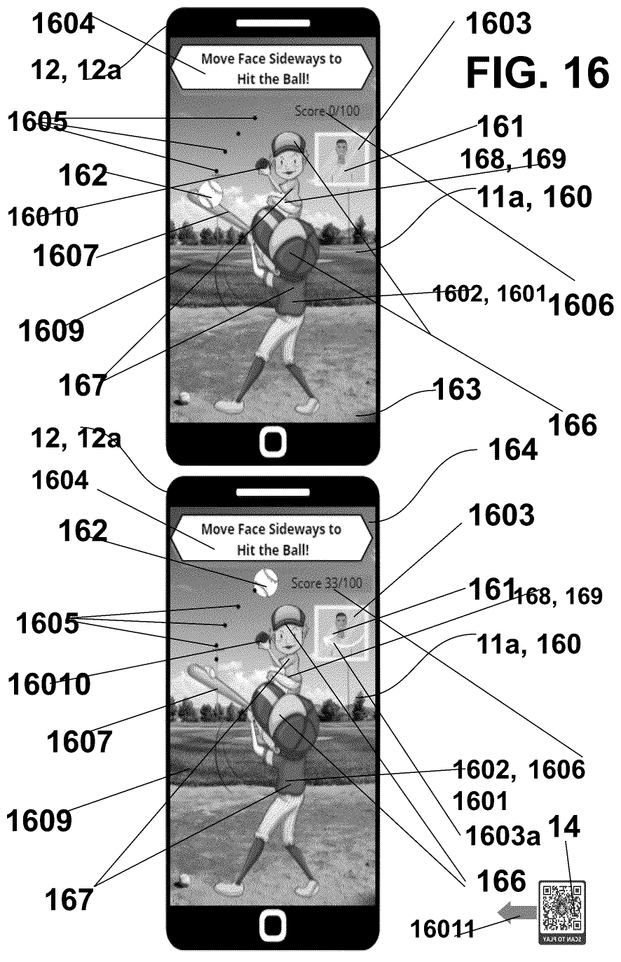

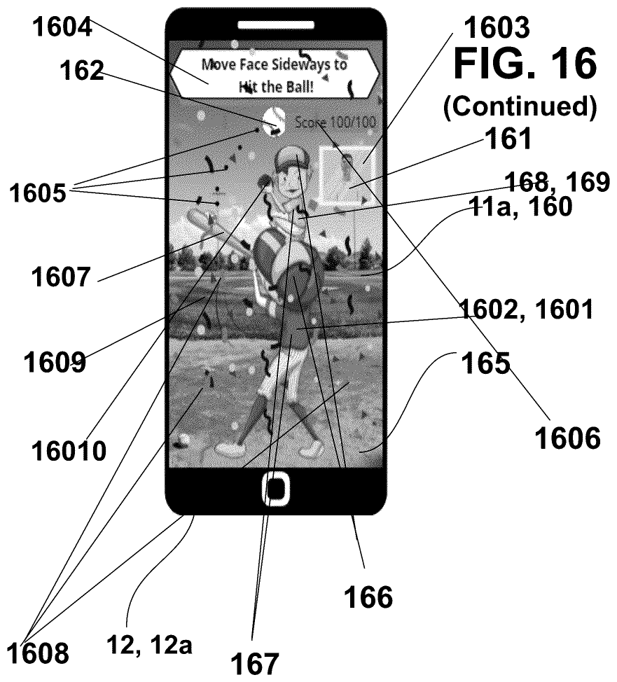

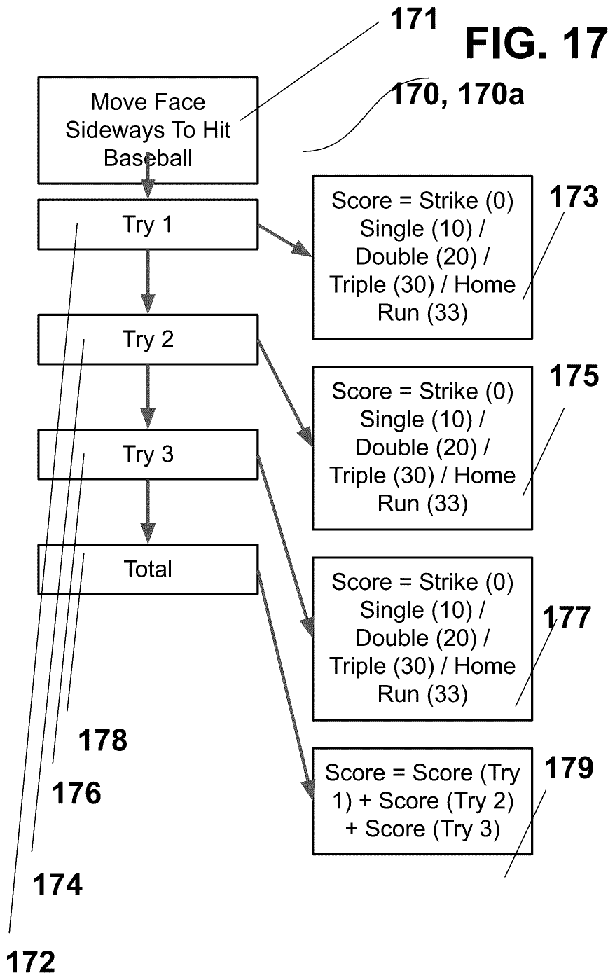

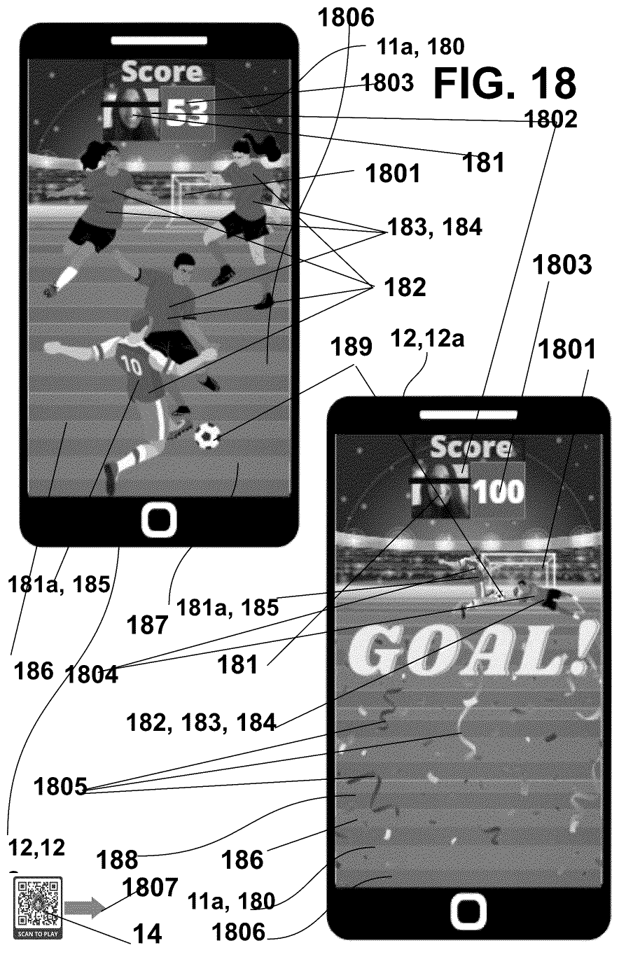

FIG. 16 illustrates an exemplative single-player baseball augmented reality game 11a which serves as the foundation for the augmented reality content 11 component of event entertainment system 10. FIG. 16 illustrates an example of augmented reality game 11a through the illustration of augmented reality game 160. There may be a variety in the types of augmented reality content 11 that may be included in event entertainment system 10. The augmented reality content 11 of event entertainment system 10 may or may not be limited to one type of augmented reality content 11, such as, but not limited to, augmented reality game 160. The illustrations and descriptions in FIG. 16 are not meant to limit the scope of augmented reality game 160. Augmented reality game 160 may be an example of what a baseball game of event entertainment system 10 and/or a variation of a baseball game (such as, but not limited to, gaming methods, game appearance, and applications) might be. Augmented reality game 160 may closely resemble a detail concerning a baseball game, a baseball game associated with event entertainment system 10, and/or a variation of a baseball game (such as, but not limited to gaming methods, the appearance of the game, and applications of the game). FIG. 16 shows that augmented reality content 11 may include and/or demonstrate baseball. The purpose of playing and/or interacting with augmented reality game 160 is for a user (such as, but not limited to, user 161) to use baseball bat 1607 to hit baseball 162. User 161 may use electronic device 12, and may specifically use smartphone 12a, to interact and/or play with augmented reality game 160. User 161 may use head/face/eye movements (as described in FIG. 9), such as, but not limited to, moving and/or tilting his/her head and/or face leftwards and/or rightwards. Other head/face/eye movements may be used to dictate the movement(s) of character 1602. User 161 may control the movement(s) of how character 1602 may be hitting the baseball 162; and, the idea of user 161 controlling the movement(s) of character 1602 as a remote control is described in more detail in FIG. 8. Screen 1603 shows user 161's face; and, this implies that user 161 may be controlling the movement(s) of character 1602. When controlling the movement(s) of character 1602, user 161 may specifically be controlling the movement(s) of baseball bat 1607. In order to control the movement(s) of baseball bat 1607, user 161 may use the aforementioned head/face/eye movements. For example, if user 161 moves and/or tilts his/her face rightwards and/or leftwards, then baseball bat 1607 may swing rightwards and/or leftwards respectively in correspondence to the direction that user 161 may move and/or tilt his/her head and/or face towards. Another example is that if user 161 moves and/or tilts his/her head and/or face rightwards and/or leftwards with force, then baseball bat 1607 may swing harder rightwards and/or leftwards respectively in correspondence to the direction and/or the force at which user 161 may move and/or tilt his/her head and/or face towards. When user 161 moves and/or tilts his/her head and/or face rightwards and/or leftwards, which may lead to baseball bat 1607 swinging harder rightwards and/or leftwards respectively, it may be implied that baseball bat 1607 is hitting baseball 162 with a lot and/or more force. In order to achieve better results in augmented reality game 160 (such as, but not limited to, scoring a home run), it may be recommended for user 161 to move and/or tilt his/her face with (more and/or a lot of) force so that baseball 162 may be hit to move farther along field 1609 (preferably far enough for user 161 to score/achieve a home run). In FIG. 16, arrow 1603a in image 164 may show that user 161 moved and/or tilted his/her head rightwards. Image 163 shows that baseball 162 is touching baseball bat 1607 to imply that character 1602 is in the process of hitting baseball 162. When baseball 162 may be coming in a direction towards character 1602, it may be assumed that opposing player 168 may have thrown baseball 162 in a direction towards character 1602 and that baseball 162 left baseball glove 16010 of opposing player 168 after opposing player 168 has thrown baseball 162. Character 1602 may be shown in the same stance for the images and/or parts 163, 164, and 165 of augmented reality game 160 to imply that character may have three chances to hit baseball 162. Images 163, 164, and 165 serve as examples of a particular scenario of user 161 playing with and/or interacting with augmented reality game 160; and, augmented reality content 160 may be expressed in more images and/or scenarios beyond what is illustrated in FIG. 16. Similarly, for the images and/or scenarios regarding augmented reality content 11 that may be illustrated in the figures in this present disclosure, augmented reality content 11 (including, but not limited to, any and all of its types, categories, and/or examples) may be expressed in more images and/or scenarios beyond what is illustrated in the figures of this present disclosure. Imaginary dots 1605 show the direction that baseball 162 may go towards or may have already gone towards when baseball 162 was hit by baseball bat 1607 and/or when baseball 162 was thrown away from baseball glove 16010. Instructions 1604 shows the instructions that user 161 may follow to play with and/or interact with augmented reality game 160. Instructions 1604 may say, “Move Face Sideways to Hit The Ball”. Instructions 1604 may be worded differently from what is shown in images 163, 164, and 165 in order for a user to better understand how to play with and/or interact with augmented reality game 160. Scoreboard 1606 shows the current score of user 161 throughout his/her interaction and/or play with augmented reality game 160. For example, in image 163, user 161's current score is 0 out of 100 points because user 161 may have not yet completed his/her chance to (and/or is in the process of) hit(ting) baseball 162. Another example is, in image 164, user 161's current score is 33 out of 100 points because user 161 recently hit a home run. Another example is, in image 165, user 161's current score is 100 out of 100 points because user 161 hit a total of three home runs. Image 163 shows character 1602 is about to hit and/or is in the process of hitting baseball 162. Image 164 shows that baseball 162 was hit and user 161 scored 33 points because user 161 used the proper head/face movement(s) with enough force to hit a home run. It is implied that a home run was hit because baseball 162 appears to be far away from baseball bat 1607. Image 165 shows that after getting three chances to hit baseball 162, it may be implied that, based on the scoring system described in FIG. 17, out of user 161's three chances to hit baseball 162, user 161 hit a home run three times, leading to a total score of 100 points. The total score is calculated from user 161's three chances to hit baseball 162. Confetti 1608 may or may not be shown in augmented reality game 160 to imply that user 161 won augmented reality game 160 by scoring a total of 100 points after having three tries to hit baseball 162. Confetti 1608 may not be shown in augmented reality game 160 if user 161 achieved a total score of less than 100 points after having three tries to hit baseball 162. FIG. 17 will cover more information about augmented reality game 160, including, but not limited to, how augmented reality game 160 records the number of points user 160 scores when interacting and/or playing with augmented reality game 160. An example of an entity design that may be illustrated and/or simulated in augmented reality content 11 may be an entity design that may be associated (directly and/or indirectly) with venue 101, company, team, organization, individual, mascot, logo, icon, art, theme, community, uniform, and/or jersey. For instance, an example of an entity design that may be illustrated and/or simulated in augmented reality content 11 may be the following, which includes, but is not limited to, a baseball cap 166 and baseball jersey 167, which may relate to a baseball player associated with the home team 1601 affiliated with venue 101 and/or associated with the opposing team 169 of home team 1601; and, that entity design may relate to the player, a party and/or organization affiliated with the player, and/or venue 101. Other elements, drawings, animations, etc., of augmented reality game 160 may also include an entity design. For example, field 1609 may contain an entity design relating to venue 101, a sports team, a party and/or organization that may be affiliated with and/or controls the sports team, and/or a sponsoring company and/or advertiser of venue 101 and/or of venue 101's event. QR code 14 and arrow 16011 are shown to imply that a user may use an electronic device 12 to scan QR code 14, and scanning QR code 14 may allow the user(s) to retrieve access to augmented reality content 11, such as, but not limited to, augmented reality game 160. A user may retrieve access to augmented reality game 160 via methods other than scanning QR code 14, such as, but not limited to, being provided with a URL.

FIG. 17 illustrates a method 170 for playing an exemplative single-player baseball augmented reality game 160 of the augmented reality content 11 component of the event entertainment system 10. Augmented reality game 160 may be a single-player game because one user (such as, but not limited to, user 161) may be needed to complete augmented reality game 160. However, augmented reality content 11 may be able to be interacted with by one person (i.e. single-player) and/or by more than one person (i.e. multiplayer). Flowchart 170a describes the steps associated with method 170. Step 171 says that a user (i.e. user 161) may move his/her face and/or head side-to-side to hit baseball 162. The instructions for a user to move his/her head and/or face side-to-side to control the movement(s) of baseball bat 1607 may relate to the movements a user may make as described (with the movements of the user 90 and user 91) in FIG. 9. For example, by moving his/her head rightwards properly and/or with force, user 161 may allow baseball bat 1607 to swing rightwards with enough force for baseball 162 to move far across field 1609, thus allowing character 1602 to score a home run (as seen in image 164). By moving and/or tilting his/her face and/or head leftwards and/or rightwards, user 161 may be able to use baseball bat 1607 to hit baseball 162 that opposing player 168 throws to character 1602. Opposing player 168 may be affiliated with and/or identify as opposing team 169. Opposing team 169 may serve as the opponent of a baseball sports team during a live baseball game that venue 101 may host; and, the aforementioned baseball sports team (such as, but not limited to, home team 1601) may be affiliated with venue 101 and may be the team that character 1602 may be affiliated with and/or identifies as in augmented reality game 160. A user may follow the instructions in step 171 by tilting his/her head leftwards (as seen with user 94 in FIG. 9) and by tilting his/her head rightwards (as seen with user 95 in FIG. 9). For FIG. 16 and FIG. 17, a user moving his/her face and/or head and a user titling his/her face and/or head may be used interchangeably. By tilting his/her face leftwards and/or rightwards, the user's character 1602 may also hit baseball 162 with baseball bat 1607. Augmented reality game 170 uses facial recognition to be able to detect the movement(s) of parts of (and/or the whole of) a user's face moving and/or not moving side-to-side by detecting the movement(s) of various parts of a user's body, such as, but not limited to, a user's nose. Some augmented reality content 11, such as augmented reality game 160, may be able to detect a user's face and/or parts of a user's face regardless of if the user is or is not wearing a face mask. If baseball bat 1607 swings rightwards, character 1602 may have properly hit baseball 162 at any force. If baseball bat 1607 swings leftwards, then character 1602 may not have properly hit baseball 162 at any force. When user 161 moves and/or tilts his/her face and/or head leftwards, baseball 162 may be hit at a direction away from field 1609 and/or baseball 162 may not be hit at all. When user 161 moves and/or tilts his/her face and/or head leftwards, baseball bat 1607 may swing leftwards, thus potentially hitting baseball 162 in a direction away from field 1609 and/or not hitting baseball 162 at all. If the facial recognition component of augmented reality game 160 does not detect user 161 moving and/or tilting his/her face properly to the aforementioned facial recognition component's standards of making a score, such as, but not limited to, “Single”, “Double”, “Triple”, and “Home Run” (as shown in steps 173, 175, 177, and 179), then user 161 may receive a score, “Out” for the trial (first, second, and/or third trial(s)) user 161 may have been given. Step 172 says that user 161 may be given his/her first try to move his/her face side to side to hit baseball 162. Step 173 lists the scores and the identification of the type of score user 161 may receive on his/her first try. The score and/or of the identification of the type of score user 161 may receive on his/her first try may depend on how augmented reality game 160's facial recognition component determines how hard (in terms of force) user 161 moved his/her face rightwards to hit baseball 162 with baseball bat 1607. The scoring system of step 173 includes the following: If augmented reality game 160's facial recognition component recognizes and/or determines that user 162 did not move his/her face side-to-side (and/or did not move his/her face rightwards) and/or moved his/her face leftwards, then augmented reality game 160's facial recognition component may determine that user 162 failed to hit baseball 162, thus leading to user 161's score to be 0 points; and, the score may identify as “Strike”. If augmented reality game 160's facial recognition component recognizes and/or determines that user 162 moved his/her face side-to-side (and/or moved his/her face rightwards), then augmented reality game 160's facial recognition component may determine that user 162 hit baseball 162, thus leading to user 161's score to be 10 points; and, the score may identify as “Single”. If augmented reality game 160's facial recognition component recognizes and/or determines that user 162 moved his/her face side-to-side (and/or moved his/her face rightwards) with more force than the side-to-side and/or rightwards movement(s) that may be necessary for a “Single” score, then augmented reality game 160's facial recognition component may determine that user 161 hit baseball 162, thus leading to user 161's score to be 20 points; and, the score may identify as “Double”. If augmented reality game 160's facial recognition component recognizes and/or determines that user 162 moved his/her face side-to-side (and/or moved his/her face rightwards) with more force than the side-to-side movement and/or rightwards movement that may be necessary for a “Double” score, then augmented reality game 160's facial recognition component may determine that user 162 hit baseball 162, thus leading to user 161's score to be 30 points; and, the score may identify as “Triple”. If augmented reality game 160's facial recognition component recognizes and/or determines that user 162 moved his/her face side-to-side (and/or moved his/her face rightwards) with more force than the side-to-side movement and/or rightwards movement that may be necessary for a “Triple” score, then augmented reality game 160's facial recognition component may determine that user 162 hit baseball 162, thus leading to user 161's score to be 33 points; and, the score may identify as “Home Run”. Step 174 says that user 161 may be given his/her second try to move his/her face side to side to hit baseball 162. Step 175 lists the scores and the identification of the type of score user 161 may receive on his/her second try; and, the scores and aforementioned identifications (aka scoring system) may be the same scores and identifications (aka scoring system) as described in step 173. Step 176 says that user 161 may be given his/her third try to move his/her face side to side to hit baseball 162. Step 177 lists the scores and the identification of the type of score user 161 may receive on his/her second try; and, the scores and aforementioned identifications (aka scoring system) may be the same scores and identifications (aka scoring system) as described in step 173. After any of the tries that user 161 may receive, for the scores that identify as the bases, “Single”, “Double”, and/or “Triple”, one or more animation(s) may show character 1602 running to the base that may be associated with the score that user 161 may receive in each of the three tries to hit baseball 162. After any of the tries that user 161 may receive, for the scores that identify as “Home Run”, one or more animation(s) may show character 1602 running farther down field 1609. After any of the tries that user 161 may receive, for the scores that identify as “Strike” one or more animation(s) may not show character 1602 running to a base and/or running down field 1609. For each of the scores that user 161 may receive, the identification of the score, such as, but not limited to, “Strike”, “Single”, “Double”, “Triple”, and “Home Run”, may show as big letters and/or animations of “Strike”, “Single”, “Double”, “Triple”, and “Home Run” respectively on electronic device 12 after user 161's first, second, and/or third trial(s) may be finished. Step 178 says that the total score may be calculated during and/or after user 161 finishes the first, second, and/or third trials of augmented reality game 160. The total score that may be calculated during and/or after user 161 finishes the first, second, and/or third trials of augmented reality game 160 may be shown on scoreboard 1606 as and/or after user 151 progresses with augmented reality game 160. Step 179 shows how the total score may be calculated. Step 179 says the total score may be calculated by the summation of the scores of the first, second, and/or third trials. The first score may be calculated in step 173. The second score may be calculated in step 175. The third score may be calculated in step 177. An example of step 179 being the summation of the scores of the three trails may be if user 161 scores a “Single” (aka 10 points) on the first trial, a “Out” (aka 0 points) on the second trial, and a “Home Run” (aka 33 points) on the third trial, then the summation of the scores of the three trials (aka total score) may be 43 points. The total score may range from 0 points to 100 points. The total score may be rounded to 100 points (instead of 99 points) if user 161 scores a “Home Run” during each trial for the three trials. If user 161 scores a “Out” during each trial for the three trials, then, at the end of augmented reality game 160, animations of the words, “Game Over” and/or “You're Out”, may show on electronic device 12.

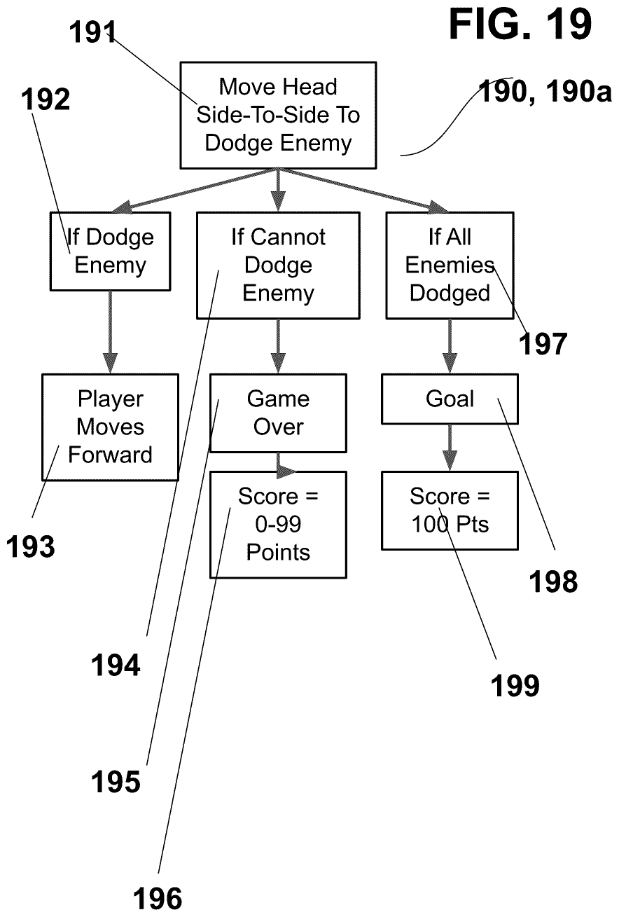

FIG. 18 illustrates an exemplative single-player soccer augmented reality game 11a which serves as the foundation for the augmented reality content 11 component of event entertainment system 10. FIG. 18 illustrates an example of augmented reality game 11a through the illustrations of augmented reality game 180. There may be variety in the types of augmented reality content 11 that may be included in event entertainment system 10. The augmented reality content 11 of event entertainment system 10 involves one or more types of augmented reality content 11, such as, but not limited to, augmented reality game 180. The illustrations and descriptions in FIG. 18 are not meant to limit the scope of augmented reality game 180. Augmented reality game 180 may be an example of what a soccer game of event entertainment system 10 and/or a variation of a soccer game (such as, but not limited to, gaming methods, game appearance, and applications) might be. Augmented reality game 180 may closely resemble a detail concerning a soccer game, a soccer game associated with event entertainment system 10, and/or variations of a soccer game (such as, but not limited to gaming methods, the appearance of the game, and applications of the game). FIG. 18 shows that augmented reality content 11 may include and/or demonstrate soccer. The purpose of playing and/or interacting with augmented reality game 180 may be for a user (such as, but not limited to, user 181) to move his/her face side-to-side to dodge the enemies 182 while character 181a runs down the field 186 and kicks soccer ball 189. The user may successfully win augmented reality game 180 if he/she has character 181a dodge the enemies 182 that character 181a may run past and/or through when running to goal post 1801 to score a goal. User 181's ability to move side-to-side may be demonstrated by the face/eye/head movements in FIG. 9. If character 181a fails to dodge and/or move past any of the enemies, the user 181 will lose augmented reality game 180. The idea of user 181 controlling that movement(s) of character 181a as a remote control may be described in FIG. 8. Screen 1802 shows the face of user 181 in the real world; and, this implies that user 181 controls the movement of character 181a. For example, if user 181 moves and/or tilts his/her face and/or head leftwards, then character 181a may run leftwards. Another example is that if user 181 moves and/or tilts his/her face and/or head rightwards, then character 181a may run rightwards. The enemies 182 (aka opposing character(s) 183) that character 181a may try to dodge and/or run past may be associated with opposing team 184. Opposing team 184 may be the actual opponent that venue 101's home team may play a game (i.e. soccer game) against during venue 101's live event. Soccer ball 189 may be near the feet of character 181a to imply that character 181a is trying to kick soccer ball 189 and/or move soccer ball 189 through field 186 while character 181a is running through field 186. Character 181a may be seen in a similar stance throughout user 181's interaction with augmented reality game 180. The instructions of augmented reality game 180 may be similar to the instructions of augmented reality game 85. The instructions of augmented reality game 180 in FIG. 18 may be implied. It is possible that user 181 may have already encountered a potential home screen and/or page of augmented reality game 180 which may show the instructions for augmented reality game 180. Scoreboard 1803 shows the current score that user 181 may have while playing with and/or interacting with augmented reality game 180. In image 187, scoreboard 1803 shows that user 181 has 53 points; and, in image 188, scoreboard 1803 shows that user 181 has 100 points. In order to win augmented reality game 180, user 181 may need to score 100 points. When user 181 reaches 100 points, animation(s) may show character 181a scoring a goal and/or kicking soccer ball 189 towards goal post 1801 without soccer ball 189 getting caught by opposing character 183 (such as, but not limited to a goalkeeper in a soccer-based game). Also, when user 181 wins augmented reality game 180, the words, “Goal” may be shown; and, confetti 1805 may show. The appearance of venue 1806 may closely resemble the appearance of venue 101, especially if venue 1806 may have and/or be a soccer stadium. FIG. 19 will cover more information about augmented reality game 180, including, but not limited to, the scenarios by which the movement(s) of user 181 may dictate how user 181's interaction with augmented reality game 180 unfolds. An example of an entity design that may be illustrated and/or simulated in augmented reality content 11, such as, but not limited to augmented reality game 180, may be an entity design that may be associated (directly and/or indirectly) with venue 101, company, team, organization, individual, mascot, logo, icon, art, theme, community, uniform, and/or jersey. For instance, an example of an entity design that may be illustrated and/or simulated in augmented reality content 11 may be the following, which includes, but is not limited to, soccer jersey 1804, which may relate to a soccer player associated with the home team 185 affiliated with venue 101 and/or associated with the opposing team 184 of home team 185; and, entity design may relate to the player, a party and/or organization affiliated with the player, and/or venue 101. Other elements, drawings, animations, etc. of augmented reality game 180 may also include entity design. For example, field 186 may contain an entity design that relates to venue 101, a sports team, a party and/or organization that may be affiliated with and/or controls the sports team, and/or a sponsoring company and/or advertiser of venue 101 and/or of venue 101's event. QR code 14 and arrow 1807 are shown to imply that a user may use an electronic device 12 to scan QR code 14, and scanning QR code 14 may allow the user(s) to retrieve access to augmented reality content 11, such as, but not limited to, augmented reality game 180. A user may retrieve access to augmented reality game 180 via methods other than scanning QR code 14, such as, but not limited to, being provided with a URL.

FIG. 19 illustrates a method 190 for playing an exemplative single-player soccer augmented reality game 180 of augmented reality content 11 component of event entertainment system 10. Method 190 of augmented reality game 180 may closely resemble method 130 of augmented reality game 85. Augmented reality game 180 may be a single-player game because one user (such as, but not limited to, user 181) may be needed to complete augmented reality game 180. However, augmented reality content 11 may be able to be interacted with by one person (i.e. single-player) and/or more than one person (i.e. multiplayer). Flowchart 190a describes the steps associated with method 190. Step 191 says that a user (i.e. user 181) who uses electronic device 12 to interact with augmented reality game 180 may move his/her head side-to-side to dodge the enemy 182 (aka opposing character 183). The instructions for a user to move his/her head side-to-side may relate to the movements a user may make as described in FIG. 9. For example, a user may follow the instructions in step 191 by moving his/her face leftwards (as seen with user 90 in FIG. 9) and/or rightwards (as seen with user 91 in FIG. 9). By moving his/her face leftwards and/or rightwards, the user's character 181a may dodge the enemy(-ies) 182, which means that character 181a may be able to move farther down the field 109 without physically clashing with any of the enemies 182 in augmented reality game 180. The enemies 183 may be classified as opposing team 184 in augmented reality game 180. A user may also follow the instructions in step 191 by tilting his/her head leftwards (as seen with user 94 in FIG. 9) and by tilting his/her head rightwards (as seen with user 95 in FIG. 9). By tilting his/her face and/or head leftwards and/or rightwards, the user's character 181a may also dodge the enemy(-ies) 182. Augmented reality game 180 may use facial recognition to be able to detect the movement(s) of a user's face moving and/or not moving side-to-side by detecting the movement(s) of various parts of a user's body, such as, but not limited to, a user's nose, Some augmented reality content 11, such as, but not limited to, augmented reality game 180, may be able to detect a user's face and/or parts of a user's face regardless of if the user is or is not wearing a face mask. Step 192 says that if the user dodges an enemy 182 (of opposing team 184), then step 193 may follow in which the player moves forwards through field 186. In other words, if the user runs through and/or past enemy 183 and does not clash with enemy 183, then character 181a may be able to run farther down the field 186. Step 194 says that if a user cannot dodge enemy 183 (in other words, character 181a clashes with enemy 183), then step 195 may follow in which the user has lost augmented reality game 180 (aka “game over”). Step 196 says that if a user loses augmented reality game 180, then his/her total score may be between 0 and 99 points. Step 197 says that if character 181a does not clash into or hit any of the enemies 183, then step 198 may follow in which the user/character 181a will score a goal. In this soccer-based augmented reality game 180, scoring a goal implies that the user has won augmented reality game 180. If the user wins augmented reality game 180, then his/her total score may be 100 points (as shown in step 199). In FIG. 19 assumes that a user (i.e. user 181) and character 181a may be used interchangeably because, as described in FIG. 8, a user's face and/or another part of the user's body may serve as the remote control of augmented reality game 180.

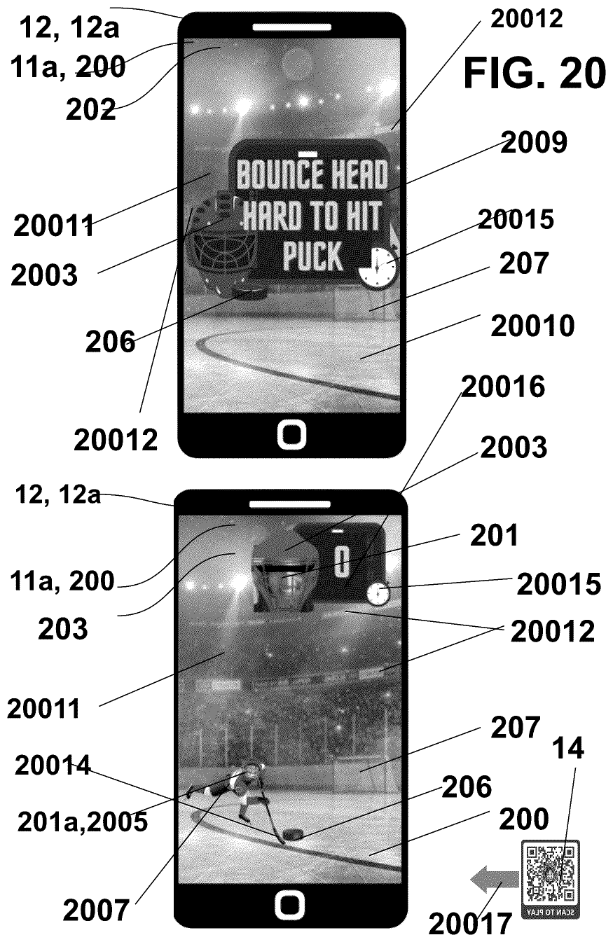

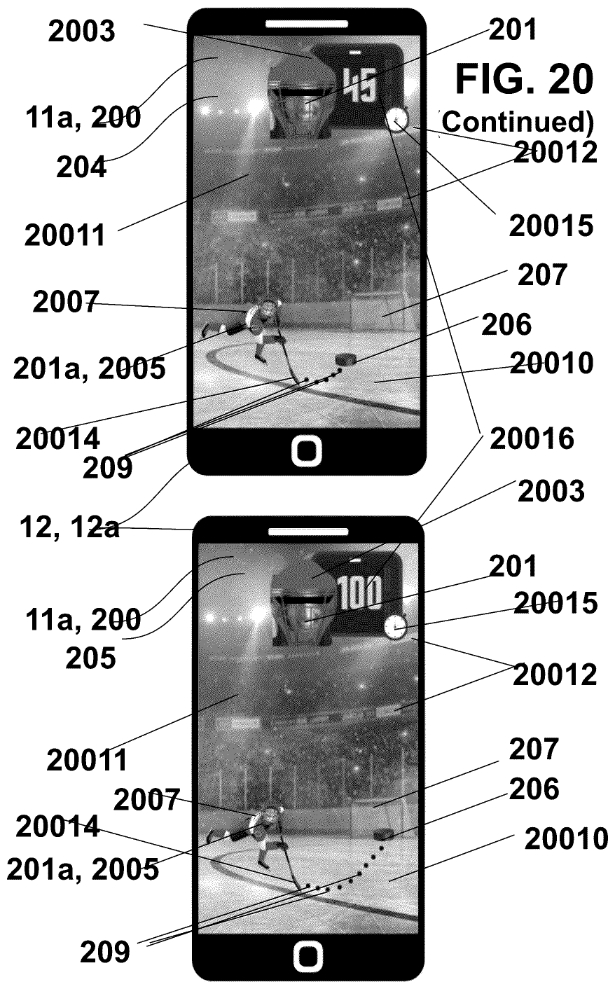

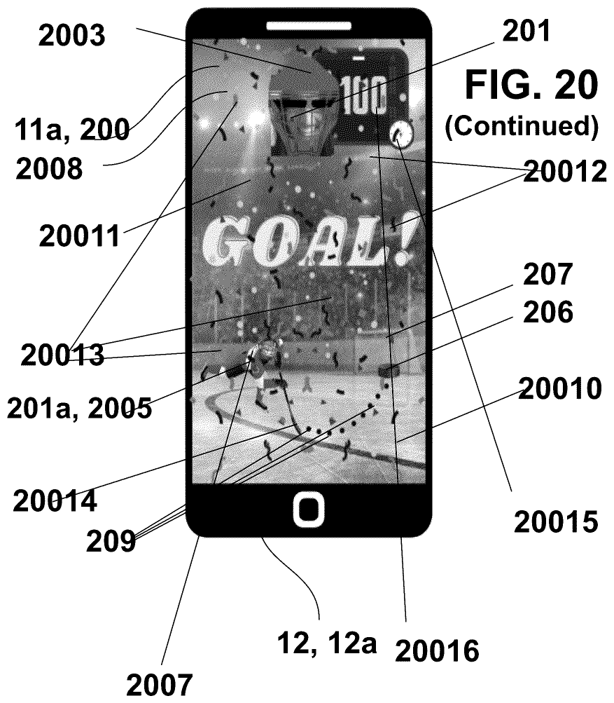

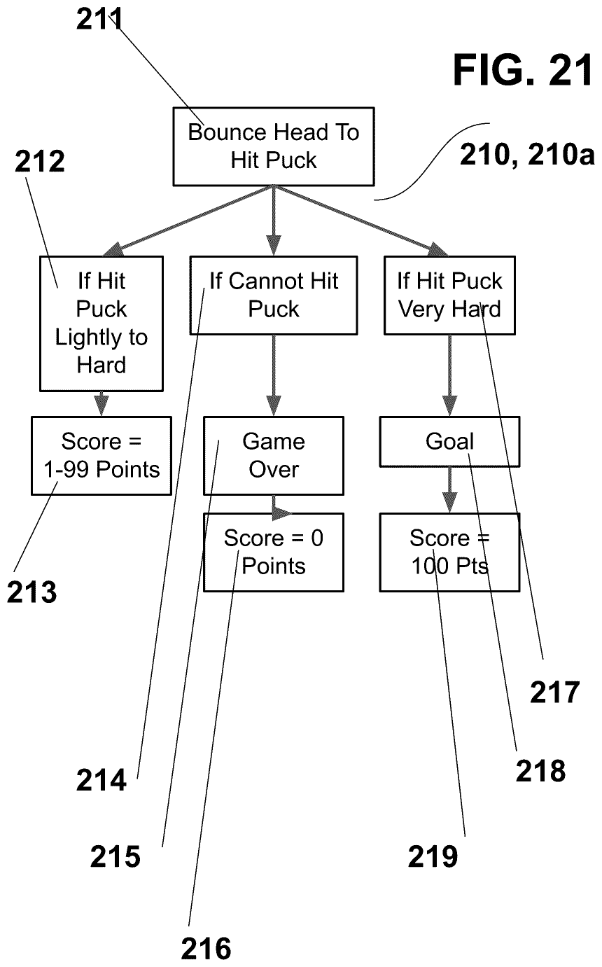

FIG. 20 illustrates an exemplative single-player hockey augmented reality game 11a which serves as the foundation for the augmented reality content 11 component of event entertainment system 10. FIG. 20 illustrates an example of augmented reality game 11a through the illustration of augmented reality game 200. There may be a variety in the types of augmented reality content 11 that may be included in event entertainment system 10. The augmented reality content 11 of event entertainment system 10 may include augmented reality game 200. The illustrations and descriptions in FIG. 20 are not meant to limit the scope of augmented reality game 200. Augmented reality 200 may be an example of what a hockey (such as, but not limited to ice hockey) game of event entertainment system 10 and/or a variation of a hockey game (such as, but not limited to, gaming methods, game appearance and applications) might be. Augmented reality game 200 may closely resemble a detail concerning a hockey game, a hockey game associated with event entertainment system 10, and/or a variation of a hockey game (such as, but not limited to gaming methods, the appearance of the game, and applications of the game). FIG. 20 does not limit the scope of what may be illustrated in FIG. 20. FIG. 20 shows that augmented reality content 11 that may include and/or demonstrate hockey. The purpose of playing and/or interacting with augmented reality game 200 may be for a user (such as, but not limited to, user 201) to push his/her head and/or face forward with enough force so that character 201a may hit hockey puck 206 into goal cage 207 to score a goal. A timer 20015 may be shown and/or utilized in augmented reality game 200. A timer may be shown to imply that there may be a fixed duration of how long augmented reality game 200 lasts during a user's interaction and/or play with augmented reality game 200. For instance, augmented reality game 200 may have a fixed time duration of 20 seconds, in which user 201 may have a total time limit of 20 seconds to be able to hit hockey puck 206 into goal cage 207 to score a goal. A timer and/or fixed time duration also may not be necessary for augmented reality game 200. For instance, the duration of augmented reality game 200 may continue until user 201 tries once to hit hockey puck 206 and/or may continue until user 201 tries to hit hockey puck 206 three times and/or may continue until user 201 successfully hits hockey puck 206 into goal cage 207. User 201 may be seen wearing an ice hockey helmet 2003 in augmented reality game 200 as illustrated in images 203, 204, 205, and 2008. Character 201a may represent a player, such as, but not limited to an ice hockey player, who may be affiliated with an ice hockey sports team that may be the home team (such as, but not limited to, home team 2005) of venue 101. User 201's avatar may represent this aforementioned player who may identify as a part of the sports team that user 201 may favor. User 201 may control the movement(s) of character 201a as a remote control; and, the idea of user 201 controlling the movement(s) of character 201a as a remote control may be further described in FIG. 8. The movement(s) that user 201 may make to control the movement(s) of character 201a, may include, but is not limited to, bouncing his/her head and moving his/her head downwards; and, the aforementioned movement(s) may be further described in FIG. 9. Instructions 2009 may be shown on augmented reality game 200 before the game starts. In image 202, instructions 2009 may show the phrase, “Bounce Head Hard To Hit Puck”; and, this phrase may be simplified and/or written differently for user 201 to better understand how to play augmented reality game 200; but, the instructions involved with the programming language that runs augmented reality game 200 may differ from instructions 2009 while intending to achieve the same result(s) for augmented reality game 200. In image 203, 204, 205, and 2008, character 201a may be seen at the same stance throughout augmented reality game 200 to imply that character 201a is ready to hit (and/or is hitting) hockey puck 206 with the intention of scoring a goal. The venue illustrated in augmented reality game 200, which includes, but is not limited to, ice rink 20010, seating area 20011, and banner 20012, may closely resemble venue 101 if the structure of venue 101 was made to accommodate and/or host ice hockey games. Logo(s) may be incorporated on ice rink 20010 and other animations, elements, and/or images of augmented reality game 200. In images 204, 205, and 2008, imaginary dots 209 show the direction at which hockey puck 206 was hit and how far hockey puck 206 has gone in the direction towards goal cage 207. Image 203 shows no imaginary dots 209 because hockey puck 206 was not yet hit by character 201a. This situation may be accompanied with user 201's score of 0 points in image 203 (as shown in scoreboard 20016). Image 204 shows some imaginary dots 209 because hockey puck 206 was hit by character 201a, but user 201 did not move his/her head forward with enough force to the extent that character 201a would score a goal. This situation may be accompanied with user 201's score of 45 points (as shown in scoreboard 20016). Images 205 and 2008 show more imaginary dots 209 than in image 204 because hockey puck 206 was hit by character 201a and user 201 moved his/her head forward with enough force to the extent that character 201a would score a goal. In images 205 and 2008, hockey puck 206 may be seen inside goal cage 207 because hockey puck 206 was hit hard enough by the facial movement(s) user 201 made to score a goal. This situation may be accompanied by user 201's total score of 100 points (as shown in scoreboard 20016). The total number of points user 201 may achieve in augmented reality game 200 may be 100 points. The closer hockey puck 206 is to goal cage 207 after character 201a hits hockey puck 206, the more points user 201 may get. This description of the scoring system is illustrated in the scores, including, but not limited to, 0, 45, and 100 points in images 203, 204, 205, and 2008. If user 200 scores 100 points, the word, “Goal” and/or confetti 20013 may show on the screen of electronic device 12. The opposing team 2006 in the live event that venue 101 may host (while augmented reality game 200 may be broadcasted) may or may not be illustrated in augmented reality game 20. FIG. 21 will cover more information about augmented reality game 200, including, but not limited to, the scenarios by which the movement(s) of user 201 may dictate how user 201's interaction with augmented reality game 200 may unfold. An example of an entity design that may be illustrated and/or simulated in augmented reality content 11, such as, but not limited to, augmented reality game 200, may be an entity design that may be associated (directly and/or indirectly) with venue 101, company, team, organization, individual, mascot, logo, icon, art, theme, community, uniform, and/or jersey. For instance, an example of an entity design that may be illustrated and/or simulated in augmented reality content 11 may be the following, which includes, but is not limited to, hockey jersey 2007 and hockey stick 20014, which may relate to a hockey player associated with the home team 2005 affiliated with venue 101 and/or associated with the opposing team 2006 of home team 2005; and, that entity design may relate to a player and/or venue 101. Other elements, drawings, animations, etc., of augmented reality game 200 may also include entity design. For example, ice rink 20010 may contain an entity design that relates to venue 101, a sports team, a party and/or organization that may be affiliated with and/or controls the sports team, and/or a sponsoring company and/or advertiser of venue 101 and/or venue 101's event. QR code 14 and arrow 20017 are shown to imply that a user may use an electronic device 12 to scan QR code 14, and scanning QR code 14 may allow the user(s) to retrieve access to augmented reality content 11, such as, but not limited to, augmented reality game 200. A user may retrieve access to augmented reality game 200 via methods other than scanning QR code 14, such as, but not limited to, being provided with a URL.

FIG. 21 illustrates a method 210 for playing an exemplative single-player ice hockey augmented reality game 200 of the augmented reality content 11 component of the event entertainment system 10. Augmented reality game 200 may be a single-player game because one user (such as, but not limited to, user 201) may be needed to complete augmented reality game 200. However, augmented reality content 11 may be able to be interacted with by one person (i.e. single-player) and/or by more than one person (i.e. multiplayer). Flowchart 210a describes the steps associated with method 210. Step 211 says that a user (such as, but not limited to user 201) may move and/or bounce his/her head and/or face forward to hit hockey puck 206. The instructions for a user to move his/her face forward to hit hockey puck 206 may relate to the movements a user may make as described (with the movements of user 93, user 94, and user 97) in FIG. 9. For example, by moving his/her head forwards with enough force, user 201 may allow character 201a to hit hockey puck 206 into goal cage 207 to score a goal. The facial recognition component of augmented reality game 200 determines the strength of the force user 201 may have used when making various facial movements that satisfy instructions 2009 for user 201 to bounce his/her head forward with force to hit hockey puck 206. After analyzing the facial movement(s) of user 201, the facial recognition component and/or programming of augmented reality game 200 determines if and/or how much force user 201 moved his/her head and/or face forwards and may provide a score, ranging from 0 to 100 points based on the aforementioned determination. Based on the aforementioned determination, the programming component of augmented reality game 200 determines whether user 210 hit hockey puck 206 at all, lightly, hard, and/or very hard, and provides a score ranging from 0 to 100 points based on this determination. Step 212 says that if the facial movement(s) of user 201 causes hockey puck 206 to be hit from light to hard, then step 213 may follow in which user 201 may receive a score of 1 to 99 points in augmented reality game 200. In other words, if the facial recognition component and/or programming of augmented reality game 200 determines that user 201 moved his/her face and/or head forward with a strength of light force to hard force, then user 201's score in augmented reality game 200 may range from 0 to 99 points. Step 214 says that if the facial movement(s) of user 201 causes hockey puck 206 to not be hit at all, then step 215 may follow in which the game is over, and step 216 may follow in which user 201 may receive a score of 0 points in augmented reality game 200. In other words, if the facial recognition component and/or programming of augmented reality game 200 determines that user 201 moved his/her face and/or head forward with a strength of no force (which may also mean that if the facial recognition component and programming of augmented reality game 200 determines that user 201 did not move his/her face and/or head at all), then user 201's score in augmented reality game 200 may be 0 points. Step 217 says that if the facial movement(s) of user 201 causes hockey puck 206 to be hit very hard, then step 218 may follow in which user 201 scores a goal (via character 201a), and step 219 may follow in which user 201 may receive a score of 100 points in augmented reality game 200. In other words, if the facial recognition component and programming of augmented reality game 200 determines that user 201 moved his/her head and/or face forward with a strength of a lot of force, then user 201's score in augmented reality game 200 may be 100 points.

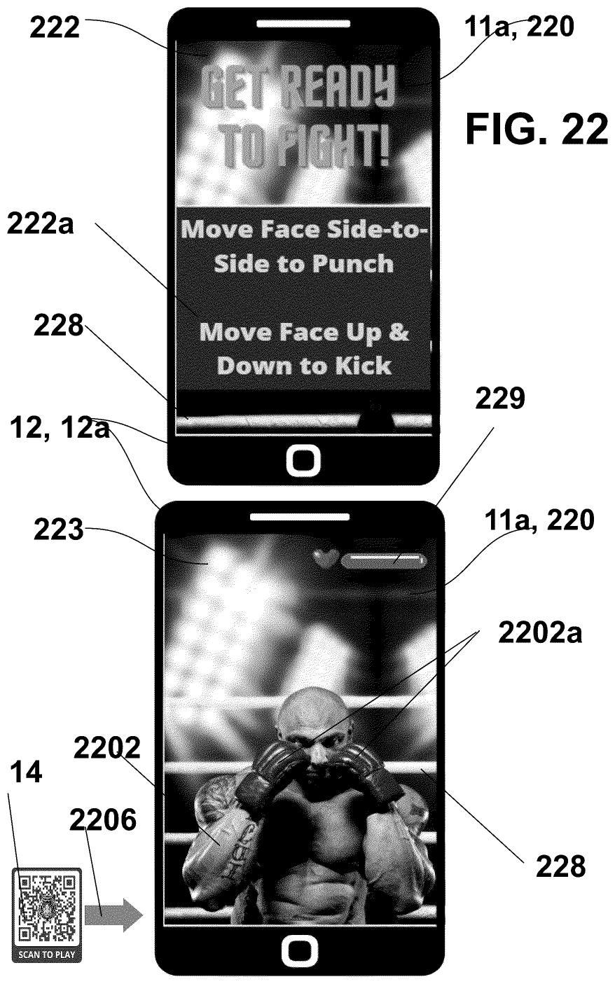

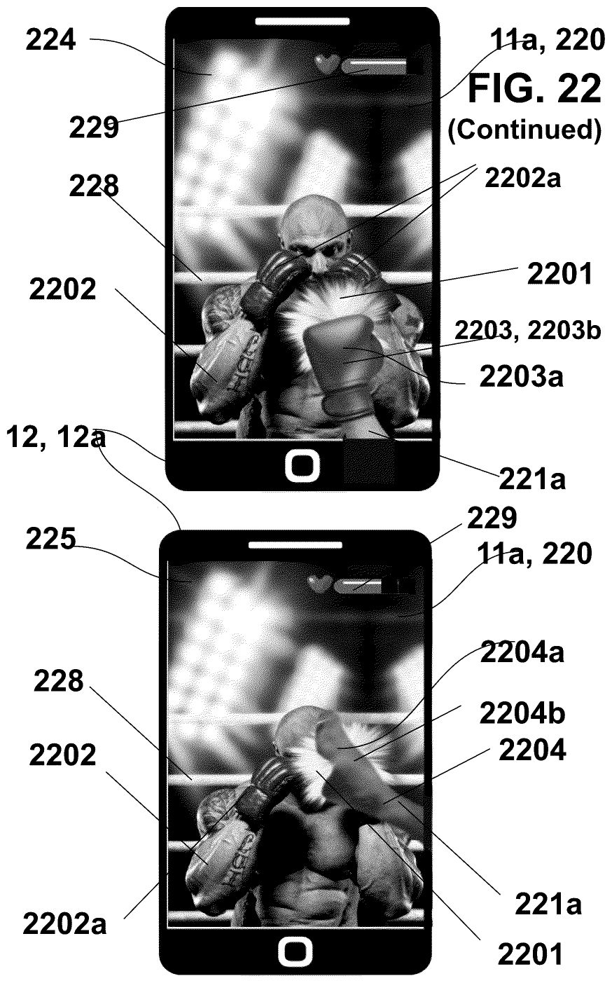

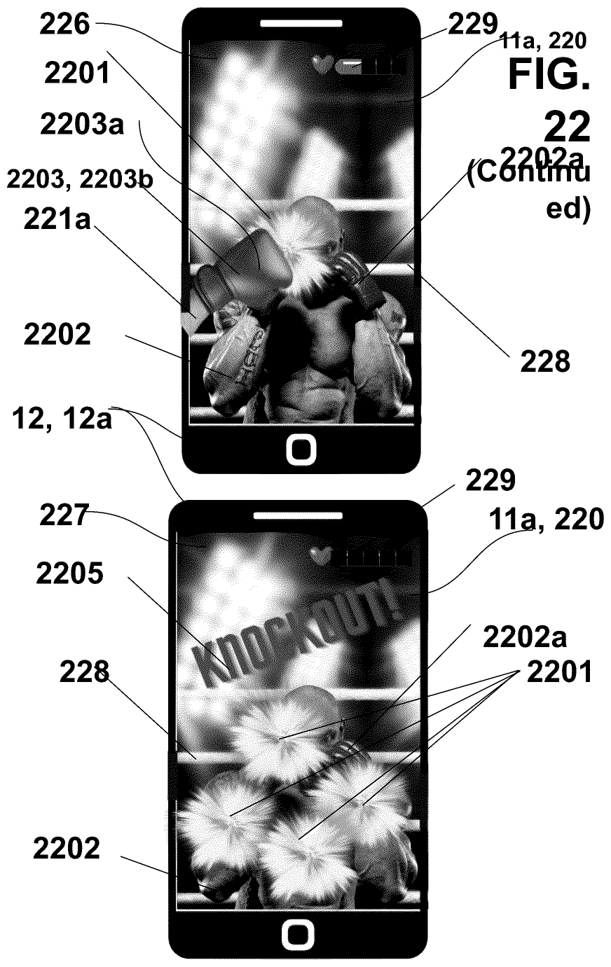

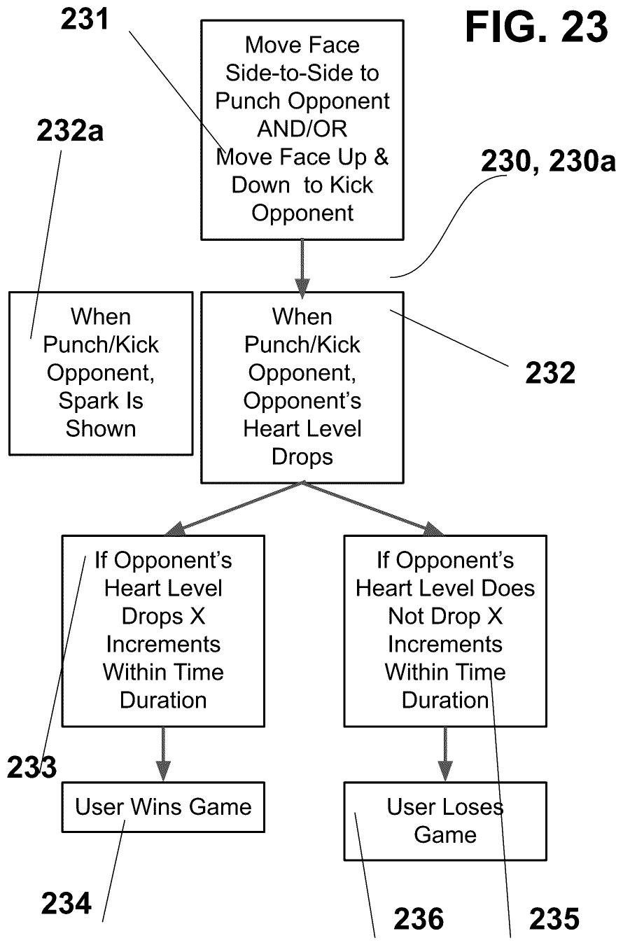

FIG. 22 illustrates an exemplative single-player martial arts augmented reality game 11a which serves as the foundation for the augmented reality content 11 component of event entertainment system 10. FIG. 22 illustrates an example of augmented reality game 11a through the illustration of augmented reality game 220. There may be a variety in the types of augmented reality content 11 that may be included in event entertainment system 10. The augmented reality content 11 of event entertainment system 10 may not be limited to augmented reality game 220. The illustrations and descriptions in FIG. 22 are not meant to limit the scope of augmented reality game 220. Augmented reality game 220 may be an example of what a martial arts (such as, but not limited to mixed martial arts, aikido, hapkido, judo, jiu jitsu, karate, krav maga, kung fu, muay thai, taekwondo, and tai chi) game of event entertainment system 10 and/or a variation of a martial arts game (such as, but not limited to, gaming methods, game appearance and applications) may be. Augmented reality game 220 may closely resemble a detail concerning a martial arts game, a martial arts game associated with event entertainment system 10, and/or a variation of a martial arts game (such as, but not limited to, gaming methods, the appearance of the game, and applications of the game). FIG. 22 shows that augmented reality content 11 may include and/or demonstrate martial arts. The purpose of playing augmented reality game 220 is for user 221 to make character 221a punch and/or kick opponent 2202 enough times within a particular time duration so that opponent 2202's heart level 229 drops to zero. Character 221a and opponent 2202 may represent martial arts players and/or athletes. In image 222, instructions 222a show facial movements that user 221 may make to play with and/or interact with augmented reality game 220. Instructions 222a say that user 221 may move and/or tilt his/her head and/or face side-to-side so that character 221a punches opponent 2202. Instructions 222a also say that user 221 may move and/or tilt his/her head and/or face up and/or down so that character 221a kicks opponent 2202. The facial movements that user 221 may make to interact with and/or play with augmented reality game 220 may be expressed by some of the facial expressions illustrated in FIG. 9, such as the facial expressions made by users 90, 91, 92, 93, 94, and 95. User 221's face and/or another part of the user's body may serve as the remote control of augmented reality game 220; and, the idea of user 221's face and/or another part of the user's body serving as the remote control of augmented reality game 220 may be described in FIG. 8. Character 221a represents user 221 in augmented reality game 220. In FIG. 22, character 221a may be shown in augmented reality game 220. Parts and/or portions of character 221a are shown in images 224, 225, and 226, such as, but not limited to character 221a's hands 2203, gloves 2203b, legs 2204, and feet 2204b; and, these parts of character 221a may be shown when user 221 makes facial movements to have character 221a punch and/or kick opponent 2202. Examples of how user 221 interacts and/or plays with augmented reality game 220 as a remote control are shown in images 224, 225, and 226. For instance, in user 221's trial/interaction/play with augmented reality game 220, image 224 shows that user 221 moved and/or tilted his/her face side-to-side to punch opponent 2202. The punch 2203a opponent 2202 receives may be accompanied with spark 2201 for a dramatic effect. Another example (of how user 221 interacts and/or plays with augmented reality game 220 as a remote control) is that image 225 shows that user 221 moved and/or tilted his/her face up and/or down to kick opponent 2202. The kick 2204a opponent 2202 received may be accompanied with spark 2201. Another example (of how user 221 interacts and/or plays with augmented reality game 220 as a remote control) is that image 226 shows that user 221 moved and/or tilted his/her face side-to-side to punch opponent 2202. The punch 2203a opponent 2202 received may be accompanied with spark 2201 to show and/or create a dramatic effect. If opponent 2202's heart level 229 does not drop to zero within a particular time duration, then user 221 may lose augmented reality game 220. A person, such as, but not limited to, a venue owner and/or game developer and/or programmer may choose a particular time duration for augmented reality game 220, such as choosing a user's interaction with augmented reality game 220 to last for durations, such as, but not limited to, twenty seconds and a minute. Image 223 may show the introduction of augmented reality game 220. In image 223, opponent 2202 may be shown as the introduction of augmented reality game 220. Opponent 2202 and/or character 221a may represent renown martial arts players, such as, but not limited to, renown martial artists affiliated with the mixed martial arts promotion organization, Ultimate Fighting Championship (UFC). Opponent 2202 and/or character 221a may also represent martial arts teams, countries, etc. Venue 101 may represent a venue that hosts live martial arts events, such as events affiliated with the UFC. Image 227 shows that user 221 won augmented reality game 220 because heart level 229 of opponent 2202 dropped to zero. As seen in image 227, the words, “Knockout” 2205 may show to imply that user 221 won augmented reality game 220. User 221's success from winning augmented reality game 220 may be accompanied with multiple sparks 2201 placed on opponent 2202 to imply that character 221a defeated opponent 2202. In FIG. 22, opponent 2202 may be trying to defend himself/herself and/or punching and/or kicking character 221a. FIG. 23 will cover more information about augmented reality game 220 including, but not limited to, the scenarios by which the movement(s) of user 221 may dictate how user 221's interaction with augmented reality game 220 unfolds. An example of an entity design that may be illustrated and/or simulated in augmented reality content 11, such as, but not limited to, augmented reality game 220, may be any entity design that may be associated (directly and/or indirectly) with venue 101, company, team, organization, individual, mascot, logo, icon, art, theme, community, uniform, and/or jersey. For instance, an example of an entity design that may be illustrated and/or simulated in augmented reality content 11 may be the following, which includes, but is not limited to, the clothes of the players, gloves 2203b of character 221, and gloves 2202a of opponent 2202, which may relate to a martial arts player(s) associated with the home team affiliated with venue 101, and/or associated with the opposing team of the aforementioned home team; and, that entity design may relate to the player(s) and/or venue 101. Other elements, drawings, animations, etc. of augmented reality game 220 may also include entity design. For example, cage 228 may contain entity design that may relate to venue 101, a sports team, a party and/or organization that may be affiliated with and/or controls the sports team, and/or a sponsoring company and/or advertiser of venue 101 and/or venue 101's event. QR code 14 and arrow 2206 are shown to imply that a user may use an electronic device 12 to scan QR code 14, and scanning QR code 14 may allow the user(s) to retrieve access to augmented reality content 11, such as, but not limited to, augmented reality game 220. A user may retrieve access to augmented reality game 220 via methods other than scanning QR code 14, such as, but not limited to, being provided with a URL.

FIG. 23 illustrates a method 230 for playing an exemplative single-player martial arts augmented reality game 220 of the augmented reality content 11 component of the event entertainment system 10. Augmented reality game 220 may be a single-player game because one user (such as, but not limited to, user 221) may be needed to complete augmented reality game 220. However, augmented reality content 11 may be interacted with by one person (i.e. single-player) and/or by more than one person (i.e. multiplayer). Flowchart 230a describes the steps associated with method 230. Step 231 says that a user (such as, but not limited to user 221) may move his/her head and/or face side-to-side to punch opponent 2202 and/or move his/her head and/or face up and down to kick opponent 2202. The instructions for a user to move his/her head and/or face side-to-side to punch opponent 2202 and/or move his/her head and/or face up and down to kick opponent 2202 may relate to the movements a user may make as described (by the movements of users 90, 91, 92, 93, 94, and 95) in FIG. 9. The facial recognition component of augmented reality game 220 analyzes the facial movements of user 221 to determine whether user 221 moved his/her face and/or head side-to-side to simulate a punch on augmented reality game 220 or whether user 221 moved his/her face and/or head up and down to simulate a kick on augmented reality game 220. Based on the analysis of user 221's facial movements, augmented reality game 220 determines whether user 221 kicked and/or attempted to kick opponent 2202 or punched and/or attempted to punch opponent 2202. FIG. 23 assumes that a user (i.e. user 221) and character 221a may be used interchangeably because, as described in FIG. 8, a user's face and/or another part of the user's body may serve as the remote control of augmented reality game 220. Step 232 says that when user 221 punches and/or kicks opponent 2202, heart level 229 of opponent 2202 may drop by one increment. The number of increments of heart level 229 may be, but is not limited to, five increments, ten increments, and three increments. For example, in FIG. 22, heart level 229 of augmented reality game 220 may have five increments. Regarding step 232a, spark 2201 may show on a specific portion of opponent 2202's body (where opponent 2202 may have been kicked and/or punched by character 221a) to imply that character 221a kicked and/or punched opponent 2202. Step 233 says that if opponent 2202's heart level 229 drops the total amount of increments of heart level 229 within the allotted time duration of augmented reality game 220, then step 234 may follow, in which user 220 wins augmented reality game 220. For example, if heart level 229 in augmented reality game 220 has five increments and augmented reality game 220 may be played and/or interacted with by user 229 for fifteen seconds and character 221a deducted opponent 2202's heart level by a total of five increments when within fifteen seconds of augmented reality game 220 passing, then user 221 won augmented reality game 220. Step 235 says that if opponent 2202's heart level 220 does not drop the total amount of increments of heart level 229 within the allotted time duration of augmented reality game 220, then step 236 may follow, in which user 220 loses augmented reality game 220. For example, if heart level 229 of augmented reality game 220 has five increments and augmented reality game 220 may be played and/or interacted with by user 229 for fifteen seconds and character 221a deducted opponent 2202's heart level by a total of four increments within fifteen seconds of augmented reality game 220 passing, then user 221 lost augmented reality game 220.

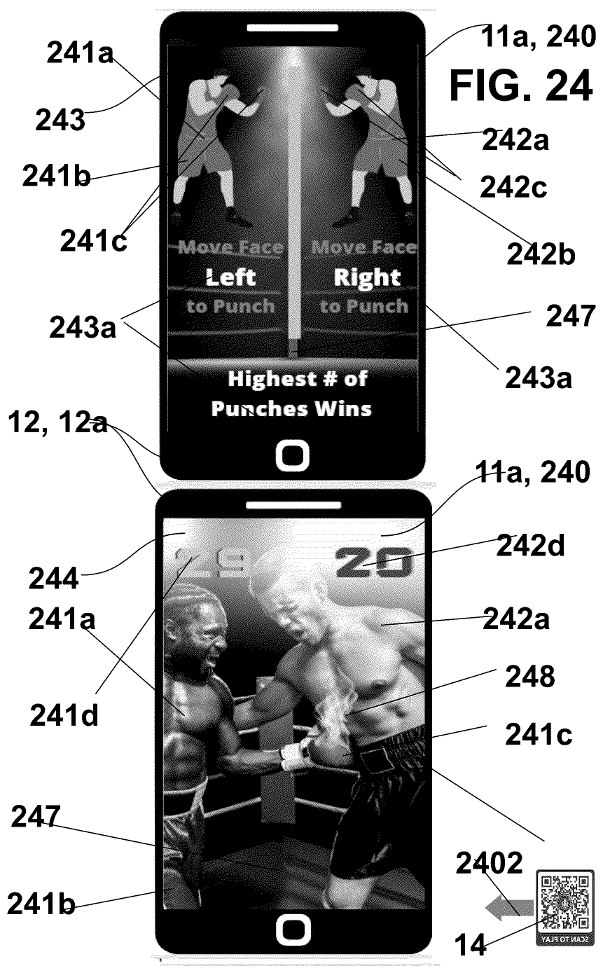

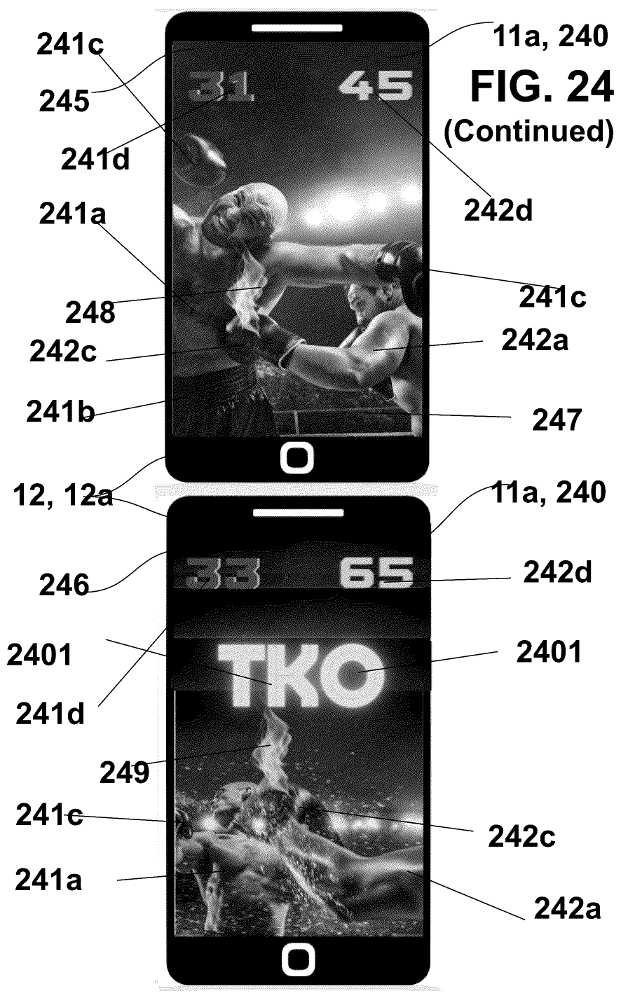

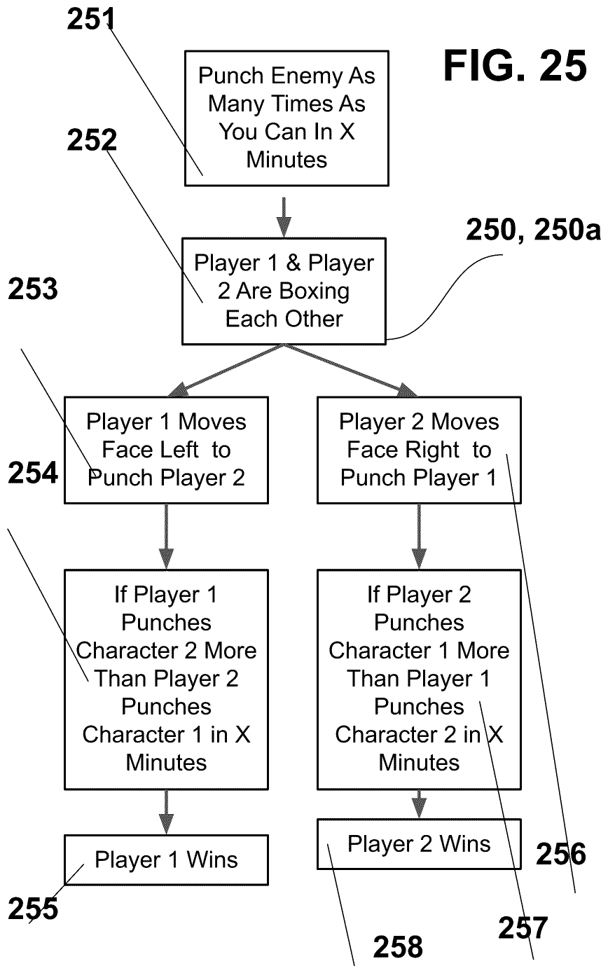

FIG. 24 illustrates an exemplative multiplayer boxing augmented reality game 11a which serves as the foundation for the augmented reality content 11 component of event entertainment system 10. FIG. 24 illustrates an example of augmented reality game 11a through the illustration of augmented reality game 240. There may be variety in the types of augmented reality content 11 of event entertainment system 10 that may or may not be limited to augmented reality game 240. The illustrations and descriptions in FIG. 24 are not meant to limit the scope of augmented reality game 240. Augmented reality game 240 may be an example of what a boxing game of event entertainment system 10 and/or a variation of a boxing game (such as, but not limited to, gaming methods, game appearance and applications) might be. Augmented reality game 240 may closely resemble a detail concerning a boxing game, a boxing game associated with event entertainment system 10, and/or a variation of a boxing game (such as, but not limited to gaming methods, the appearance of the game, and applications of the game). FIG. 24 shows that augmented reality content 11 may include and/or demonstrate boxing. Augmented reality game 240 may be a multiplayer game, in which more than one user, such as, but not limited to, two players, may interact with and/or play with augmented reality game 240. In order to better illustrate and describe augmented reality game 240, FIG. 24 implies that there are two users interacting with and/or playing with augmented reality game 240; and, the users may be user 241 and user 242. The purpose of playing augmented reality game 240 is for the two users, such as, but not limited to, user 241 and user 242, to have their character punch the opposing character more than the opposing character would punch their character within a specified time duration (in other words, however long the users' interaction and/or play with augmented reality game 240 lasts). In order to better understand augmented reality game 240, FIG. 24 illustrates that user 241 may control character 241a and user 242 may control character 242a. This means that while interacting with and/or playing with augmented reality game 240, the purpose for user 241 to play with and/or interact with augmented reality game 240 is for character 241a to punch character 242a more times than character 242a would punch character 241a during a fixed time duration of the game; and, the purpose for user 242 to play with and/or interact with augmented reality game 240 is for character 242a to punch character 241a more times than character 241a would punch character 242a during a fixed time duration of the game. User 241 and user 242 may control the movement(s) of character 241a and character 242a respectively as a remote control; and, the idea of user 241 and user 242 controlling the movement(s) of character 241a and character 242a respectively as a remote control may be further described in FIG. 8. A person, such as, but not limited to, a venue owner and/or game developer and/or programmer may choose a particular time duration for augmented reality game 240, such as choosing the users' interaction with augmented reality game 240 to last for durations, such as, but not limited to, twenty seconds and a minute. The movement(s) that user 241 may make to control the movement(s) of character 241a may include, but are not limited to, moving and/or tilting his/her head leftwards, which may be further described in FIG. 9 (such as, but not limited to, the facial expressions made by users 90 and 95). By moving and/or tilting his/her head leftwards, character 241a may punch character 242a in augmented reality game 240. FIG. 240 assumes that user 241 may be facing the left side of electronic device 12 when user 241 and user 242 are interacting and/or playing with augmented reality game 240. Because user 241 serves as the remote control to dictate the movement(s) of character 241a (as described in FIG. 8), user 241 and character 241a may be used interchangeably when describing augmented reality game 240. The movement(s) that user 242 may make to control the movement(s) of character 242a may include, but are not limited to, moving and/or tilting his/her head rightwards, which may be further described in FIG. 9 (such as, but not limited to, the facial expressions made by users 91 and 94). By moving and/or tilting his/her head rightwards, character 242a may punch character 241a in augmented reality game 240. FIG. 240 assumes that user 242 may be facing the right side of electronic device 12 when user 242 and user 241 are interacting and/or playing with augmented reality game 240. Because user 242 serves as the remote control to dictate the movement(s) of character 242a (as described in FIG. 8), user 242 and character 242a may be used interchangeably when describing augmented reality game 240. Image 243 may show the introduction of augmented reality game 240. In image 243, character 241a and character 242a may be shown as the introduction of augmented reality game 240. Character 241a and character 242a may represent renown boxing players (aka boxers), such as, but not limited to, renown boxers affiliated with the World Boxing Association (WBA), World Boxing Council (WBC), International Boxing Federation (IBF), World Boxing Organization (WBO), The Ring, and UFC. Character 241a and character 242a may also represent boxing teams, countries, etc. Venue 101 may represent a venue that hosts live boxing events, such as, but not limited to, events affiliated with the World Boxing Association (WBA), World Boxing Council (WBC), International Boxing Federation (IBF), World Boxing Organization (WBO), The Ring, and UFC. In FIG. 24, illustrations may show character 241a trying to defend himself/herself and/or punching character 242a and vice versa. In FIG. 24, parts and/or the whole of character 241a and/or character 242a may be shown in augmented reality game 240. Parts and/or portions of character 241a and character 242a are shown in images 243, 244, 245, and 246, such as, but not limited to, character 241a's boxing shorts 241b and boxing gloves 241c, and character 242a's boxing shorts 242b and boxing gloves 242c. In image 243, instructions 243a may show before user 241 and user 242 control the movement(s) of characters 241a and 242a respectively. Instructions 243a may say that user 241 may move and/or tilt his/her face and/or head leftwards so that character 241a may punch character 242a. Instructions 243a may also say that user 242 may move and/or tilt his/her face and/or head rightwards so that character 242a may punch character 241a. FIG. 2 assumes that user 241 may be facing the left side of electronic device 12 and that user 242 may be facing the right side of electronic device 12; but, the orientation(s) may differ depending on the preference(s) of user 241 and/or user 242. For the scenario in which FIG. 24 assumes that user 241 may be facing the left side of electronic device 12 and that user 242 may be facing the right side of electronic device 12, it may be practical for user 241 to move and/or tilt his/her face and/or head leftwards and for user 242 to move and/or tilt his/her face and/or head rightwards so that user 241 and user 242 do not physically clash their heads and/or faces onto each other (which may occur if user 241 and user 242 moved in opposite directions of what they may be instructed given the scenario of their orientation(s) with respect to electronic device 12). FIG. 24 assumes that for user 241 and user 242 to be able to interact with and/or play with augmented reality game 240, one of the users may need to hold electronic device 12; and, the aforementioned user may need to hold electronic device 12 with one hand; but, it may or may not matter which user (such as user 241 and/or user 242) may be holding electronic device 12 to interact with and/or play with augmented reality game 240; and, it may or may not matter how many hands a user may be using to hold electronic device 12 or if he/she is using any hands to hold electronic device 12. When a character punches the opposing character and vice versa, fire 248 may appear on the character's boxing glove(s) to dramatize the punch in augmented reality game 240. For example, if user 241 makes a facial movement that causes character 241a to punch character 242a, then fire 248 may appear on boxing gloves 241c while character 241a is punching character 242a. Another example is if user 242 makes a facial movement that causes character 242a to punch character 241a, then fire 248 may appear on boxing gloves 242c while character 242a is punching character 241a. More than one electronic device 12, such as two smartphones, may or may not be necessary for user 241 and user 242 to interact and/or play with augmented reality game 240. Given that augmented reality game 240 may be a multiplayer game, in order to interact and/or play with augmented reality game 240, one user, such as but not limited to user 241 or user 242, may hold electronic device 12; and, the aforementioned electronic device 12 may be given access to augmented reality game 240 so that user 241 and user 242 may interact and/or play with augmented reality game 240. Image 244 shows that user 241 may have made a facial movement that caused character 241a to punch character 242a. When user 241 makes a facial movement that may cause character 241a to punch character 242a, the screen of electronic device 12 may show character 241a punching character 242a with fire 248 on boxing glove(s) 241c. Image 244 also shows the current total scores that user 241 and user 242 may have during their interaction with augmented reality game 240. In image 244, the total score 241d user 241 has is 29 points, which is higher than user 242's total score 242d of 20 points. When user 241's current total score 241d is higher than user 242's current total score 242d, the screen of electronic device 12 may show character 241a punching character 242a with fire 248 on boxing gloves 241c. Image 245 shows that user 242 may have made a facial movement that caused character 242a to punch character 241a. When user 242 makes a facial movement that may cause character 242a to punch character 241a, the screen of electronic device 12 may show character 242a punching character 241a with fire 248 on boxing glove(s) 242c. Image 245 also shows the current total scores that user 241 and user 242 may have during their interaction with augmented reality game 240. In image 245, the total score 242d user 242 has is 45 points, which is higher than user 241's total score 241d of 31 points. When user 242's current total score 242d is higher than user 241's current total score 241d, the screen of electronic device 12 may show character 242a punching character 241a with fire 248 on boxing glove(s) 242c. Electronic device 12 and/or the screen of electronic device 12 during augmented reality game 240 may show character 241a punch character 242a and vice versa as many as and/or less than the number of times each respective user makes proper facial movement(s) to have their respective character punch the opposing character. For example, the number of times electronic device 12 shows character 241a punching character 242a may be equal to and/or less than the number of times user 241 made the proper facial movement(s) to have character 241a punch character 242a. Another example is that the number of times electronic device 12 shows character 242a punching character 241a may be equal to and/or less than the number of times user 242 made the proper facial movement(s) to have character 242a punch character 241a. The facial recognition component of augmented reality game 240 may judge whether any user made the proper facial movement(s) to have its character punch the opposing character. Image 246 shows that user 242 has won augmented reality game 240. Image 248 may show the abbreviation, TKO 2401, for a total knockout, when a user wins augmented reality game 240. Blue fire 249 may also be shown on the glove(s) of the character of the user who/that wins augmented reality game 240. For example, blue fire 249 is shown on boxing gloves 242c, which belongs to character 242a, to represent the knockout punch of augmented reality game 240. Image 246 shows that user 242's final total score 242d of 65 points is higher than user 241's final total score 241d of 33 points. FIG. 25 will cover more information about augmented reality game 240 including, but not limited to, the scenarios by which the movement(s) of user 241 may dictate how user 241's interaction with augmented reality game 240 unfolds. An example of an entity design that may be illustrated and/or simulated in augmented reality content 11, such as, but not limited to, augmented reality game 240, may be any entity design that may be associated (directly and/or indirectly) with venue 101, company, team, organization, individual, mascot, logo, icon, art, theme, community, uniform, and/or jersey. For instance, an example of an entity design that may be illustrated and/or simulated in augmented reality content 11 may be the following, which includes, but is not limited to, the clothes of a character, boxing gloves 241c, boxing gloves 242c, boxing shorts 241b of character 241a, and boxing shorts 242b of character 242a which may relate to a boxing player(s) associated with the home team affiliated with venue 101, and/or associated with the opposing team of the aforementioned home team; and, that entity design may relate to the player(s) and/or venue 101 and/or a sports organization. Other elements, drawings, animations, etc. of augmented reality game 240 may also include entity design. For example, boxing ring 247, boxing gloves 241c, boxing gloves 242c, boxing shorts 241b, and boxing shorts 242b may contain an entity design that may relate to venue 101, a sports team, a party and/or organization that may be affiliated with and/or controls the sports team, and/or a sponsoring company and/or advertiser of venue 101 and/or venue 101's event. QR code 14 and arrow 2402 are shown to imply that a user may use an electronic device 12 to scan QR code 14, and scanning QR code 14 may allow the user(s) to retrieve access to augmented reality content 11, such as, but not limited to, augmented reality game 240. A user may retrieve access to augmented reality game 240 via methods other than scanning QR code 14, such as, but not limited to, being provided with a URL.

FIG. 25 illustrates a method 250 for playing an exemplative multiplayer boxing augmented reality game 240 of the augmented reality content component 11 of event entertainment system 10. Augmented reality game 240 may be a multiplayer game because more than one user (such as, but not limited to, user 241 and user 242), preferably two users, may be needed to complete augmented reality game 240. However, augmented reality content 11 may be interacted with and/or played with by one person (i.e. single-player) and/or more than one person (i.e. multiplayer). Flowchart 250a describes the steps associated with method 250. Augmented reality game 240 may use facial recognition to be able to detect the movement(s) of parts of (and/or the whole of) users' 241 and 242 face moving and/or not moving leftwards and/or rightwards, such as a user's nose. Some augmented reality content 11, such as augmented reality game 240, may be able to detect a user's face and/or parts of a user's face regardless of whether the user is or is not wearing a face mask. Given the scenario (of FIG. 24) of user 241 facing the left side of electronic device 12 and user 242 facing the right side of electronic device 12, if the facial recognition component of augmented reality game 240 does not detect user 241 moving his/her head and/or face leftwards and/or does not detect user 242 moving his/her head and/or face rightwards, then user 241 and/or user 242 respectively may not be fulfilling augmented reality game 240's standards for their respective characters (character 241a and character 242a respectively) to punch the opposing character (character 242a and character 241a respectively). For instance, for the scenario in which user 241 faces the left side of electronic device 12 and user 242 faces the right side of electronic device 12, the scoring system of augmented reality game 240 determines whether user 241 and user 242 moved their faces leftwards and/or rightwards respectively in order to make their respective characters (241a and 242a) punch their respective opposing characters (242a and 241a). For example, if augmented reality game 240's facial recognition component recognizes and/or determines that user 241 moved his/her face leftwards while facing the left side of electronic device 12, then augmented reality game 240 may have character 241a punch character 242a and/or increase user 241's total score 241d in augmented reality game 240. Another example is that if augmented reality game 240's facial recognition component recognizes and/or determines that user 242 moved his/her face rightwards while facing the right side of electronic device 12, then augmented reality game 240 may have character 242a punch character 241a and/or increase user 242's total score 242d in augmented reality game 240. The scoring system of augmented reality game 240 may vary depending on the orientation of the users in correspondence with electronic device 12, such as, but not limited to, whether user 241 was facing the right or left side of electronic device 12 and whether user 242 was facing the right or left side of electronic device 12. Step 251 says that a user may play with and/or interact with augmented reality game 240 to have its respective character punch the respective character of the opposing user as many times as possible within a fixed time duration of augmented reality game 240. Step 252 clarifies that augmented reality game 240 may be a multiplayer game because it says that characters 241a and characters 242a are fighting each other. In order to better understand method 250, FIG. 25 assumes that character 241a represents “Player 1” and character 242a represents “Player 2” as mentioned in step 252. For the purpose of better understanding FIG. 25, “Player 1”, user 241, and character 241a may be used interchangeably; and, “Player 2”, user 242, and character 242a may be used interchangeably. Step 253 says that user 241 moves and/or tilts his/her face and/or head leftwards so that character 241a may punch character 242a. Step 253 assumes that user 241a is facing the left side of electronic device 12, and associates a user facing the left side of electronic device 12 as “Player 1” for the purpose of better understanding method 250. Step 254 says that if user 241's character 241a punches user 242's character 242a more times than character 242a punches character 241a within however long the users' interaction with augmented reality game 240 is, such as, but not limited to 15 seconds and 35 seconds, then step 255 may follow, in which user 241 wins augmented reality game 240. Step 256 says that user 242 moves and/or tilts his/her face and/or head rightwards so that character 242a may punch character 241a. Step 256 assumes that user 242a is facing the right side of electronic device 12, and associates a user facing the right side of electronic device 12 as “Player 2” for the purpose of better understanding method 250. Step 257 says that if user 242's character 242a punches user 241's character 241a more times than character 241a punches user 242's character 242a within however long the users' interaction with augmented reality game 240 is, such as, but not limited to 15 seconds and 35 seconds, then step 258 may follow, in which user 242 wins augmented reality game 240. The total scores 241d and 242d that users 241 and 242 may receive respectively, during their interaction and/or play with augmented reality game 240 may vary depending on the number of facial movements the facial recognition component of augmented reality game 240 may recognize of both of the users.

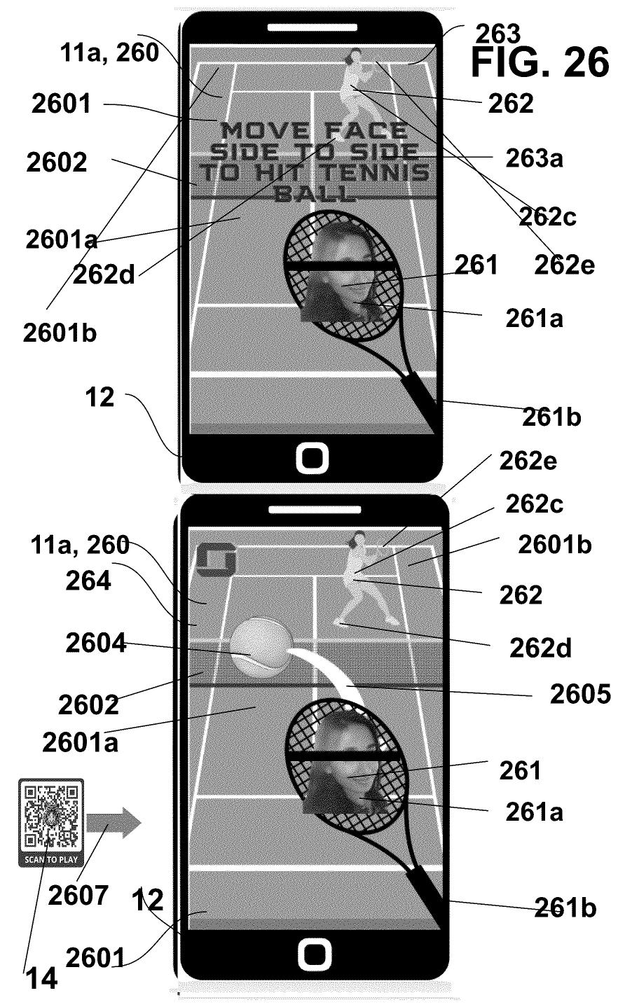

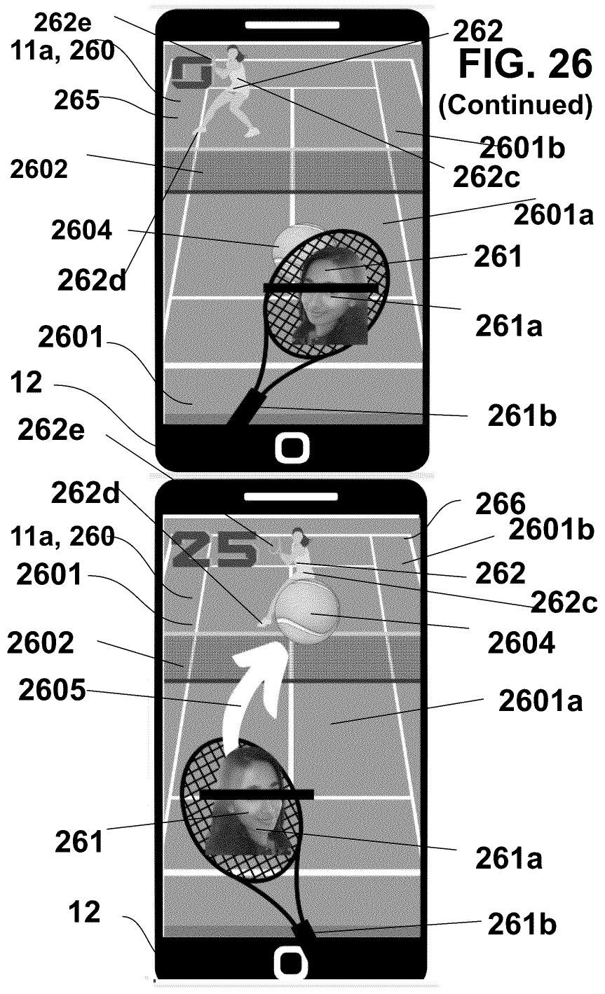

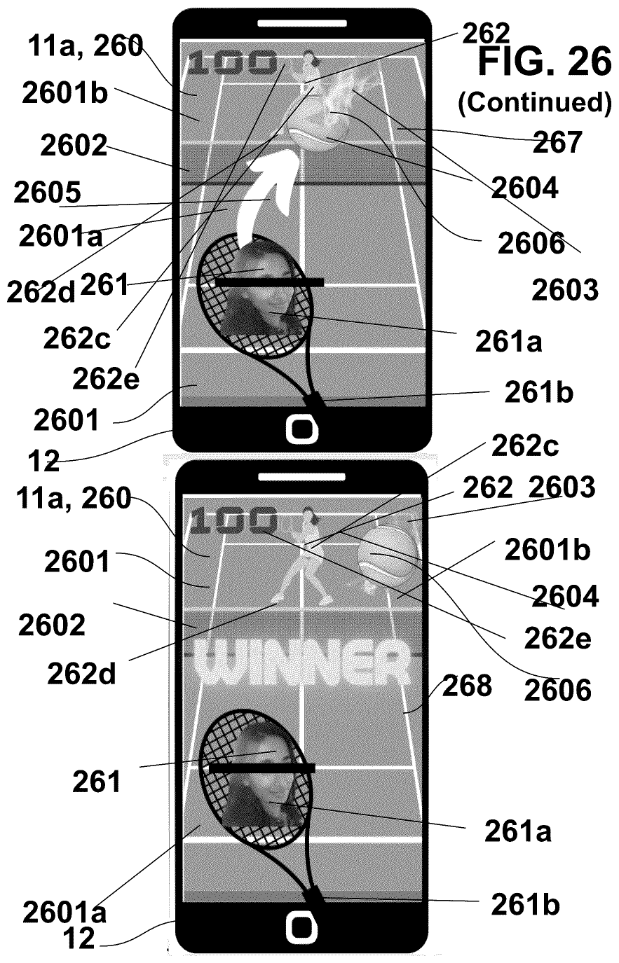

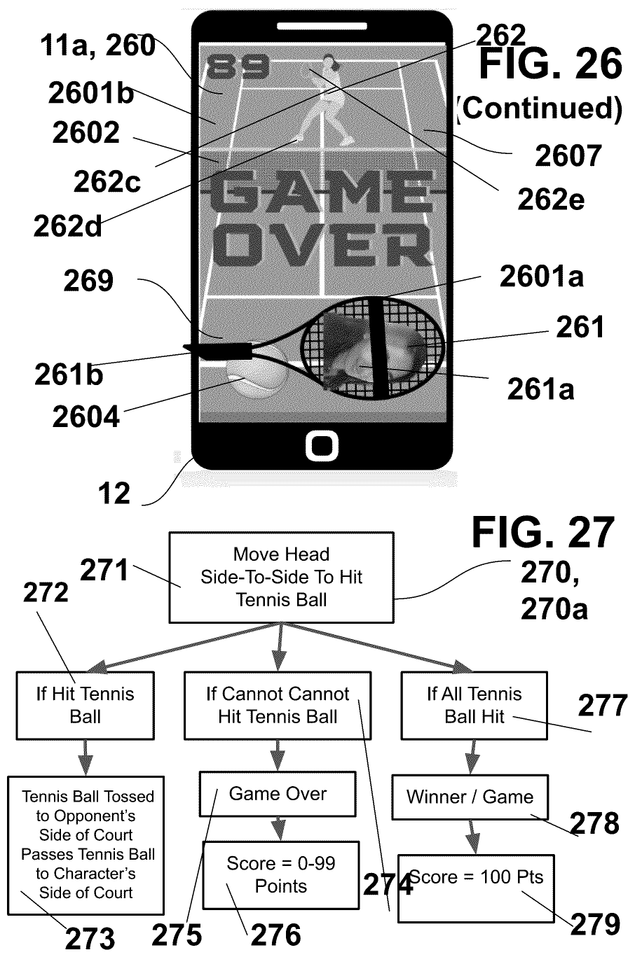

FIG. 26 illustrates an exemplative single-player tennis augmented reality game 11a which serves as the foundation for the augmented reality content 11 component of event entertainment system 10. FIG. 26 illustrates an example of augmented reality game 11a through the illustration of augmented reality game 260. There may be a variety in the types of augmented reality content 11 that may be included in event entertainment system 10. The augmented reality content 11 of event entertainment system 10 may involve augmented reality game 260. The illustrations and descriptions in FIG. 26 are not meant to limit the scope of augmented reality game 260. Augmented reality game 260 may be an example of what a tennis game of event entertainment system 10 and/or a variation of a tennis game (such as, but not limited to, gaming methods, game appearance, and applications) might be. Augmented reality game 260 may closely resemble a detail concerning a tennis game, a tennis game associated with event entertainment system 10, and/or a variation of a tennis game (such as, but not limited to, gaming methods, the appearance of the game, and applications of the game). FIG. 26 shows that augmented reality content 11 may include and/or demonstrate tennis. The purpose of augmented reality game 260 is for user 261 to have character 261a hit tennis ball 2604 every time tennis ball 2604 is hit and/or thrown and/or passed to character 261a from opponent 262 during the time frame and/or duration of augmented reality game 260. There may be a time frame and/or duration of augmented reality game 260, which may last in time periods, such as, but not limited to, 15 seconds and 20 seconds. The duration of user 261's interaction with augmented reality game 260 also and/or either lasts until character 261a hits tennis ball 2604 a fixed number of times, such as, but not limited to, 10 times, 6 times, etc; and, if character 261 successfully hits tennis ball 2604 the total fixed number of times during augmented reality game 260, then user 261 may win augmented reality game 260. To have character 261a hit tennis ball 2604, user 261 may need to move and/or tilt his/her face and/or head leftwards and/or rightwards so that tennis racket 261b hits tennis ball 2604. User 261's face may need to move leftwards and/or rightwards to the extent that his/her face may be simulated as hitting tennis ball 2604 in augmented reality game 260. FIG. 26 shows that user 261's face may be illustrated and/or embedded on tennis racket 261b; and, these illustrations may make augmented reality game 260 more personalized and/or have instructions that may be easier for user 261 to follow. When looking at electronic device 12 from up to down, character 261a's portion tennis court 2601 may be illustrated as below net 2602; and, opponent 262's portion of tennis court 2601 may be illustrated as above net 2602. If tennis ball 2604 is hit and/or thrown by opponent 262 and tennis ball 2604 hits the ground of character 261's portion of court 2601, then user 261 may lose augmented reality game 260. FIG. 23 assumes that a user (i.e. user 261) and character 261a may be used interchangeably because, as described in FIG. 8, a user's face and/or another part of the user's body may serve as the remote control of augmented reality game 260. The head and/or facial movement(s) user 261 may use to control the movement(s) of character 261a may be described in FIG. 9 (such as, but not limited to, by users 90, 91, 94, and 95). Instructions 263a say that a user may move his/her face side to side to hit tennis ball 2604. Instructions 263a may be simplified and/or written differently from what is shown in image 263 so that user 261a may better understand how to play with and/or interact with augmented reality game 260. Image 263 may show character 261a and opponent 262. Opponent 262 may represent a renown and/or famous tennis player that may be affiliated with a renown tennis tournament and/or championship organization, such as, but not limited to, Wimbledon, US Open, Australian Open, French Open, The Summer Games, BNP Paribas Open, ATP Finals, WTA Final, and Laver Cup. Throughout augmented reality game 260, character 261a and/or parts of character 261a's body may be shown during user 261's interaction and/or play with augmented reality game 260. In FIG. 26, character 261's tennis racket 261b may imply that although character 261a and/or parts of character 261's body may be shown in augmented reality game 260, user 261 may still control the movement(s) of character 261a by controlling the movement(s) of tennis racket 261b. Image 264 shows that opponent 262 is in the process of and/or has hit tennis ball 2604. In augmented reality game 260, opponent 262 may be the server of the game, which may imply that opponent 262 may be the first player (amongst opponent 262 and character 261a) to hit tennis ball 2604. FIG. 26 assumes that opponent 262 may be the first player in augmented reality game 260 to hit tennis ball 2604; but, depending on the preference(s) of a venue operator(s), a person(s), creator(s) of the augmented reality game 260, and/or programmer(s) and/or developer(s) of augmented reality game 260, character 261a may be the first player to hit tennis ball 264 in augmented reality game 260. For the purpose of understanding how augmented reality game 260 works, imaginary arrows 2605 are illustrated in images throughout FIG. 26. For example, in image 264 imaginary arrow 2605 shows that tennis ball 2604 may have been hit in the direction towards character 261a's portion of tennis court 2601. Character 261a's portion of tennis court 2601 may be known as character's portion 2601a; and, opponent 262's portion of tennis court 2601 may be known as opponent's portion 2601b. In image 266, with imaginary arrow 2605 pointing towards the direction of character's portion 2601a, it may be implied that user 261 made a facial movement(s) to have tennis racket 261b hit tennis ball 2604 back towards opponent's portion 2601b. The facial recognition component of augmented reality game 260 may determine if user 261 moved and/or tilted his/her head and/or face correctly in order to simulate character 261a and/or tennis racket 261b hitting tennis ball 2604 in augmented reality game 260. Image 265 shows that user 261 may be in the process of hitting tennis ball 2604. Because tennis racket 261b is seen on the right side of the screen of electronic device 12, this may imply that user 261 moved his/her head and/or face rightwards to have character 261a and/or tennis racket 261b hit tennis ball 2604 back towards opponent's portion 2601b. Image 266 shows another instance of user 261 hitting (and/or having hit) tennis ball 2604; and, this may be represented by imaginary arrow 2605 pointing towards the direction of opponent's portion 2601b. Because tennis racket 261b is seen on the left side of the screen of electronic device 12, this may imply that user 261 moved his/her head and/or face leftwards to have character 261a and/or tennis racket 261b hit tennis ball 2604 back towards opponent's portion 2601b. The total score of “100” on the screen of electronic device 12, in image 267, may imply that user 261 won augmented reality game 260. The total score of “100” may be accompanied by the last hit 2606. Last hit 2606 may be the last hit (of tennis ball 2604) out of the total number of hits that user 261 may make within the duration of his/her interaction and/or play with augmented reality game 260. For example, if tennis racket 261b successfully hits tennis ball 2604 10 times out of the 10 times allowed during one's interaction and/or play with augmented reality game 260, then last hit 2606 may refer to the 10th successful hit of tennis ball 2604. Another example is if tennis racket 261b successfully hits tennis ball 2604 6 times out of the 6 times allowed during one's interaction and/or play with augmented reality game 260, then last hit 2606 may refer to the 6th successful hit of tennis ball 2604. Last hit 2606 may be accompanied with fire 2603 on tennis ball 2604 to imply that last hit 2606 has occurred and/or is occurring in augmented reality game 260. Imaginary arrow 2605 in image 267 implies that tennis ball 2604 is being hit in the direction towards opponent's portion 2601b. Augmented reality game 260 assumes that opponent 262 may successfully hit tennis ball 2604 that character 261a hits in the direction towards opponent's portion 2601b during user 261's interaction and/or play with augmented reality game 260 except for during last hit 2606 because the occurrence of last hit 2606 implies that user 261 won augmented reality game 260. During the occurrence of last hit 2606, opponent 262 may be illustrated as failing to hit tennis ball 2604 that tennis racket 261b hits in the direction towards opponent's portion 2601b. Image 268 shows that user 261 has won augmented reality game 260; and, this may be accompanied with the word, “Winner”, being shown on the screen of electronic device 12. Fire 2603 may also be accompanied with last hit 2606 on tennis ball 2604. Image 269 shows a scenario of user 261 losing augmented reality game 260. If tennis racket 261b misses the tennis ball 2604 that opponent 262 hits towards character's portion 2601a, then user 261 may lose augmented reality game 260. Tennis racket 261b missing the chance to hit tennis ball 2604 back to opponent's portion 2601b may occur if user 261 did not make the correct facial movement(s), and/or if user 261 did not make the correct facial movement(s) at the correct time, and/or if the facial recognition component of augmented reality game 260 did not detect the correct movement necessary for user 261 to have tennis racket 261b hit tennis ball 2604. The scenario of user 261 losing augmented reality game 260 may be accompanied with the words, “Game Over” on the screen of electronic device 12. The scenario of user 261 losing augmented reality game 260 may be accompanied with tennis racket 261b being illustrated in an orientation that implies that character 261a missed hitting tennis ball 2604. Tennis ball 2604 may also be shown on the ground of character's portion 2601a to imply that character 261a missed hitting tennis ball 2604 from opponent 262. Tennis ball 2604 may also be shown in a location and/or portion of character's portion 2601a that is away from tennis racket 2601b. For example, for the scenario of user 261 losing the augmented reality game 260 shown in image 269, the head and/or oval frame of racket 261b is shown on the right side of the screen of electronic device 12 whereas tennis ball 2604 is shown on the left side of the screen of electronic device 12. This may imply that user 261 (and/or the facial recognition component of augmented reality game 260 didn't detect that user 261) moved and/or titled his/her face and/or head leftwards just in time for racket 261b to be simulated as having hit tennis ball 2604 in time. User 261, character 261a, and tennis racket 261b may be used interchangeably to imply that user 261 serves as the remote control, as described on FIG. 8, of character 261a and tennis racket 261b. The total score user 261 receives throughout his/her interaction and/or play with augmented reality game 260, such as, but not limited to, “0” on image 264, “0” on image 265, “25” on image 266, “100” on image 267, “100” on image 268, and “89” on image 269, may be shown depending on the preference(s) of a person, such as, but not limited to, a venue operator(s), programmer(s) of augmented reality game 260, and creator(s) of augmented reality game 260. FIG. 27 will cover more information about augmented reality game 260 including, but not limited to, the scenarios by which the movement(s) of user 261 may dictate how user 261's interaction with augmented reality game 260 unfolds. An example of an entity that may be illustrated and/or simulated in augmented reality content 11, such as, but not limited to, augmented reality game 260, may be an entity design that may be associated (directly and/or indirectly) with venue 101, company, team, organization, individual, mascot, logo, icon, art, theme, community, uniform, and/or jersey. For instance, an example of an entity design that may be illustrated and/or simulated in augmented reality content 11 may be the following, which includes, but is not limited to jersey 262c, shoe(s) 262d, tennis racket 261b, and/or tennis racket 262e which relate to a tennis player associated with the home team affiliated with venue 101, and/or associated with the opposing team of the aforementioned home team, and/or any team a player represents during a tennis match at venue 101; and, that entity design may relate to the player(s) and/or company and/or venue 101. Other elements, drawings, animations, etc. of augmented reality game 260 may also include entity design. For example, tennis court 2601, jersey 262c, shoe(s) 262d, tennis racket 261b, and/or tennis racket 262e may contain an entity design that relates to venue 101, a sports team, a party and/or organization that may be affiliated with and/or controls the sports team, and/or a sponsoring company and/or advertiser of venue 101 and/or venue 101's event. QR code 14 and arrow 2607 are shown to imply that a user may use an electronic device 12 to scan QR code 14, and scanning QR code 14 may allow the user(s) to retrieve access to augmented reality content 11, such as, but not limited to, augmented reality game 260. A user may retrieve access to augmented reality game 260 via methods other than scanning QR code 14, such as, but not limited to, being provided with a URL.

FIG. 27 illustrates a method 270 for playing an exemplative single-player tennis augmented reality game 260 of the augmented reality content component 11 of event entertainment system 10. Augmented reality game 260 may be a single-player game because one user (such as, but not limited to, user 261) may be needed to complete augmented reality game 260. However, augmented reality content 11 may be able to be interacted with by one person (i.e. single-player) and/or more than one person (i.e. multiplayer). Flowchart 270a describes the steps associated with method 270. Step 271 says that a user (such as, but not limited to, user 261) may move his/her head and/or face side-to-side to hit tennis ball 2604. The instructions for a user to move his/her head and/or face side-to-side to hit tennis ball 2604 may relate to the movements a user may make as described (with the movements of users 90, 91, 94, and 95) in FIG. 9. The facial recognition component of augmented reality game 220 may analyze the facial movement(s) of user 261 to determine whether user 261 moved his/her face and/or head side-to-side to simulate tennis racket 261b hitting tennis ball 2604 on augmented reality game 260. Based on the analysis of user 261's facial movements, augmented reality game 260 may determine whether user 261 hit and/or attempted to hit tennis ball 2604. FIG. 27 assumes that a user (i.e. user 261), character 261a, and tennis racket 261b may be used interchangeably because, as described in FIG. 8, a user's face and/or another part of the user's body may serve as the remote control of augmented reality game 260. Step 272 says that if the facial recognition component of augmented reality game 260 detects user 261 making the correct facial movement(s) necessary for tennis racket 261b to hit tennis ball 2604, then step 273 may follow, in which tennis racket 261b may hit tennis ball 2604; and, after tennis racket 261b may be simulated to hit tennis ball 2604 in augmented reality game 260, tennis ball 2604 may be animated as being tossed and/or transferred to opponent 262's portion of tennis court 2601 (aka opponent's portion 2601b). Then, after opponent 262 may be illustrated and/or animated as using its tennis racket 262b to hit tennis ball 2604, tennis ball 2604 may be animated as being tossed and/or transferred to character 261a's portion of tennis court 2601 (aka character's portion 2601a). This may lead to user 262 having to make the correct facial movement(s) (which includes moving and/or tilting his/her head and/or face leftwards and/or rightwards (depending on where in the screen of electronic device 12 tennis ball 2604 is being tossed and/or transferred to)) to hit tennis ball 2604. Step 274 says that if the facial recognition component of augmented reality game 260 does not detect user 261 making the correct facial movement(s) necessary for tennis racket 261b to hit tennis ball 2604, then step 275 may follow, in which user 261 loses augmented reality game 260 (aka the game is over for user 261). Then, as described in step 276, user 261 may receive a total score within the range of 0 to 99 points. Step 277 says that, for the opportunities and/or instances (i.e. within a time limit (i.e. augmented reality game 260 lasting for 10 seconds, 20 seconds, etc.)) and/or within a fixed number of hits allowed (such as, but not limited to, 10 hits of tennis ball 2604, 6 hits of tennis ball 2604, etc.) that user 261 may be given to make facial movement(s) to hit tennis ball 2604 in augmented reality game 260, if the facial recognition component of augmented reality game 260 detects user 261 making the correct facial movement(s) necessary for tennis racket 261b to hit tennis ball 2604 for these given instances, then step 278 may follow in which user 261 may win augmented reality game 260. Then, as described in step 279, user 261 may receive a total score of 100 points.

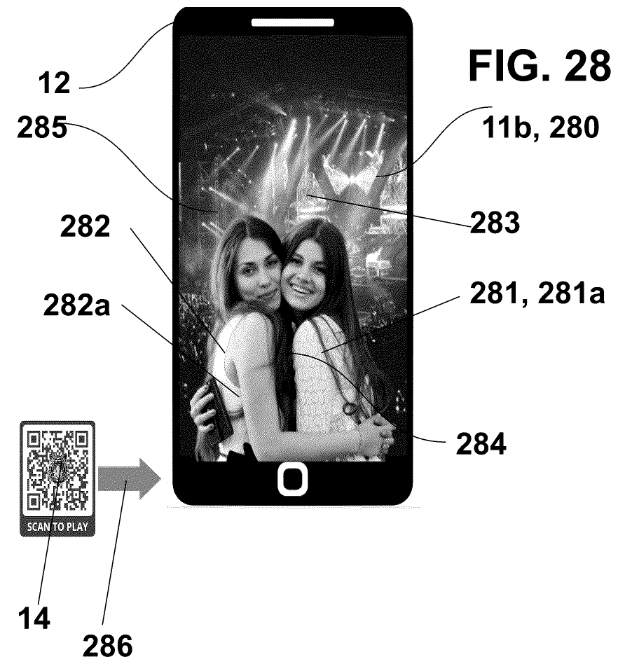

FIG. 28 illustrates an exemplative augmented reality animations and/or illustrations 11b which serves as the foundation for the augmented reality content 11 component of event entertainment system 10. FIG. 28 illustrates an example of augmented reality game 11a through the illustration of augmented reality animation 280. There may be a variety in the types of augmented reality content 11 that may be included in event entertainment system 10. The augmented reality content 11 of event entertainment system 10 may involve augmented reality animation 280. The illustrations and descriptions in FIG. 28 are not meant to limit the scope of augmented reality animation 280. Augmented reality animation 280 may be an example of what interactive concert animations of event entertainment system 10 and/or a variation of interactive concert animations (such as, but not limited to, animation methods, animation appearances, interactive methods, interactive appearances, and applications) might be. Augmented reality animation 280 may closely resemble a detail concerning a concert, a concert associated with event entertainment system 10, and/or a variation of a concert (such as, but not limited to, animations methods, animation appearances, interactive methods, interactive appearances, and applications). FIG. 28 shows that augmented reality content 11 may include and/or demonstrate a concert and/or a person (such as, but not limited to, an artist, singer, and pop star) affiliated with a concert. The purpose for a user (such as, but not limited to user 281) to play with and/or interact with augmented reality animation 280 may be for user 281 to potentially feel that he/she may be interacting with an individual who may be affiliated with the live event (such as, but not limited to, a concert) that venue 101 may be hosting. The aforementioned individual, may be any individual, such as, but not limited to, an individual performing at venue 101's live event, a singer, a dancer, a celebrity, a narrator, a host, a judge of a contest, a performer, an audience member, a politician, a businessperson, a talented individual, etc. The aforementioned individual may be represented by performer 282 in augmented reality animation 280. The concept of a renown individual being represented by performer 282 in augmented reality animation 280 may be similar to how renown athletes and individuals may be represented by characters in augmented reality content 11, such as, but not limited to in augmented reality games 11a and in augmented reality animations and/or illustrations 11b. The types of concerts that may be illustrated and/or animated in augmented reality animation 280 may include, but are not limited to, any form of a gathering of people, pop music concerts, alternative music concerts, country music concerts, classical music concerts, EDM and/or Rave concerts, rap music concerts, oldies music concerts, festivals, etc. FIG. 28 shows performer 282 hugging, in close contact with, and/or mingling with user 281. The act of performer 282 hugging, in close contact with, and/or mingling with user 281 may be described as hug 284. Depending on the animations and/or illustrations presented in augmented reality animation 280, user 281 may be represented as character 281a in augmented reality animation 280. Hug 284 shows that performer 282 may be simulated as giving user 281 a hug; but, performer 282 may be animated as doing any other action with and/or without user 281, such as, but not limited to, dancing with and/or without user 281, playing with and/or without user 281, talking to with and/or without user 281, and mingling with and/or without user 281. Augmented reality animation 280 may be broadcasted for users (such as, but not limited to user 281) to play with and/or interact with during a live event that may be hosted by venue 101, such as a concert that may feature the individuals and/or performers who may be represented by performer 282 and/or other possible characters in augmented reality animation 280. Background 285 shown in augmented reality animation 280 may represent the live background of venue 101 that user 281 may be experiencing in real life during the event that venue 101 may be hosting. Background 285 may also represent any background, surrounding, and/or environment that user 281 may be able to capture with the camera of his/her electronic device 12. Performer 282 and user 281 may make body and/or facial movements that may include movements described in FIG. 9 and movements beyond what is described in FIG. 9. In the augmented reality game 11a described FIG. 9, there may be a limited and/or fixed time duration for how long user 281 may be able to interact with and/or play with augmented reality animation 280. For any augmented reality content 11, whatever the cameras (the front camera, the rear camera, and/or side camera) of electronic device 12 may capture may be embedded, illustrated, animated, and/or a part of augmented reality content 11, such as, but not limited to augmented reality games 11a and augmented reality animations and/or illustrations 11b. An example of an entity design that may be illustrated and/or simulated in augmented reality content 11, such as, but not limited to, augmented reality animation 280, may be an entity design that may be associated (directly and/or indirectly) with venue 101, company, team, organization, individual, mascot, logo, icon, art, theme, community, uniform, jersey, etc. For instance, an example of an entity design that may be illustrated and/or simulated in augmented reality content 11 may be the following, which includes, but is not limited to, stage 283, background 285, and the clothes 282a of (and/or affiliated with) performer 282 (that may be worn (and/or simulated to be worn) by user 281 and/or performer 282), which may relate to an individual associated with the concert and/or live event affiliated with venue 101 and/or any organization and/or company a performer may represent during a concert and/or live event at venue 101; and, that entity design may relate to the performer(s) and/or a company and/or venue 101. Other elements, drawings, animations, etc. of augmented reality animation 280 may also include entity design. For example, stage 283, background 285, and the clothes of (and/or affiliated with) performer 282 may contain entity design that may relate to venue 101, a performer(s), a party and/or organization that may be affiliated with and/or controls the performer(s), and/or a sponsoring company and/or advertiser of venue 101 and/or venue 101's event. QR code 14 and arrow 286 are shown to imply that a user may use an electronic device 12 to scan QR code 14, and scanning QR code 14 may allow the user(s) to retrieve access to augmented reality content 11, such as, but not limited to, augmented reality instructions and/or animations 280. A user may retrieve access to augmented reality illustrations and/or animations 280 via methods other than scanning QR code 14, such as, but not limited to, being provided with a URL.

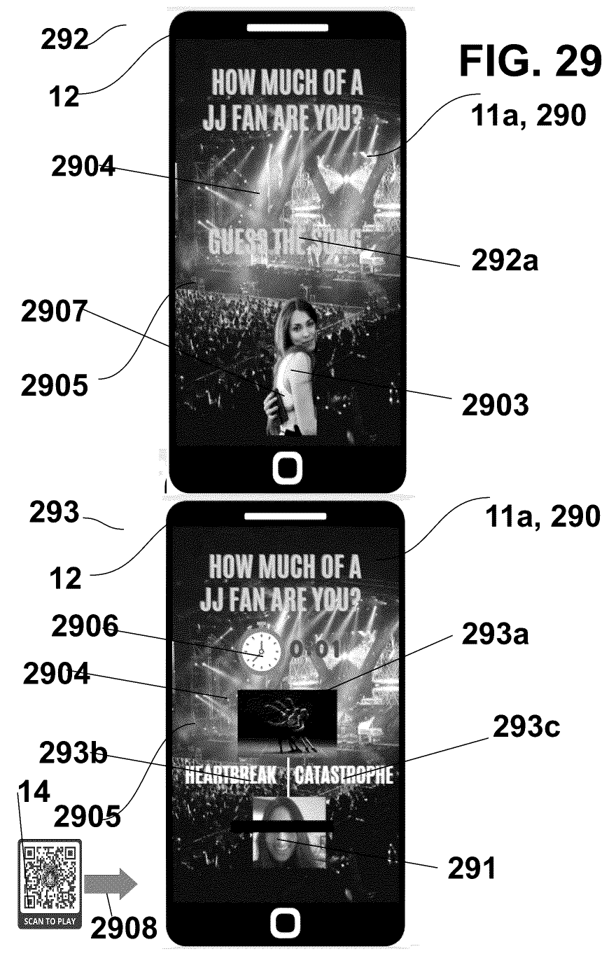

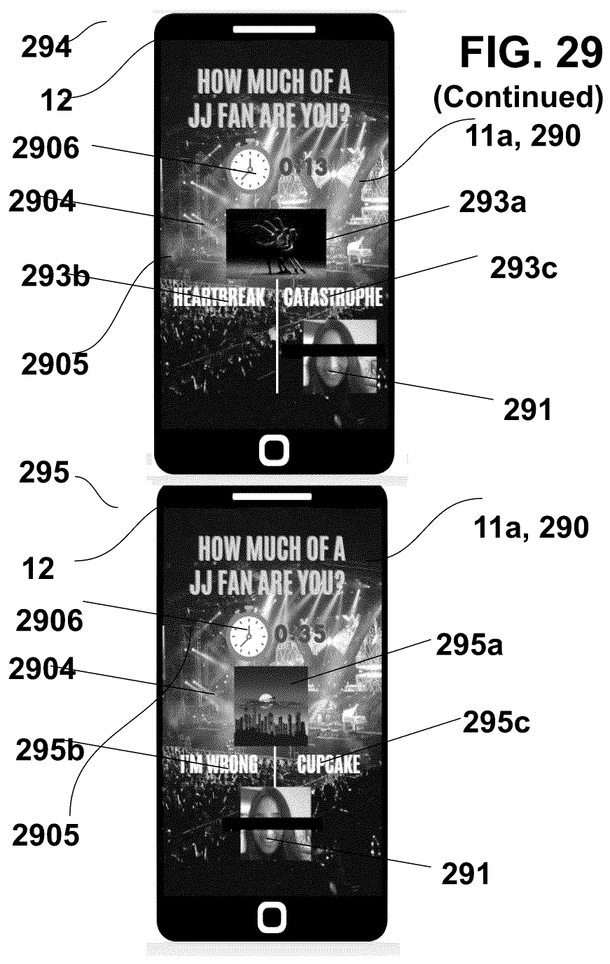

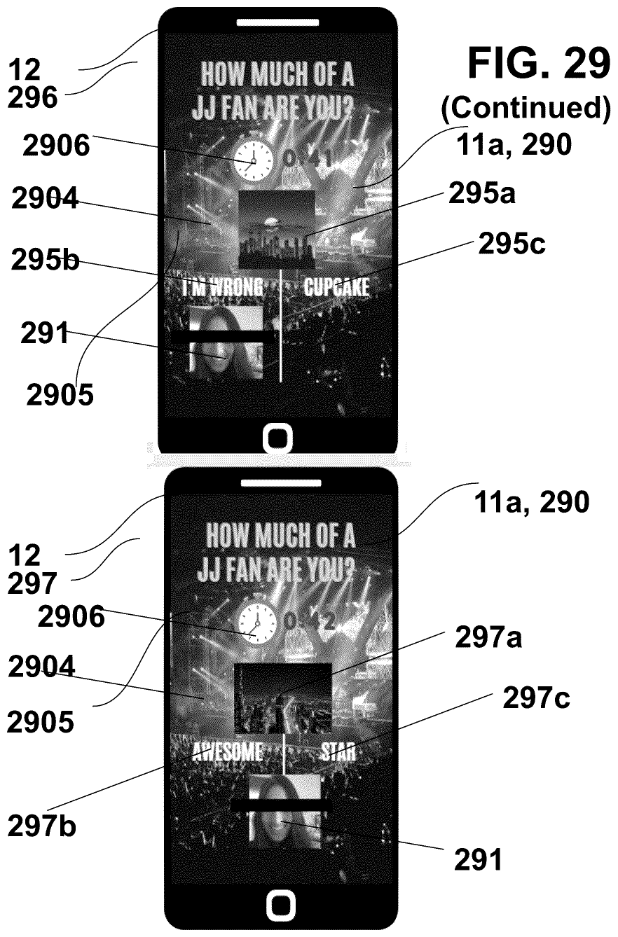

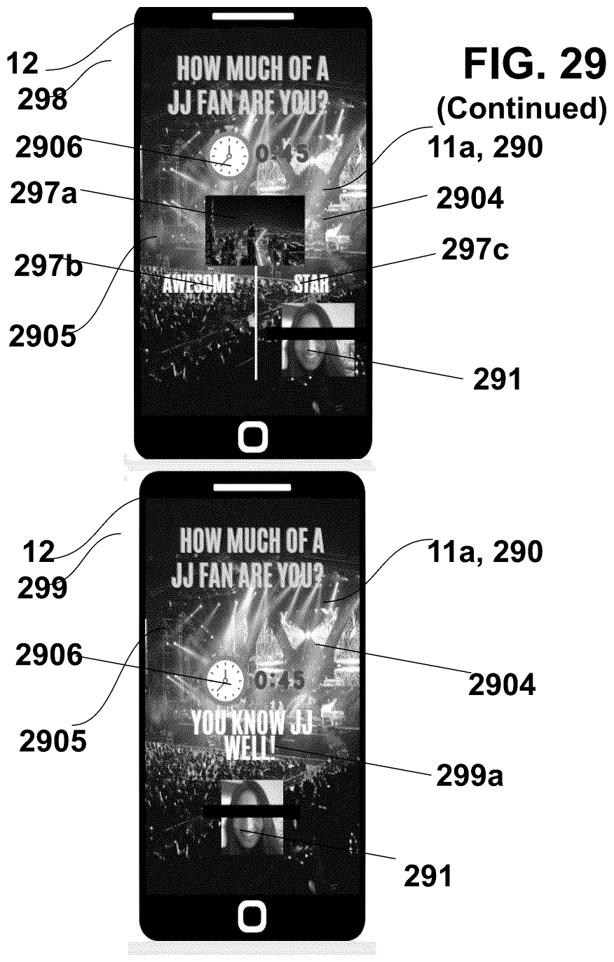

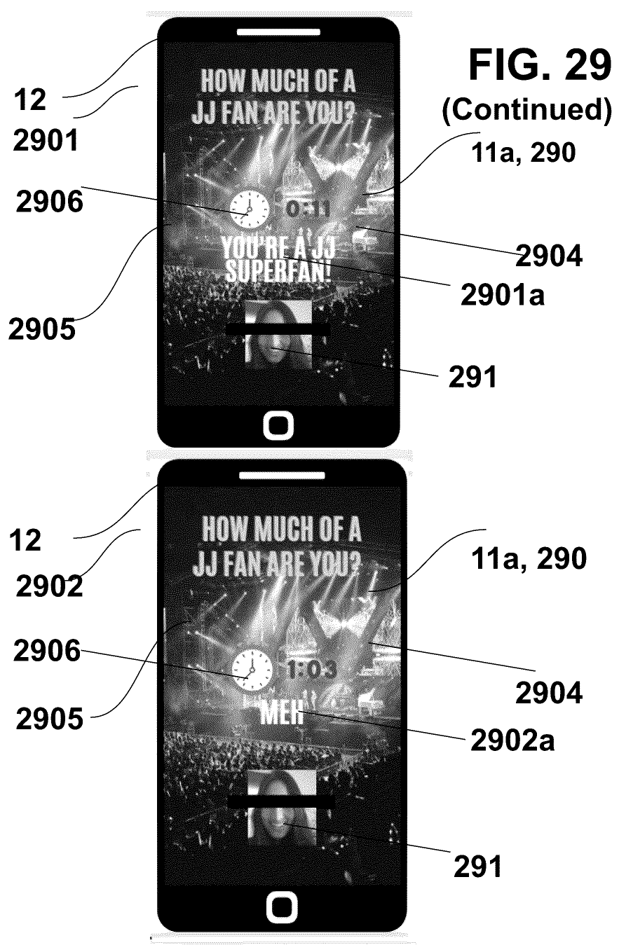

FIG. 29 illustrates an exemplative augmented reality game 11a which serves as the foundation for the augmented reality content component 11 of the event entertainment system 10. FIG. 29 illustrates an example of augmented reality game 11a through the illustration of augmented reality game 290. There may be a variety in the types of augmented reality content 11 of event entertainment system 10. The augmented reality content 11 of event entertainment system 10 may involve augmented reality game 290. The illustrations and descriptions in FIG. 29 are not meant to limit the scope of augmented reality game 290. Augmented reality game 290 may be an example of what interactive concert animations of event entertainment system 10 and/or a variation of interactive concert animations (such as, but not limited to, animation methods, animation appearances, interactive methods, interactive appearances, and applications) might be. Augmented reality game 290 may closely resemble a detail concerning a concert, a concert associated with event entertainment system 10, and/or a variation of a concert (such as, but not limited to, animations, methods, animation appearances, interactive methods, interactive appearances, and applications). FIG. 29 shows that augmented reality content 11 may include and/or demonstrate a concert and/or a person (such as, but not limited to, an artist, singer, and pop star) affiliated with a concert. The types of concerts that may be animated, illustrated, implied, and/or referred to in augmented reality animation 290 may include, but are not limited to, any form of a gathering of people, pop music concerts, alternative music concerts, country music concerts, classical music concerts, EDM and/or Rave concerts, rap music concerts, oldies music concerts, festivals, etc. Augmented reality game 290 may be affiliated with a venue 101 that may represent a concert and/or concert venue, such as, but not limited to, a park, arena, theater, and/or concert hall. The purpose of playing and/or interacting with augmented reality game 290 is for a user (such as, but not limited to user 291) to figure out the song of a music video associated with performer 2903 as soon as possible. Performer 2903 may be and/or represent any individual, such as, but not limited to, an individual performing at venue 101's live event, a singer, a dancer, a celebrity, a narrator, a host, a judge of a contest, a performer, an audience member, a politician, a businessperson, a talented individual, etc. Performer 2903 may be illustrated in augmented reality game 290. Augmented reality game 290 may show pictures from performer 2903's music video(s); and, user 291 may try to determine the song(s) associated with the picture of the music video(s) presented. User 291 may determine the aforementioned song by moving and/or tilting his/her face (leftwards and/or rightwards) towards the name of the song that may be presented on the screen of electronic device 12 during his/her interaction and/or play with augmented reality game 290. Augmented reality game 290 may instruct user 291 to guess more than one song for the music videos presented, such as guessing three songs, five songs, ten songs, etc, throughout the duration of augmented reality game 290. For example, in FIG. 29, augmented reality game 290 allows user 291 to guess three songs throughout the duration of augmented reality game 290. Augmented reality game 290 may imply that the sooner a user determines, guesses, and/or chooses the songs for the pictures of the music videos presented, the more of a quality fan the user may be of performer 2903. Timer 2906 shows how long user 291 may take to determine the songs for the pictures of the music videos presented as he/she progresses with his/her interaction with augmented reality game 290. Timer 2906 may start when user 291 starts playing with augmented reality game 290 (which may involve user 291 pressing and/or touching a button on electronic device 12 to start augmented reality game 290). Timer 2906 ends when user 291 correctly determines the songs for the pictures of the music videos presented. The ending of timer 2906 may not imply that user 291's interaction and/or play with augmented reality game 290 may be over. Image 292 shows an illustration of what user 291 may encounter before he/she starts augmented reality game 290. Augmented reality game 290 may be titled, “How Much of a JJ Fan Are You?”. “JJ” refers to the name of an example of performer 2903; but, augmented reality game 290 may be tweaked to involve another individual under the category of what and/or who performer 2903 may be (who may not be “JJ”). “JJ” may be an example of the individual that performer 2903 may represent in augmented reality game 290. Augmented reality game 290 may imply that user 291 may be a fan of performer 2903 and that user 291 may be attending a live concert in venue 101 that may involve performer 2903 as a performer; but, user 291 may not be a fan of performer 2903 or be attending a live event in venue 101 that may involve performer 2903 as a performer. For example, augmented reality game 290 implies that user 291 may be a fan of “JJ” and that user 291 may be attending a live concert in venue 101 that may involve “JJ” as a performer; but, user 291 may not be a fan of “JJ” or be attending a live event in venue 101 that may involve “JJ” as a performer. Image 292 also shows instructions 292a, which says, “Guess the song”. Instructions 292a may be simplified and/or written differently from what is shown in image 292 so that user 291 may better understand how to play with and/or interact with augmented reality game 290. Image 292 may also show an illustration and/or animation of performer 2903 to imply that the song(s) user 291 may have to guess may be associated with performer 2903. Image 293 demonstrates an example of the first song user 291 may need to determine in augmented reality game 290. Timer 2906 is shown with “0:01”, which implies that 1 second has passed since user 291 started augmented reality game 290. A picture from a music video associated with performer 2903 is shown and may be referred to as music video image 293a. The names of two songs, song 293b and song 293c, may be shown so that user 291 may choose which song music video image 293a may be associated with. Song 293b may be referred to as, “Heartbreak”; and, song 293c may be referred to as, “Catastrophe”. User 291 may be shown in augmented reality game 290; and, user 291 may move and/or tilt his/her head and/or face leftwards (under the name of song 293b (“Heartbreak”)) or rightwards (under the name of song 293c (“Catastrophe”)) to guess the song associated with music video image 293a. Image 294 shows that user 291 may have chosen a song associated with music video image 293a. It is shown that user 291 may have moved and/or tilted his/her face and/or head rightwards to choose song 293c, “Catastrophe”. Timer 2906 shows that 13 seconds has passed since user 291 started augmented reality game 290. If user 291 chooses the correct song associated with the picture of the music video presented (aka music video image 293a), then user 291 may continue further along with augmented reality game 290, in which he/she may have to determine the next song for the picture of the music video presented. Because user 291 chose the correct song, “Catastrophe”, associated with music video image 293a, user 291 may continue further along augmented reality game 290 to determine the next song. If user 291 does not choose the correct song associated with music video image 293a, then user 291 may have to try again to select the correct song associated with music video image 293a. Image 295 demonstrates an example of the next song user 291 may need to determine in augmented reality game 290. Timer 2906 is shown with “0:35”, which implies that 35 seconds has passed since user 291 started augmented reality game 290. A picture from a music video associated with performer 2903 is shown and may be referred to as music video image 295a. The names of two songs, song 295b and song 295c, may be shown so that user 291 may choose which song music video image 295a may be associated with. Song 295b may be referred to as, “I'm Wrong”; and, song 295c may be referred to as, “Cupcake”. User 291 may be shown in augmented reality game 291; and, user 291 may move and/or tilt his/her head and/or face leftwards (under the name of song 295b (“I'm Wrong”)) or rightwards (under the name of song 295c (“Cupcake”)) to guess the song associated with music video image 295a. Image 296 shows that user 291 may have chosen a song associated with music video image 295a. It is shown that user 291 may have moved and/or tilted his/her face and/or head leftwards to choose song 295b, “I'm Wrong”. Timer 2906 shows that 41 seconds has passed since user 291 started augmented reality game 290. If user 291 chooses the correct song associated with the picture of the music video presented (aka music video image 295a), then user 291 may continue further along with augmented reality game 290, in which he/she may have to determine the next song for the picture of the music video presented. Because user 291 chose the correct song, “I'm Wrong”, associated with music video image 295a, user 291 may continue further along augmented reality game 290 to determine the next song. If user 291 does not choose the correct song associated with music video image 295a, then user 291 may have to try again to select the correct song associated with music video image 295a. Image 297 demonstrates an example of the next song user 291 may need to determine in augmented reality game 290. Timer 2906 is shown with “0:42”, which implies that 42 seconds has passed since user 291 started augmented reality game 290. A picture from a music video associated with performer 2903 is shown and may be referred to as music video image 297a. The names of two songs, song 297b and song 297c, may be shown so that user 291 may choose which song music video image 297a may be associated with. Song 297b may be referred to as, “Awesome”; and, song 297c may be referred to as, “Star”. User 291 may be shown in augmented reality game 290; and, user 291 may move and/or tilt his/her head and/or face leftwards (under the name of song 297b (“Awesome”)) or rightwards (under the name of song 297c (“Star”)) to guess the song associated with music video image 297a. Image 298 shows that user 291 may have chosen a song associated with music video image 297a. It is shown that user 291 may have moved and/or tilted his/her face and/or head rightwards to choose song 297c, “Star”. Timer 2906 shows that 45 seconds has passed since user 291 started augmented reality game 290. If user 291 chooses the correct song associated with the picture of the music video presented (aka music video image 297a), then user 291 may continue further along with augmented reality game 290, in which he/she may have to determine the next song for the picture of the music video presented; or, the augmented reality game 290 may end, which is determined by the number of songs augmented reality game 290 instructs and/or allows user 291 to guess. FIG. 29 shows an example of augmented reality game 290 instructing and/or allowing user 291 to guess a total of three songs associated with the pictures of the music videos presented. Because user 291 chose the correct song, “Star”, associated with music video image 297a, user 291 has finished augmented reality game 290 in FIG. 29. If user 291 does not choose the correct song associated with music video image 297a, then user 291 may have to try again to select the correct song associated with music video image 297a. Image 299 shows an example of user 291's trial with augmented reality game 290, in which user 291 correctly guessed the songs associated with the pictures presented from the music videos associated with performer 2903. Timer 2906 shows that user 291 correctly guessed the songs in 45 seconds. Because augmented reality game 290 may determine a time period of 45 seconds as a moderate amount of time to guess the songs associated with a performer 2903, commentary 299a (including words, such as, but not limited to, “You Know JJ Well!”) may be added to imply to user 291 that user 291 may know performer 2903 and/or his/her songs well. Image 2901 shows an example of user 291's trial with augmented reality game 290, in which user 291 correctly guessed the songs associated with the pictures presented from the music videos associated with performer 2903. Timer 2906 shows that user 291 correctly guessed the songs in 11 seconds. Because augmented reality game 290 may determine a time period of 11 seconds as a short amount of time to guess the songs associated with performer 2903, commentary 2901a (including words, such as, but not limited to, “You're a JJ Superfan!”) may be added to imply to user 291 that user 291 may know performer 2903 and/or his/her songs very well. Image 2902 shows an example of user 291's trial with augmented reality game 290, in which user 291 correctly guessed the songs associated with the pictures presented from the music videos associated with performer 2903. Timer 2906 shows that user 291 correctly guessed the songs in 1 minute and 3 seconds. Because augmented reality game 290 may determine a time period of 1 minute and 3 seconds as a long amount of time to guess the songs associated with performer 2903, commentary 2902a (including words, such as, but not limited to, “Meh”) may be added to imply to user 291 that user 291 may not know performer 2903 and/or his/her songs well. Commentaries 229a, 2901a, and 2902a may be associated as a type of scoring system of augmented reality game 290 in addition to the results shown with the help of timer 2906. An example of an entity design that may be illustrated and/or simulated in augmented reality content 11, such as, but not limited to, augmented reality game 290, may be an entity design that may be associated (directly and/or indirectly) with venue 101, company, team, organization, individual, mascot, logo, icon, art, theme, community, uniform, jersey, etc. For instance, an example of an entity design that may be illustrated and/or simulated in augmented reality content 11 may be the following, which includes, but is not limited to, stage 2904, background 2905, and the clothes 2907 associated with performer 2903 (that may be worn by any individual, such as, but not limited to, performer 2903, user 291, and a person attending venue 101's event), which may include the name, image, and/or likeness of an individual (such as, but not limited to the individual whom performer 2903 represents) associated with the concert and/or live event affiliated with venue 101, and/or any organization and/or company a performer and/or individual represents during a concert and/or live event at venue 101; and, that entity design may relate to the performer(s), individual(s), and/or venue 101. Other elements, drawings, animations, etc. of augmented reality game 290 may also include entity design. For example, stage 2904, background 2905 and the clothes 2907 associated with performer 2903 (that may be worn by any individual, such as, but not limited to, performer 2903, user 291, and a person attending venue 101's event) may contain entity design that may relate to venue 101, performer(s), individual(s) (such as, but not limited to the individual whom performer 2903 represents), a party and/or organization that may be affiliated with and/or controls the performer(s) and/or individual(s), and/or a sponsoring company and/or advertiser of venue 101 and/or venue 101's event. QR code 14 and arrow 2908 are shown to imply that a user may use an electronic device 12 to scan QR code 14, and scanning QR code 14 may allow the user(s) to retrieve access to augmented reality content 11, such as, but not limited to, augmented reality game 290. A user may retrieve access to augmented reality game 290 via methods other than scanning QR code 14, such as, but not limited to, being provided with a URL.

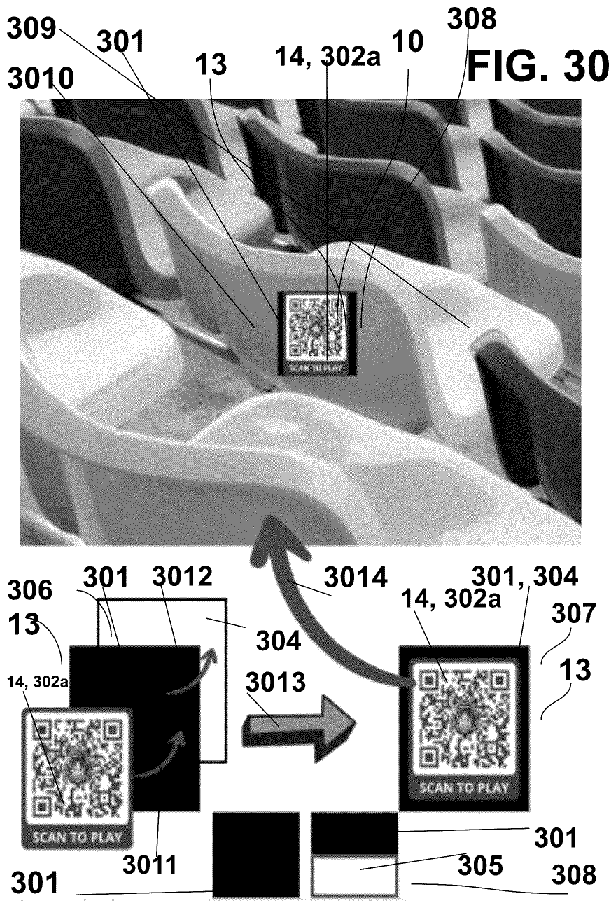

FIG. 30 illustrates a perspective view of event entertainment system 10 in which the accessory component 13 involves one or more pieces of rubber 301. Section 306 shows an exploded view of the accessory component 13 which involves rubber 301. Imaginary curved arrow 3011 shows that QR code 14 may be attached to a piece of rubber 301. There are various ways that QR code 14 may be attached to rubber 301. One way that QR code 14 may be attached to rubber 301 may be by having an elastic (aka QR code elastic 302a (which may be implied in FIG. 30) attached to the side(s) of QR code 14 that may not be scannable by any electronic device 12 (aka the back side of QR code 14). Another way that QR code 14 may be attached to rubber 301 may be by printing the illustrations, markings, and other descriptions of QR code 14 onto rubber 301. QR Code elastic 302a may contain and/or involve a removable adhesive so that, upon the preference or a person (such as, but not limited to a venue operator), rubber 301 may still be attached to chair 309 while a new version and/or type of QR code 14 (which may differ by illustration, markings, and/or descriptions, etc.) may be used while accessory component 13 may still be attached to chair 309. Imaginary curved arrow 3012 shows that rubber 301 may be attached to a piece of elastic 304 so that rubber 301 may be securely and/or properly attached to chair 309 so that, as a whole, accessory component 13 may be securely and/or properly attached to chair 309. Elastic 304 may contain and/or involve a removable adhesive so that, upon the preference of a person (such as, but not limited to, a venue operator), rubber 301 (and/or accessory component 13 as a whole) may be detached/uninstalled and/or reattached/reinstalled onto chair 309. Other ways that QR code 14 may be attached to rubber 301 are implied, but are not specifically detailed in this present disclosure. Straight arrow 3013 shows that when the parts (QR code 14, QR code elastic 302a, rubber 301, and elastic 304) may be attached and/or assembled together, it may create what may be seen in section 307. Section 307 shows a perspective view of accessory component 13. Section 307 shows a frontal view of QR code 14 attached to rubber 301; and, it may be implied that elastic 304 may be shown as attached to rubber 301. In FIG. 30, elastic 304 may be a part of accessory component 13. Curved arrow 3014 shows that accessory component 13 may be attached to chair 309. Section 308 shows a perspective view of accessory component 13 attached to chair 309 (an example of the type of seat that event entertainment system 10 may be involved with). FIGS. 2, 3, and 4 discuss methods and use cases of a chair and/or seat with event entertainment system 10 in more detail. Accessory component 13 may be attached to the back of chair 309 (such as, but not limited to backrest 3010), but a person, such as, but not limited to, a venue operator, may attach accessory component 13 to wherever he/she pleases. As shown in section 308 of FIG. 30, it may be likely that backrest 3010 and/or the backside of chair 309 may be on a tilted position, which may mean that when accessory component 13 is installed onto backrest 3010 and/or the backside of chair 309, QR code 14 may be tilted as well. If a person and/or venue operator does not prefer the accessory component 13 being tilted (because it may make it more difficult for a user to scan QR code 14 with electronic device 12), then, an extra piece of material (aka extra material 305; such as, but not limited to a piece of rubber) may be created with and/or installed with rubber 301. If extra material 305 may be a necessary part of accessory component 13, then another elastic 304 may need to be attached to extra material 305 so that accessory component may be securely and/or properly attached to chair 309.

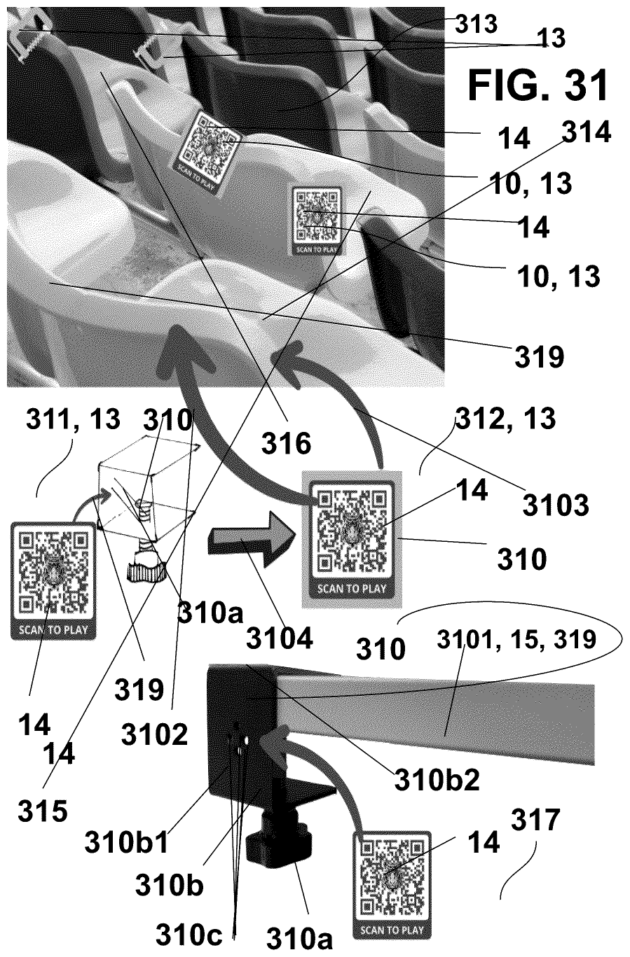

FIG. 31 illustrates a perspective view of event entertainment system 10, in which the accessory component 13 of event entertainment system 10 involves one or more C-clamps. Section 311 shows an exploded view of accessory component 13. QR code 14 is shown. Imaginary curved arrow 319 shows that QR code 14 may be attached to a portion of C-clamp 310. Imaginary descending diagonal lines 310a show one of the portions of C-clamp 310 where QR code 14 may be attached to. Section 312 shows a perspective view of accessory component 13. Section 312 shows a frontal view of QR code 14 attached to the portion of C-clamp 310 where imaginary descending diagonal lines 310a (from Section 311) may have been. Imaginary straight arrow 3104 shows that when the QR code 14 and C-clamp 310 may be attached together, accessory component 13 may be created, and the frontal view of what accessory component 13 may look like is shown in Section 312. Section 313 shows accessory components 13 attached to different areas of chairs 314, 315, and 316 and shows various methods (not limited to what is illustrated in FIG. 31) of attaching accessory component 13 to a piece of furniture 15. In other words, it may be said that Section 313 shows a perspective view of different versions of event entertainment system 10 attached to different areas of chairs 314, 315, and 316 because given that section 313 implies that because the parts of accessory component 13 may be attached, this may imply that a perspective view of event entertainment system 10 may have been created from the aforementioned attachment of the parts of accessory component 13 and shown together, collectively, as event entertainment system 10 on Section 313. Variations of how accessory component 13's may be attached to various chairs, seats, and/or furniture 15 in venue 101 are shown in Section 313. For example, accessory component 13 may be attached to the rim 319 of a chair, such as, but not limited to, rim 319 located on the top of chair 314, rim 319 located on the side of chair 314, rim 319 located on the top of chair 315, and rim 319 located on the side of chair 316. Imaginary curved arrow 3102 shows that accessory component 13 may be attached to rim 319 located on the top of chair 314. Imaginary curved arrow 3013 shows that accessory component 13 may be attached to rim 319 location on the side of chair 314. Depending on the portion of a piece of furniture that accessory component 13 may be attached to, a person may need to rotate and/or orient accessory component 13 so that the designs of QR code 14 may face a user who may scan QR code 14 with his/her electronic device 12. In FIG. 31, the curvature and/or dimensions of accessory component 13's may appear when accessory component 13 may be attached to a chair. Section 317 shows a close-up of how accessory component 13 may be attached to a portion of any chair and/or any seat and/or any furniture 15 that may be involved with event entertainment system 10. When in the process of attaching C-clamp 310 to a piece of furniture 15, such as, but not limited to, chairs 314, 315, 316, a seat, a bleacher, a desk, etc., a person may rotate handle 310a so that C-clamp 310 may be securely and/or properly attached to a piece of furniture 15. Bar 3101 is shown as an example of a piece of (and/or a part of a piece of) furniture 15; and, Section 317 shows how the positioning(s) and/or method(s) of how C-clamp 310 may be attached to a piece of furniture 15. The process for attaching C-clamp 310 to a piece of furniture 15 may differ amongst different furniture types. Section 317 shows an example of what a portion of a piece of furniture 15 (and/or a furniture itself) may be. For example, section 317 shows another view of rim 319. The specifications of C-clamp 310, such as, but not limited to, its length, width, height, dimensions, weight, swivel head, frame, jaws, throat, screws, handle, and other components of C-clamp 310 may vary from what is illustrated in FIG. 31. C-clamp 310 may be made of materials not limited to plastics and metals. Frame 310b may help C-clamp 310 be securely and properly attached to a piece of furniture 15. QR code 14 may be attached to any portion of frame 310b, such as, but not limited to, portion 310b1 and/or portion 310b2 of frame 310b. Portions 310b1 and 310b2 may contain holes 310c.

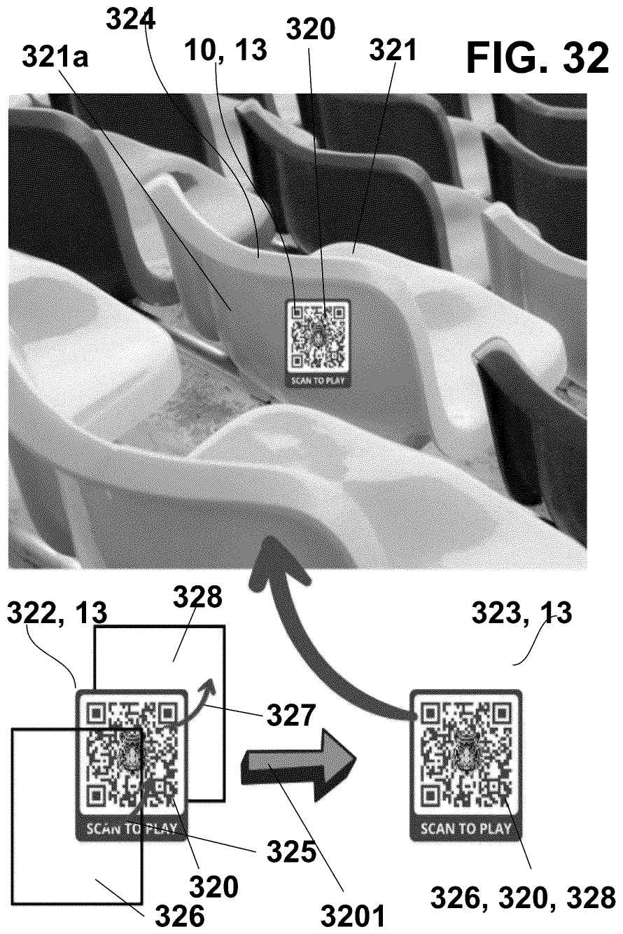

FIG. 32 illustrates a perspective view of event entertainment system 10, in which the accessory component 13 of event entertainment system 10 involves QR code 320 being attached to a chair 321 (and/or a piece of furniture) without a piece of rubber or C-clamp. FIG. 32 illustrates a perspective view of event entertainment system 10, in which the accessory component 13 of event entertainment system 10 involves QR code 320 being attached to a chair 321 (and/or a piece of furniture 15) without a piece of rubber 301 or C-clamp 310. Section 322 shows an exploded view of accessory component 13. Imaginary curved arrow 325 shows that QR code 320 may be laminated, which may involve QR code 320 being overlaid with a layer of plastic, such as, but not limited to, plastic 326, and/or some other protective material. Plastic 326 may consist of a material other than plastic of any thickness and may consist of a transparent plastic with little thickness. Imaginary curved arrow 325 shows that plastic 326 may be attached to QR code 320. For any and all variations of accessory component 13 described in this present disclosure, the top side and/or front side and/or entirety of a QR code (such as, it not limited to QR code 320) may be laminated and/or have plastic 326 attached to it. Imaginary curved arrow 327 shows that QR code 320 may be attached to elastic 328 so that accessory component 13 may be securely and/or properly attached to a piece of furniture, such as chair 321. Elastic 304 may contain and/or involve a removable adhesive so that, upon the preference of a person (such as, but not limited to, a venue operator), QR code 320 (and/or accessory component 13 as a whole) may be detached/uninstalled and/or reattached/reinstalled onto chair 321. Section 323 shows a perspective view of accessory component 13. Imaginary straight arrow 3201 shows that when QR code 320, plastic 326, and elastic 328 may be attached together, accessory component 13 may be created, and the frontal view of what accessory component 13 may look like is shown in section 323. Section 324 shows an example of accessory component 13 being attached to a piece of furniture, such as, but not limited to, chair 321. There may be various locations (of a piece of furniture 15) and/or various methods for attaching accessory component 13 to a piece of furniture 15. For example, section 324 shows that accessory component 13 may be attached to the backside 321a of chair 321; but, there may be other locations of chair 321 where accessory component 13 may be attached to, such as, but not limited to, the armrest, rim, front side, top side, bottom side, left side, and right side of chair 321.

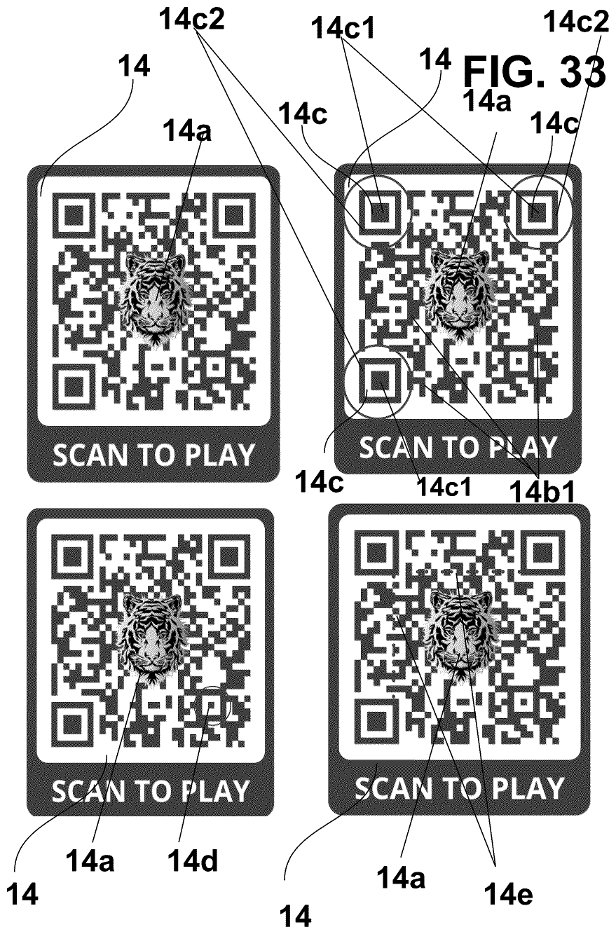

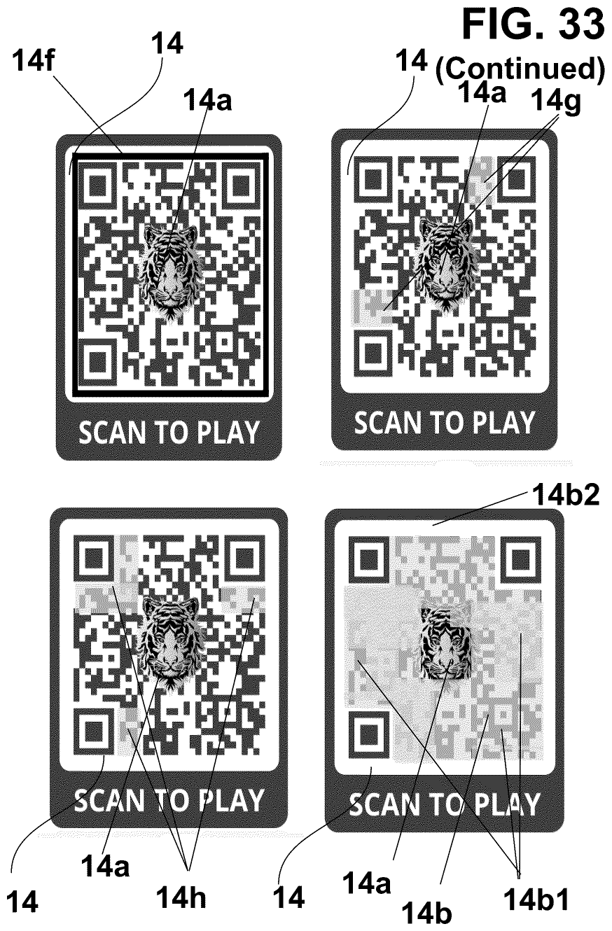

FIG. 33 illustrates a perspective view of QR code 14 as a part of the QR code component 14 of event entertainment system 10, that may include an icon 14a. QR code component 14 involves one or more QR codes that serve to help broadcast augmented reality content component 11 to users. QR code 14 may be an example of a type of QR code that may be a part of QR code component 14. The QR code(s) used in QR code component 14 of event entertainment system 10 may vary in designs and/or elements, such as, but not limited to positioning marking, alignment marking, timing pattern, quiet zone, version information, format information, data and error correction module, and/or icon. QR code 14 is an example of a QR code as a part of QR code component 14 that may have a unique design and/or unique element, such as, but not limited to positioning marking, alignment marking, timing pattern, quiet zone, version information, format information, data and error correction module, and/or icon. QR code component 14 may involve another QR code(s) that has different design(s) and/or different element(s) (such as, but not limited to positioning marking, alignment marking, timing pattern, quiet zone, version information, format information, data and error correction module, and/or icon) from those of QR code 14 and still be a part of the QR code component 14 for a particular organization and/or individual, such as, but not limited to a venue, company, and/or person. In other words, if venue 101 uses an event entertainment system 10 which includes QR code component 14, then venue 101 may use QR code 14, a QR code that may differ in design(s) and/or element(s) from QR code 14, a QR code that may differ in design(s) and/or element(s) from the aforementioned QR codes, and/or, as many (and/or a single) QR codes a person, venue, company, and/or organization prefers. QR code 14 in FIG. 33 may be a pictorial representation of a matrix code (and/or QR code) that is preferably intended to be scanned by electronic device 12 so that a user may be directed to a webpage and/or application containing and/or broadcasting (and/or associated with) augmented reality content 11. Providing a QR code may help broadcast augmented reality content 11, such as, but not limited to, augmented reality games 11a and augmented reality animations and illustrations 11b, to users. The various elements of QR code 14 may give electronic device 12 the ability to and/or a better chance to scan QR code 14. FIG. 33 shows various elements of QR code 14 to provide a better understanding of how these elements may give electronic device 12 the ability to and/or a better chance to scan QR code 14. For example, data and error correction module 14b serves as one of the key parts of QR code 14. Data and error correction module 14b serves as the standard unit of QR code 14 and typically consists of black squares 14b1 against a white background 14b2. QR code 14 of event entertainment system 10 allows customizations and/or tweaks to be made, in which the black squares 14b1 may be colors other than black. Although customizations may be made by the actions of, such as, but not limited to, changing the color of the data module 14b, the better the contrast between the squares 14b1 and the white background 14b2, the better the chance electronic device 12 may be able to scan QR code 330. While data and error correction module 14b may have black squares 14b1, which may provide the best contrast against white background 14b2, the color of the squares 14b1 that may also provide a good contrast against white background 14b2 may be other colors, such as, but not limited to, dark purple, red, dark green, a combination of colors, etc. Data and error correction module 14b represents the majority of QR code 14 through its squares 14b1. The aforementioned squares 14b1 store data, such as, but not limited to, data concerning and/or affiliated with a webpage and/or uniform resource link (URL). Because squares 14b1 are surrounded by parts of white background 14b2, up to thirty percent of QR code 14 may be damaged without electronic device 12 losing the chance and/or ability to scan QR code 14. Data module 14b may consist of black squares 14b1 and white background 14b2. QR code 14 may consist of three position markings 14c. Each position marking 14c includes inner eye 14c1 and outer eye 14c2. Position marking 14c allows the scanner(s) and/or camera(s) of electronic device 12 to find squares 14b1 (of data module 14b) when it may be scanning QR code 14. Position markings 14c may also allow the scanner(s) and/or camera(s) of electronic device 12 to find the scanning direction when it may be scanning QR code 14. Finding the scanning direction allows electronic device 12 to scan QR code 14 when electronic device 12 is and/or is not at an angle. QR code 14 may be scanned in any direction that electronic device 12 might be in. During a possible scenario in which the size of QR code 14 may be too large, alignment marking 14d helps position and/or align QR code 14 so that it may be scanned by electronic device 12. Timing pattern 14e helps the scanner and/or camera of electronic device 12 determine how large the data matrix of QR code 14 may be. Quiet zone 14f may be another key element of QR code 14 because it helps the scanner and/or camera of electronic device 12 recognize the difference between QR code 14 and whatever may surround QR code 14. For instance, if QR code 14 was attached to the backside of a chair, when electronic device 12 scans QR code 14 that may be located on the backside of the chair, quiet zone 14f may allow the scanner and/or camera of electronic device 12 to recognize the difference (such as, but not limited to, the visual difference) between QR code 14, the backside of the chair, and whatever else may be surrounding QR code 14. By recognizing the difference between QR code 14 and whatever may surround QR code 14, the scanner and/or camera of electronic device 12 (due to quiet zone 14f) may be able to determine where QR code 14 starts and finishes. Quiet zone 14f may also be described as the blank area located on the sides of the data matrix that houses the other elements of QR code 14f. QR code 14 may contain version information 14g which provides information about the type of version that QR code 14 represents out of the 40 plus versions of a QR code that may exist. Format information 14h may give information about, such as, but not limited to, the extent to which QR code 14 may be scanned by electronic device 12 when QR code 14 may become dirty and/or damaged (in other words, the chosen level of error tolerance). Icon 14a involves an image(s) that may be placed on a portion of (such as, but not limited to the center of) QR code 14. The size of icon 14a may determine electronic device 12's ability and/or chance to scan QR code 14. For example, while the size of icon 14a may be as small as possible, the larger the size of icon 14a gets, the harder it may be for electronic device 12 to scan QR code 14; and, if the size of icon 14a becomes too large, then electronic device 12 may not have the chance and/or ability to scan QR code 14. The size of icon 14a may be classified as too large when it covers too many squares 14b1 to the extent that electronic device 12 may not be able to scan QR code 14. Icon 14a may be customized as an image(s) and/or icon(s) such as, but not limited to, a logo, mascot, animal, item, good, emotion, feeling, emoji, individual, etc. For example, icon 14a may be a mascot affiliated with a sports team and/or with venue 101. Another example may be that icon 14a may represent a famous individual, such as, but not limited to, a famous athlete and/or singer. Another example may be that icon 14a may represent a logo of a company—as shown by the icon 14a of FIG. 33 being a logo of a company; and, the logo for the aforementioned company may be a tiger. Regardless of the variations of elements and/or designs a QR code may have, the ability and/or chance of an electronic device 12 to scan a QR code may vary with the type, model, and/or brand of electronic device 12.

FIG. 34 illustrates a flowchart 340, which shows the process of allowing a user to access augmented reality content component 11 of event entertainment system 10 through implementing QR code component 14 and/or accessory component 13 of event entertainment system 10. In order to broadcast augmented reality content 11 to user(s), a user may need to be given access to augmented reality content 11 first; and, the steps for giving a user access to augmented reality content 11 are explained in FIG. 6 and/or FIG. 34. FIG. 6 explains a method of broadcasting augmented reality content 11 to a user via back end actions of a person, such as, but not limited to, a programmer and developer, whereas FIG. 34 explains a method of allowing a user access to augmented reality content 11 via the front end actions of a person, such as, but not limited to, a user and an installer of accessory component 13 and/or QR code component 14. The back end actions, as explained in FIG. 6, involve the technological intricacies of augmented reality content 11, webpages, QR codes, and/or deeplinks. The front end actions will be elaborated in Steps 341, 342, 343, and 344 of FIG. 34. Step 341 says that accessory component 11 may be installed on a piece of furniture 15 that may be located in venue 101. Installing accessory component 11 onto a piece of furniture 15 involves attaching the parts of accessory component 11, such as, but not limited to QR code component 14 (aka a QR code), elastic(s), plastic(s), adhesive(s), rubber(s), and/or C-clamp(s), onto a piece of furniture 15, such as, but not limited to, a chair, bench, bleacher, benchback seat, table, and sofa. Step 342 says that accessory component 11 may display QR code component 14. A QR code serves as the essence of QR code component 14; and, a QR code gives a user faster and/or more efficient access to augmented reality content 11. One or more QR codes may be involved with QR code component 14, such as, but not limited to, QR code 14 that was described in multiple figures throughout this present disclosure. Step 343 says that electronic device 12 may retrieve data from QR component 14 when it scans the QR code. The QR code that electronic device 12 scans may store data regarding uniform resource links (URLs) and/or mobile application information, and a QR code may store any type of data, such as, but not limited to, phone numbers, a message, opening a message, plain text, geolocation, email addresses, calendar data, image, audio, and contact data. In regards to event entertainment system 10, when electronic device 12 retrieves data from scanning a QR code, the data that electronic device 12 typically retrieves includes data regarding URLs and/or application information; but, the data that electronic device 12 retrieves may include other data, such as, but not limited to, the types of data mentioned in the previous sentence. When electronic device 12 retrieves data from the QR code it scans, electronic device 12 may retrieve URL(s) and/or mobile application information associated with augmented reality content 11, such as, but not limited to, augmented reality game 11a and augmented reality illustrations and/or animations 11b. Although Step 343 mentions the words, “user's device”, the electronic device 12 that a user may use to scan a QR code may or may not belong to the user. Step 344 says that electronic device 12 may retrieve access to augmented reality component 11. Electronic device 12 may be in the process of retrieving access to augmented reality component 11 when electronic device 12 may be processing the barcode data electronic device 12 has retrieved from scanning a QR code. When electronic device 12 may be in the process of retrieving access to augmented reality component 11, it is possible that, during this process, electronic device 12 may or may not encounter and/or launch one or more deeplinks. Deep links, the use of it, and/or not the use of it, may be explained in more detail in FIG. 6. When electronic device 12 may be in the process of retrieving access to augmented reality component 11, it is also possible that electronic device 12 may or may not encounter and/or launch one or more web pages, URLs, and/or mobile applications. Electronic device 12 may have successfully retrieved access to augmented reality content component 11 when a webpage and/or application associated with and/or houses augmented reality content 11 launches on electronic device 12. A QR code may store URL data, which may also be known as the address of the webpage and/or application associated with and/or housing augmented reality content 11. When electronic device 12 launches a webpage and/or application, this may also be known as electronic device 12 launching the content and/or collection of content of augmented reality content 11.

FIG. 35 illustrates a flowchart 350 of the variations of a server and/or Internet device to report that one or more users have interacted with augmented reality content component 11 of event entertainment system 10. Step 350a shows that flowchart 350 helps determine whether a user has or has not interacted with augmented reality content 11. Step 350a implies that an electronic device 12 (that may or may not belong to a particular user) scanning a particular QR code may be how one can determine if the user has or has not interacted with a particular type of augmented reality content 11. Flowchart 350 helps one determine whether a user interacted with a QR code 14. In order to better understand FIG. 35, QR code 14 may represent any QR code as a part of QR code component 14. Flowchart 350 may be used to help determine whether a user interacted with a specific type of augmented reality content 11 via scanning a specific QR code at a time; however, flowchart 350 may also be used to help determine whether one or more users interacted with one or more types of augmented reality content 11 via scanning one or more QR codes. Step 351 says that if a user scans a QR code of QR code component 14, such as, but not limited to, QR code 14, then step 352 may follow in which it may be likely that the user interacted with augmented reality (AR) content 11. One may not assume scanning QR code 14 may be equivalent to interacting with augmented reality content 11 because electronic device 12 may do different actions when scanning QR code 14 and when interacting with augmented reality content 11. When scanning QR code 14, electronic device 12 may be in the process (and/or finished with the process) of retrieving QR code 14's data, such as, but not limited to, a URL that may be associated with augmented reality content 11. When interacting with augmented reality content 11, electronic device 12 may be in the process (and/or finished with the process) of launching a webpage and/or application that may be associated with and/or houses augmented reality content 11. The fact that an electronic device 12 has scanned QR code 14 helps deduce that there may have been a likelihood that the user that may be associated with the particular electronic device 12 may have interacted with augmented reality content 11. Step 353 says that if a user scans QR code 14 more than one time, then step 354 may follow in which it may be more likely (than the scenario mentioned in steps 351 and 352) that the user interacted with augmented reality content 11. There may be multiple scenarios that may justify that user may have interacted with augmented reality content 11 via the scenario mentioned in step 353. For example, it may be possible that electronic device 12 may have taken multiple attempts to access augmented reality content 11 one time and/or more than one time. Another possibility is that the user may have interacted with augmented reality content 11 and may need to scan QR code 14 in order to access augmented reality content 11 again. On the other hand, another possibility may occur in which the user may have not been able to interact with augmented reality content 11; and, this may occur if electronic device 12 made multiple attempts to scan QR code 14 and could not launch augmented reality content 11. Step 355 says that if a user does not scan QR code 14, it is likely that (as mentioned in step 356) the user did not interact with augmented reality content 11, unless electronic device 12 may have been shared between the user and another user so that the former user still had a chance to interact with augmented reality content 11. Methods for which electronic device 12 retrieves access to augmented reality content 11 may involve electronic device 12 scanning a QR code 14 in order to retrieve access to augmented reality content 11. Various information may be collected from a user scanning QR code 14. This information includes, but is not limited to, unique visitors, requests, countries, latitude and longitude, language settings, cities, OS distribution, model, reference, scan via share, bots, and scan position. Unique visitors refers to the number of times a new electronic device 12 scanned QR code 14. Requests refers to the total number of times QR code 14 was scanned by electronic devices 12. A QR code 14 may be scanned more than one time by the same electronic device 12. This means that, for a scenario that QR code(s) 14 is in venue 101 and is scanned by the entire venue capacity, for example, 60,000 users, this may or may not mean that all 60,000 users scanned QR code 14 with their electronic devices 12. The possibilities may include, but are not limited to, (1) all 60,000 users scanned QR code 14 once, and (2) less than 60,000 users scanned QR code 14 more than one time. The number of scans of QR code 14 may not specify the number of users who interacted with augmented reality content 11 and/or the number of times augmented reality content 11 was interacted with. It is possible that the number of users who interacted with augmented reality content 11 may be determined by the number of times QR code 14 was scanned if a small capacity of users (whom we may or may not be able to differentiate individually) scanned QR code 14. Countries refers to the country where QR code 14 may have been scanned and/or requested by a user. Each scan of QR Code 14 may be determined by the IP address and the user agent that electronic device 12 may send. Latitude and longitude refers to the location of where electronic device 12 was when it scanned QR code 14. Language settings refers to the primary language that electronic device 12 operates with, such as, but not limited to, English and Chinese. Cities refers to the city that electronic device 12 was in when it scanned QR code 14. OS distribution refers to the operating system that electronic device 12 runs on, such as, but not limited to, Android and iPhone Operating System (iOS). Model refers to the brand of an electronic device 12, such as, but not limited to, Google, Apple, Samsung, Nokia, and Motorola. Reference refers to whether QR code 14 was referred to another user. Scan via share refers to whether a user scanned QR code 14 because the QR code 14 was shared through email and/or other social network(s). Scan position refers to whether a user has been allowed to share his/her location to whoever manages QR code 14; and, that location data may be provided to whoever manages QR code 14.

The embodiments are provided and described for the purpose of thoroughly describing the event entertainment system 10 and methods regarding the event entertainment system 10. The present disclosure may be embodied in various forms, so the present disclosure should not be understood as limited to the aforementioned embodiments.

1. An entertainment system, comprising:
a. immersive media relating to an event
b. a digital icon for providing an electronic device the ability to access said immersive media
c. means for displaying said digital icon
whereby said immersive media will enhance the experience of said event.

2. The entertainment system of claim 1, wherein said immersive media involves an augmented reality-based video game.

3. The entertainment system of claim 1, wherein said digital icon shows a QR code as means for providing said access.

4. The entertainment system of claim 1, wherein the said means provide data that measures a user's interaction with said immersive media.

5. An electronic game, comprising:
d. a design of said electronic game relating to an event
e. a graphic relating to one or more parts of a user's body
f. means for allowing said user to interact with the electronic game
whereby said design and said graphic will enhance said user's experience relating to said event.

6. The electronic game of claim 2, wherein said design involves augmented reality relating to a venue, participant, organization, entity, or scenario (or a combination thereof) of said event.

7. The electronic game of claim 2, wherein said part that interacts with said electronic game may differ from a part shown in said electronic game.

8. The electronic game of claim 2, wherein instructions and the design of said electronic game allow said user to use said part to interact with said electronic game and control the outcome, or process (or a combination thereof) of said electronic game.

9. The electronic game of claim 2, wherein said user can interact with said electronic game regardless of whether said user touches the screen of an electronic device used to interact with said game.

10. The electronic game of claim 2, wherein data regarding said interaction can be accessible through said user's usage of a mobile device.

11. A method for broadcasting entertainment content, comprising:
a. providing access to immersive media relating to an event
b. providing a digital icon as a means of providing said access
c. displaying said digital icon within a venue, or nearby a venue, or on a digital screen, or a combination thereof
whereby said immersive media will enhance the experience of said event.

12. The method of claim 3, wherein said immersive media involves augmented reality personalized for a user.

13. The method of claim 3, wherein said digital icon shows a QR code, that relates to an event, as means for providing said access.

14. The method of claim 3, wherein said digital icon is displayed on a furniture of said venue, or on said digital screen (such as, but not limited to, a television, or jumbotron, or tablet), or a combination thereof

15. The method of claim 3, wherein data regarding a user's interaction with said digital icon or with said immersive media (or a combination thereof) is accessible.

16. A furniture accessory, comprising:
a. a design relating to an event
b. means for said design to provide access to digital content
whereby said digital content will enhance the experience of an event.

17. The furniture accessory of claim 4, wherein said design shows a QR code as a means for providing said access to an electronic device that can scan the QR code.

18. The furniture accessory of claim 4, wherein said furniture accessory can be attached to a seat.

19. A method of advertising for an event, comprising:
a. providing immersive media related to said event
b. allowing a user to interact with said event through said immersive media
whereby said immersive media increases a user's engagement with said event.

20. The method of claim 5 wherein said immersive media involves augmented reality personalized for a user.
